(19) United States
(12) Patent Application Publication
(10) Pub. No.: US 2026/0254643 A1
(43) Pub. Date: Aug. 27, 2026

(54) Cryptographic Pipeline Bypass for Poisoned Data in Encrypted Interconnects

(71) Applicant: UnifabriX Ltd., Haifa (IL)

(72) Inventors: Ronen Aharon Hyatt, Haifa (IL); Gaya Opal Hyatt, Haifa (IL); Ethan Sharon Hyatt, Haifa (IL); Gil Thieberger, Kiryat Tivon (IL)

(73) Assignee: UnifabriX Ltd., Haifa (IL)

(21) Appl. No.: 19/649,220

(22) Filed: Apr. 16, 2026

Related U.S. Application Data
(60) Provisional application No. 63/811,859, filed on May 25, 2025.
(60) Provisional application No. 63/826,342, filed on Jun. 18, 2025.
(60) Provisional application No. 63/856,653, filed on Aug. 3, 2025.
(60) Provisional application No. 63/874,393, filed on Sep. 2, 2025.
(60) Provisional application No. 63/895,053, filed on Oct. 7, 2025.
(60) Provisional application No. 63/906,709, filed on Oct. 28, 2025.
(60) Provisional application No. 63/931,124, filed on Dec. 4, 2025.
(60) Provisional application No. 63/991,122, filed on Feb. 25, 2026.
(60) Provisional application No. 64/013,582, filed on Mar. 22, 2026.
(60) Provisional application No. 64/030,256, filed on Apr. 5, 2026.
(60) Provisional application No. 64/031,378, filed on Apr. 6, 2026.
(60) Provisional application No. 64/038,992, filed on Apr. 14, 2026.

(51) Int. Cl. H04L 9/32; H04L 9/00; H04L 9/06

(52) U.S. Cl. CPC H04L 9/32; H04L 9/002; H04L 9/0618

(57) ABSTRACT

Implementations for propagating data errors through encrypted interconnects without causing false authentication failures. A device in a UALink-based network detects a data error indicator on a data beat of a transaction and excludes the data beat from encryption and authentication tag computation by a port encryption engine. Bytes and byte enables of the data beat are replaced with a predetermined value, and the data beat is replaced with error indication messages in an outbound flit stream. At a receiving device, a transaction layer detects the error indication messages, asserts a data error indicator for the corresponding data beat, and a decryption engine excludes the data beat from decryption and authentication tag verification. The authentication tag verification succeeds for non-poisoned data beats despite the presence of poisoned beats. Implementations may apply to accelerators, switches, integrated circuits, active cables, and collective operations in the UALink-based network.

### CROSS-REFERENCE TO RELATED APPLICATIONS

This Application claims priority to: U.S. Provisional Patent Application No. 64/038,992, filed Apr. 14, 2026 that is herein incorporated by reference in its entirety; U.S. Provisional Patent Application No. 64/031,378, filed Apr. 6, 2026; U.S. Provisional Patent Application No. 64/030,256, filed Apr. 5, 2026; U.S. Provisional Patent Application No. 64/013,582, filed Mar. 22, 2026; U.S. Provisional Patent Application No. 63/991,122, filed Feb. 25, 2026; U.S. Provisional Patent Application No. 63/931,124, filed Dec. 4, 2025; U.S. Provisional Patent Application No. 63/906,709, filed Oct. 28, 2025; U.S. Provisional Patent Application No. 63/895,053, filed Oct. 7, 2025; U.S. Provisional Patent Application No. 63/874,393, filed Sep. 2, 2025; U.S. Provisional Patent Application No. 63/856,653, filed Aug. 3, 2025; U.S. Provisional Patent Application No. 63/826,342, filed Jun. 18, 2025; and U.S. Provisional Patent Application No. 63/811,859, filed May 25, 2025.

### BACKGROUND

High-performance computing environments increasingly rely on clusters of accelerators interconnected by high-speed fabrics to deliver computational throughput for artificial intelligence (AI) training and inference workloads. Ultra Accelerator Link (UALink) is a high-speed interconnect technology that enables communication among accelerators and switches. UALink defines a Protocol Level Interface (UPLI) that specifies channels, commands, and fields for transactions between originator and completer devices. UALink enables accelerators to form pods comprising switches and accelerators, wherein the switches route traffic among the accelerators.

Data integrity in high-performance interconnects may be protected by parity or error detection mechanisms. When a data error is detected, the affected data may be marked with an error indicator, commonly referred to as a poison indicator, allowing the data to propagate through the system to the destination device for handling. Separately, encrypted interconnects protect data in transit using authenticated encryption algorithms, such as AES-GCM, which compute an authentication tag over encrypted content to verify both confidentiality and integrity.

### SUMMARY

Some of the following implementations describe a device for a UALink-based network, the device comprising a UALink-based port, a circuit configured to detect a data error indicator on a data beat of a transaction, and a port encryption engine configured to, upon detection of the data error indicator, exclude the data beat from encryption, exclude the data beat from authentication tag computation, and set bytes and byte enables of the data beat to a predetermined value. A transaction layer is configured to replace the data beat with one or more error indication messages in an outbound flit stream on the UALink-based port.

Some of the following implementations describe a method for propagating data errors in a UALink-based network. The method comprises detecting, at a device comprising a port encryption engine coupled to a UALink-based port, a data error indicator on a data beat of a transaction, excluding the data beat from encryption and from authentication tag computation, replacing bytes and byte enables of the data beat with a predetermined value, and replacing the data beat in an outbound flit stream with one or more error indication messages.

Some of the following implementations describe an interconnect system for a UALink-based network comprising a transmitting device and a receiving device coupled via a UALink-based link. At the transmitting device, when a data error is detected on a data beat, the port encryption engine excludes the data beat from encryption and authentication tag computation, and the transaction layer replaces the data beat with error indication messages. At the receiving device, the transaction layer detects the error indication messages, asserts a data error indicator for a corresponding data beat, and the port encryption engine excludes the data beat from decryption and authentication tag verification. The authentication tag verification succeeds for non-poisoned data beats despite the presence of the data beat with the data error.

### BRIEF DESCRIPTION OF THE DRAWINGS

FIG. 1A illustrates accelerators coupled to one or more switches via high-bandwidth links supporting a protocol level interface;

FIG. 1B illustrates a method for validating connectivity in an accelerator interconnect network;

FIG. 2A illustrates a centralized controller that may verify the topology of an accelerator interconnect network at the system level by aggregating neighbor validation results from all devices;

FIG. 2B illustrates a method for verifying topology of an accelerator interconnect network at the system level;

FIG. 3A illustrates a centralized controller generating forwarding entries that direct traffic between accelerators through switches;

FIG. 3B illustrates a method for maintaining workload continuity during a management failure;

FIG. 4A illustrates system comprising a centralized controller that upon recovery from a failure may execute a reconciliation pipeline to restore management plane consistency;

FIG. 4B illustrates a method for recovering management of an accelerator interconnect network;

FIG. 5A illustrates accelerators coupled to switches via high-bandwidth links, wherein each physical switch may include one or more logical switches;

FIG. 5B illustrates a method for recovering from a link failure in an accelerator interconnect network;

FIG. 6A illustrates a centralized controller that may apply different recovery strategies based on the type of component that failed;

FIG. 6B illustrates a method for managing errors in an accelerator interconnect network;

FIG. 7A illustrates telemetry collection that may provide visibility into health and performance of devices and links;

FIG. 7B illustrates a method for collecting telemetry in an accelerator interconnect network comprising a telemetry collector establishing a read-only connection to a management agent and subscribing to different data categories;

FIG. 8A illustrates a system wherein each port on a device in the accelerator interconnect network may maintain per-layer telemetry counters;

FIG. 8B illustrates a method for monitoring an accelerator interconnect network comprising maintaining per-layer telemetry counters at each port, collecting the counters via a management agent, and reporting them to a telemetry collector;

FIG. 9A illustrates a device for UALink-based network comprising a transmitter and a receiver;

FIG. 9B illustrates a method for performing authenticated encryption in a UALink-based network;

FIG. 10A illustrates a device configured to receive and decrypt encrypted transactions that arrive out of order;

FIG. 10B illustrates a method describing receiver-side operations for decrypting encrypted transactions that arrive out of order;

FIG. 11A illustrates a mechanism to detect faults by computing a CRC over plaintext content before encryption, encrypting the CRC using a portion of the encryption keystream, and including the encrypted CRC in the authentication tag computation;

FIG. 11B illustrates a method for verifying integrity of encryption engines in a UALink-based network;

FIG. 12A illustrates a system comprising an end-to-end crypto engine fault detection mechanism;

FIG. 12B illustrates a method for detecting faults in encryption engines across a UALink-based link;

FIG. 13A illustrates a bypass mechanism where the encryption engine excludes a poisoned data beat from both encryption and authentication tag computation, sets the data beat to a predetermined value, and the transaction layer replaces the data beat with error indication messages;

FIG. 13B illustrates a method for propagating data errors through an encryption pipeline in a UALink-based network;

FIG. 14A illustrates a system comprising a transmitting device and a receiving device each independently exclude a poisoned data beat from their respective encryption and decryption operations;

FIG. 14B illustrates a method for propagating data errors through encryption at both the transmitting and receiving devices;

FIG. 15A illustrates accelerators communicating via transaction layer flits over UALink-based links;

FIG. 15B illustrates a method for encoding transactions in a UALink-based network;

FIG. 16A illustrates an accelerator comprising a circuit that processes incoming responses from transaction layer flits, while distinguishing between responses corresponding to collective operations and responses corresponding to unicast operations;

FIG. 16B illustrates a method for processing responses in a UALink-based network;

FIG. 17A illustrates a switch for a UALink-based network which may perform in-network collective operations;

FIG. 17B illustrates a method for performing a collective operation in a UALink-based network;

FIG. 18A illustrates a switch for a UALink-based network which may operate in two distinct modes depending on type of request received;

FIG. 18B illustrates a method for processing requests at a switch in a UALink-based network;

FIG. 19A illustrates a switch for a UALink-based network, which may offload entire collective operations from accelerators;

FIG. 19B illustrates a method for offloading a collective operation to a switch in a UALink-based network;

FIG. 20A illustrates a switch for a UALink-based network which may manage queue resources for block collective operations through a lifecycle of allocation, invocation, and deallocation;

FIG. 20B illustrates a method for managing collective operation resources at a switch in a UALink-based network;

FIG. 21A illustrates a method for performing in-network data reduction in a UALink-based network;

FIG. 21B illustrates a method for performing data reduction with format conversion in a UALink-based network;

FIG. 22A illustrates a system for a UALink-based network that includes a centralized controller that integrates collective operation resource allocation into a virtual partition lifecycle;

FIG. 22B illustrates a method for creating a virtual partition with collective operation resources;

FIG. 22C illustrates a system for a UALink-based network that includes a centralized controller that maintains per-virtual-partition resource accounting for in-network collective operation resources and enforces per-virtual-partition quotas;

FIG. 23A illustrates a system for a UALink-based network comprising a centralized controller that programs group table entries across a plurality of switches to enable in-network collective operations spanning accelerators coupled to different switches;

FIG. 23B illustrates a method for programming consistent group table entries across switches in a UALink-based network;

FIG. 24A illustrates a system for a UALink-based network comprising a centralized controller that maintains group table entries in response to topology changes in the network;

FIG. 24B illustrates a method for maintaining group table consistency in response to topology changes in a UALink-based network;

FIG. 25A illustrates a switch supporting both collective operations and unicast operations;

FIG. 25B illustrates a method for selectively processing encrypted transactions at a switch in an accelerator network;

FIG. 26A illustrates a system providing a mechanism for trusted software on a host processor to selectively elevate a switch into a trusted computing base for collective operations of a specific virtual partition; and

FIG. 26B illustrates a method for selectively elevating a switch into a trusted computing base.

### DETAILED DESCRIPTION

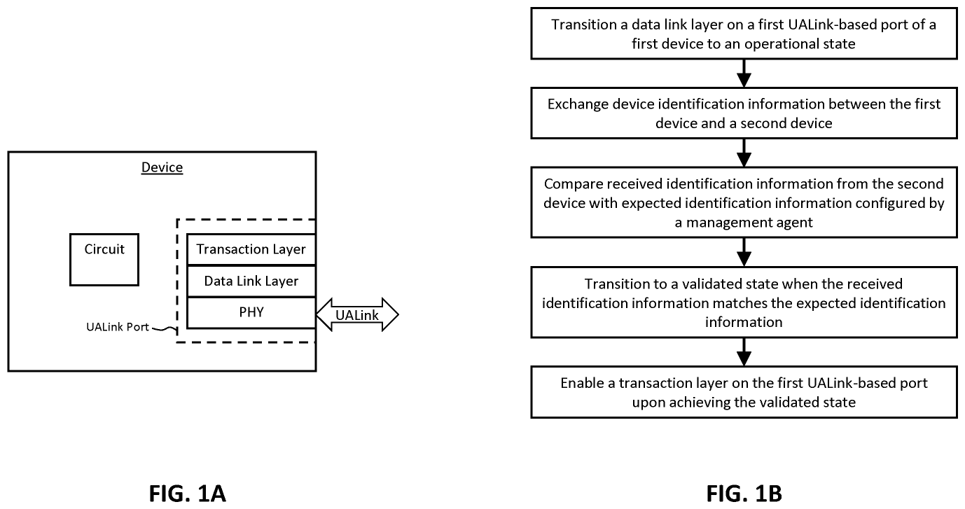

FIG. 1A illustrates accelerators coupled to one or more switches via high-bandwidth links supporting a protocol level interface. Each link may connect an accelerator port to a switch port. Before higher-layer protocols are enabled on a port, the device may verify that the link partner on the other end of the physical link is the expected device. This verification may be performed at the data link layer by exchanging device identification messages after the data link layer reaches an operational state. A circuit on each device may compare the received identification information with expected values pre-configured by a management agent. When the received information matches the expected information, the circuit may transition to a validated state, enabling the transaction layer and protocol level interface on that port. When the information does not match, the circuit may transition to an invalid state, and the port may be blocked from carrying transactions regardless of administrative configuration. This hardware-enforced gate may prevent misrouted transactions due to incorrect cabling, unauthorized cross-tenant communication, or silent data corruption. The mechanism may operate at each port independently, and each device in the network may implement the validation circuit.

In various implementations, a device for an Ultra Accelerator Link (UALink)-based network, comprising: a UALink-based port comprising a data link layer and a transaction layer; the data link layer configured to exchange device identification messages with a link partner after the data link layer reaches an operational state; a circuit configured to compare received device identification information from the link partner with expected device identification information configured by a management agent; and wherein the transaction layer is gated by the circuit, the transaction layer being enabled when the circuit indicates a validated state, and the UALink-based port being blocked from carrying transactions when the circuit indicates an invalid state. The device may be an accelerator or a switch in the network. The port may include a physical layer, a data link layer, a transaction layer, and a protocol level interface arranged in a protocol stack, where enabling each higher layer depends on successful operation of the lower layers. The circuit may be implemented as hardware logic within the device, and the validated and invalid states may be maintained in registers accessible to the management agent for reporting but not overridable by software. The data link layer may reach the operational state after completing link training at the physical layer and exchanging a series of initialization messages at the data link layer. The expected device identification information may include a device identifier, a device type, and a port number that the management agent programs into the circuit before enabling the physical layer and data link layer on the port.

In some implementations of the device, the device identification messages comprise: a device identifier request carrying a device identifier and a device type field indicating at least one of: a switch or an accelerator, and a corresponding response; and a port number request carrying a port number and a corresponding response. The device identifier request may carry the requesting device's own identifier and type, and the link partner may respond with its own identifier and type. Similarly, the port number request may carry the requesting device's own port number. Each message type may follow a request-response pattern where one outstanding request is permitted at a time.

In some implementations of the device, the link partner is required to respond to each device identification message within a response timeout, and wherein the circuit transitions to the invalid state when the response is not received within the response timeout. The response timeout may prevent the circuit from remaining indefinitely in a discovering state when the link partner is unresponsive or malfunctioning. Upon timeout, the circuit may report the invalid state to the management agent for diagnostic purposes.

In some implementations of the device, the circuit supports independently configurable checks comprising: a device identifier and type check, and a port number check, each independently enabled or disabled by the management agent; and wherein when all checks are disabled, the circuit transitions directly to the validated state without performing comparisons. The independently configurable checks may allow flexible deployment configurations. In environments where cabling is pre-verified, all checks may be disabled to reduce initialization latency. In multi-tenant environments, all checks may be enabled for maximum safety. Partial configurations may enable device identifier checking while disabling port number checking, or vice versa.

In some implementations of the device, enabling the transaction layer further requires: a configured transaction layer admin state of enabled, and the data link layer being in an operational-up state; and wherein all three conditions are required for the transaction layer to be enabled. The three-condition gate may provide defense-in-depth: the administrative state allows management control, the data link operational state confirms link health, and the validation state confirms correct connectivity. All three conditions being true may be required before the transaction layer begins credit exchange and protocol level interface connection handshake.

In some implementations of the device, the invalid state is hardware-enforced, and the UALink-based port remains blocked from carrying transactions in the invalid state regardless of a configuration of the transaction layer admin state by the management agent. The hardware enforcement may prevent a compromised or misconfigured management agent from overriding the validation gate to force traffic on a miscabled link. The invalid state may be exited by re-executing the validation sequence with correct expected neighbor information.

In some implementations of the device, the UALink-based port transitions through ordered initialization sub-steps comprising physical layer training, data link layer bringup, neighbor validation, route installation, and transaction layer bringup, wherein each sub-step gates enablement of the subsequent sub-step. The ordered gating may prevent higher-layer protocols from being enabled prematurely. For example, neighbor validation may complete before forwarding entries are installed, and forwarding entries may be installed before the transaction layer begins credit exchange. This ordering may prevent transactions from flowing through incorrect routes during initialization.

In some implementations of the device, when any sub-step fails, the UALink-based port transitions to an operationally-down state with a reason identifying which protocol layer failed, and a management agent reports the reason to a centralized controller. The reason may distinguish between physical layer failure, data link layer failure, transaction layer failure, and protocol level interface failure. The centralized controller may use the reason to select an appropriate recovery strategy targeting the specific failed layer.

In some implementations of the device, the UALink-based port supports a degraded operational state in which the UALink-based port continues to carry transactions despite recoverable errors exceeding a threshold, with a link quality indicator reporting a health level of the UALink-based port. The link quality indicator may transition between healthy, marginal, and unhealthy levels based on error rate heuristics. The degraded state may allow continued operation while alerting the management plane that the port is experiencing elevated errors and may require maintenance.

In some implementations of the device, upon a link width change event on the UALink-based port, the data link layer re-exchanges device identification messages with the link partner, and the circuit re-validates the received device identification information against the expected device identification information. Link width changes may occur during link folding or link resiliency events where the number of active physical lanes changes. Re-validation after a width change may confirm that the link partner has not changed and that the connection remains correctly established.

In some implementations of the device, the circuit transitions through states comprising: a none state upon reset; a configured state when the management agent programs the expected device identification information; a discovering state when the data link layer reaches the operational state; the validated state when received information matches expected information; the invalid state when received information does not match or a timeout occurs; and an operating state when the transaction layer is enabled. The six states may represent a complete lifecycle of the validation process from initial reset through active operation. The none state may be the default after device power-on or reset. The transition from validated to operating may occur when all enablement preconditions are satisfied.

In some implementations of the device, the management agent configures the expected device identification information on the circuit before enabling a physical layer and the data link layer of the UALink-based port. Configuring expected neighbor information before enabling the physical and data link layers may allow the circuit to begin validation as soon as the data link layer reaches the operational state, without requiring a separate configuration step after link training completes.

FIG. 1B illustrates a method for validating connectivity in an accelerator interconnect network, which may be performed at each device in the network. The method may involve exchanging device identification information at the data link layer after the link is established, comparing the received information with expected values, and conditionally enabling the transaction layer and protocol level interface based on the comparison result. The method may be implemented in firmware, hardware logic, or a combination thereof, and may be performed on every port of the device independently.

In various implementations, a method for validating connectivity in an Ultra Accelerator Link (UALink)-based network, comprising: transitioning a data link layer on a first UALink-based port of a first device to an operational state, the first UALink-based port coupled to a second UALink-based port of a second device; exchanging, via data link layer messages, device identification information between the first device and the second device; comparing, at the first device, received identification information from the second device with expected identification information configured by a management agent; transitioning to a validated state when the received identification information matches the expected identification information; and enabling a transaction layer on the first UALink-based port upon the validated state being achieved. The method may be performed at both ends of the link independently and concurrently. Each device may compare the identification information it receives from the link partner with the expected values that the management agent programmed before the physical layer and data link layer were enabled. The transition to the validated state may trigger the enablement of the transaction layer and the protocol level interface, which may then begin credit exchange and connection handshake procedures. The method may be performed during initial network bringup, after a link failure and recovery, or after a physical cable change.

In some implementations, the method further comprises transitioning to an invalid state when the received identification information does not match the expected identification information; and blocking the first UALink-based port from carrying transactions in the invalid state regardless of a configuration of a transaction layer admin state. Blocking the port in the invalid state may prevent any transactions from traversing a miscabled link. The blocking may be hardware-enforced, meaning that software configuration of the administrative state may not override the invalid state.

In some implementations of the method, the exchanging comprises: transmitting a device identifier request carrying a device identifier and a device type indicating at least one of: a switch or an accelerator; receiving a corresponding response from the second device; transmitting a port number request carrying a port number; and receiving a corresponding port number response from the second device. The device identifier and port number may be exchanged as separate message types at the data link layer. Each request may carry the transmitting device's own information, and the response may carry the link partner's corresponding information.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an apparatus configured to operate as a switch, wherein the apparatus comprises switching circuitry and is configured to perform the method.

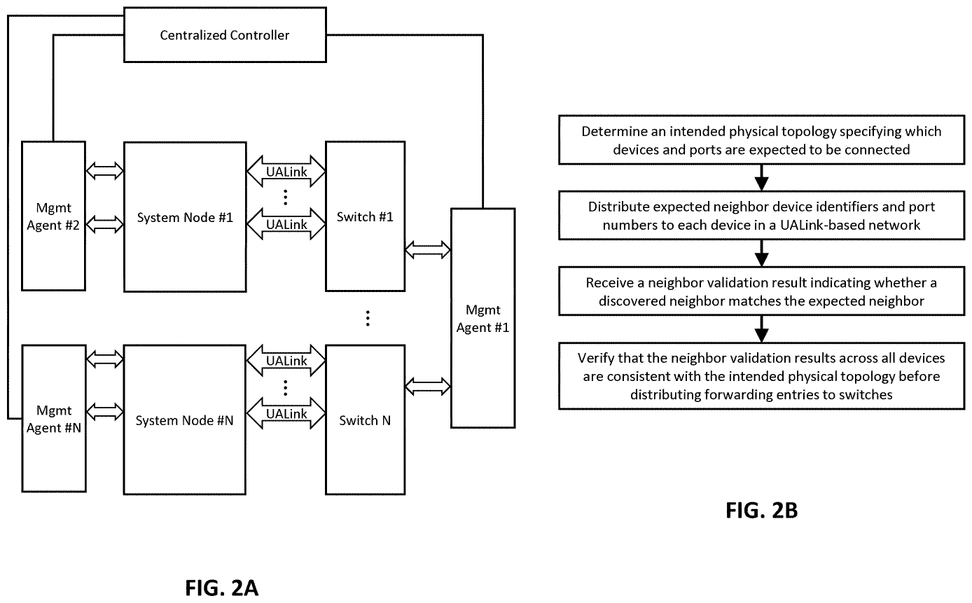

FIG. 2A illustrates a centralized controller that may verify the topology of an accelerator interconnect network at the system level by aggregating neighbor validation results from all devices. The centralized controller may distribute expected neighbor identifiers to each device based on an intended physical topology, and after each device performs its local neighbor validation, the centralized controller may collect the results and verify that the complete set of validation results is consistent with the intended topology. This system-level verification may be performed before the centralized controller distributes forwarding entries, preventing traffic from flowing through an incompletely verified or incorrectly cabled network. The verification may detect individual miswired connections, asymmetric failures, and topology configurations that violate connectivity rules.

In various implementations, a system for verifying topology of an Ultra Accelerator Link (UALink)-based network, comprising: a centralized controller coupled to switches and accelerators via an out-of-band management network; management agents, each managing one or more of the switches or the accelerators; wherein the centralized controller is configured to: distribute expected neighbor identifiers for each port to each device via the management agents based on an intended physical topology; receive neighbor validation results from each device via the management agents; and verify that a complete set of the neighbor validation results is consistent with the intended physical topology before distributing forwarding entries to the switches. The centralized controller may determine the intended physical topology from a configuration database, an administrator-provided specification, or a previously discovered topology. The expected neighbor identifiers may include a device identifier, a device type, and a port number for each port on each device. The centralized controller may distribute these expected values to switch management agents via a control plane protocol and to node management agents via a device management protocol. The centralized controller may wait until all devices report their validation results before verifying topology consistency. The verification may compare each reported neighbor against the expected neighbor and confirm that the aggregated results form a consistent, fully connected topology. Forwarding entries may be withheld until verification completes, preventing transactions from flowing through an unverified network.

In some implementations of the system, the centralized controller is further configured to construct a topology graph from the neighbor validation results and verify that the topology graph satisfies connectivity rules comprising: each of the accelerators has a same number of ports, each of the switches is coupled to each of the accelerators, and all ports use a same bifurcation mode. The connectivity rules may reflect architectural requirements of the network. The uniform port count rule may allow each accelerator to have equal bandwidth to the switches. The full connectivity rule may allow any accelerator to reach any other accelerator through any switch. The uniform bifurcation rule may allow consistent routing across all switches.

In some implementations of the system, the centralized controller is configured to verify that for each link, a switch port's discovered neighbor identifier matches the accelerator port's discovered neighbor identifier, detecting asymmetric failures. Asymmetric failures may occur when one end of a link reports a validated neighbor while the other end reports an invalid neighbor, potentially due to a unidirectional cable fault or a device firmware issue. Cross-validation may catch such failures before traffic is enabled.

In some implementations of the system, the centralized controller is configured to verify that no accelerator in one virtual partition shares a physical switch port with an accelerator in a different virtual partition. Virtual partitions may provide multi-tenant isolation. Verifying physical topology isolation may confirm that routing isolation between virtual partitions is supported by the physical connectivity, preventing potential traffic leakage between tenants. In some examples, a virtual partition refers to a virtual pod (vPod).

In some implementations of the system, when tearing down a virtual partition, a data link layer on affected ports remains active and neighbor validation states remain in the validated state, enabling creation of a new virtual partition on the same physical links without re-executing neighbor discovery. Preserving the data link layer and validation states during teardown may reduce the time required to create a subsequent virtual partition from the same accelerators, because physical layer training and neighbor discovery do not need to be re-executed.

In some implementations of the system, when one or more ports report an invalid neighbor validation result, the centralized controller is configured to identify specific miswired connections based on the invalid results and generate a diagnostic report indicating which ports have incorrect neighbors. The diagnostic report may indicate which physical cable should be moved, what the expected and actual neighbors are for each invalid port, and whether the issue is a cable swap, a missing connection, or an incorrect device placement. The report may reduce mean-time-to-repair during deployment.

In some implementations of the system, after a physical cable change, the centralized controller triggers re-validation on affected ports by cycling a configured neighbor state on the affected ports, without disrupting validated neighbors on unaffected ports. Cycling the configured neighbor state may cause the affected ports to re-enter the discovering state and re-exchange device identification messages with the new link partner. Unaffected ports may remain in the operating state and continue carrying transactions.

FIG. 2B illustrates a method for verifying topology of an accelerator interconnect network at the system level, which may involve a centralized controller determining an intended physical topology, distributing expected neighbor identifiers to each device, receiving validation results, and verifying consistency before enabling traffic. The method may be performed during initial network bringup, after error recovery, or after physical cable changes.

In various implementations, a method for verifying topology of an Ultra Accelerator Link (UALink)-based network, comprising: determining, by a centralized controller, an intended physical topology specifying which devices and ports are expected to be connected; distributing, via management agents over an out-of-band management network, expected neighbor device identifiers and port numbers to each device in the UALink-based network; receiving, from each device via the management agents, a neighbor validation result indicating whether a discovered neighbor matches the expected neighbor; and verifying, by the centralized controller, that the neighbor validation results across all devices are consistent with the intended physical topology before distributing forwarding entries to switches. The centralized controller may determine the intended physical topology from a configuration file, a hardware inventory system, or a previously validated topology stored in non-volatile storage. The expected neighbor identifiers may be distributed to switch management agents via a control plane protocol and to node management agents via a device management protocol. The centralized controller may collect validation results asynchronously as each device completes its local validation, and may proceed with verification once all expected results are received. The method may be performed during initial pod bringup, after a device failure and recovery, or after maintenance operations involving physical cable changes.

In some implementations, the method further comprises constructing, by the centralized controller, a topology graph from the neighbor validation results; and verifying that the topology graph satisfies connectivity rules comprising: each accelerator has a same number of ports, each switch is coupled to each accelerator, and all ports use a same bifurcation mode. The topology graph may represent devices as nodes and validated links as edges. The connectivity rules may be checked against the graph structure to confirm that the network meets architectural requirements before forwarding entries are computed and distributed.

In some implementations, the method further comprises when one or more ports report an invalid neighbor validation result, identifying specific miswired connections based on the invalid results; and generating a diagnostic report indicating which ports have incorrect neighbors. The diagnostic report may include the expected and actual device identifiers and port numbers for each invalid port, enabling an operator to locate and correct the miswired cables. The method may continue without enabling traffic on the invalid ports.

In some implementations, the method further comprises upon determining that the neighbor validation results are not consistent with the intended physical topology, withholding distribution of the forwarding entries and generating an alert indicating which portions of the topology do not match. Withholding forwarding entries may prevent transactions from flowing through an incorrectly cabled network. The alert may be transmitted to an operator or a workload orchestrator, enabling corrective action before traffic is enabled. In some implementations of the method, a non-transitory computer-readable medium comprising instructions which, when executed by a processor, cause the processor to perform the method.

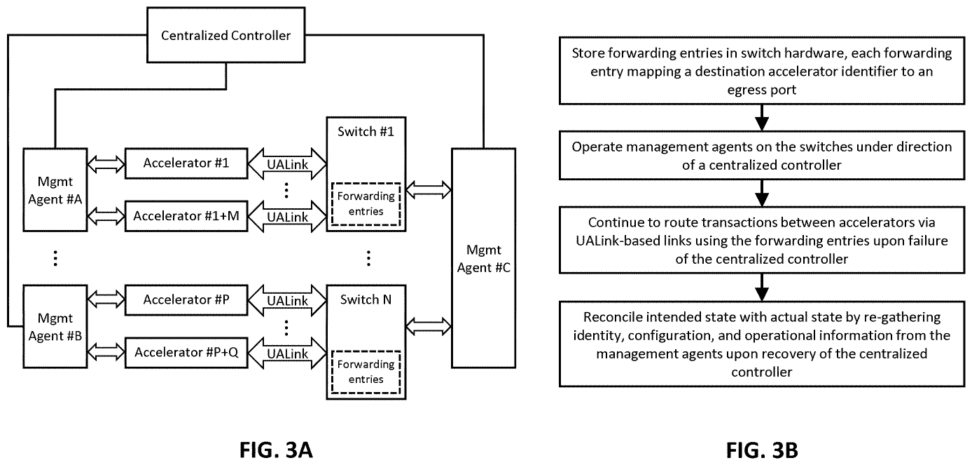

FIG. 3A illustrates a centralized controller generating forwarding entries that direct traffic between accelerators through switches. The forwarding entries may be distributed to the switches via management agents and installed into route tables in the switch hardware. Each forwarding entry may map a destination accelerator identifier to an egress port on a switch, enabling the switch to forward transactions addressed to a particular accelerator out the correct port. A key architectural property of the network may be that the forwarding entries are stored in the switch hardware and persist independently of the centralized controller and the management agents. This hardware persistence may enable continued data plane operation when management plane components fail. No timeout mechanism may cause the forwarding entries to expire, and the management agents may not hold route state that would be lost upon agent failure. When the centralized controller or a management agent fails, executing workloads on the accelerators may continue because the switches continue routing transactions using the persisted forwarding entries. Upon recovery of the centralized controller, the controller may reconcile its intended state with the actual state of the network by re-gathering information from the management agents and correcting any discrepancies.

In various implementations, a system for an Ultra Accelerator Link (UALink)-based network, comprising: a plurality of accelerators coupled to a plurality of switches via UALink-based links, the switches storing forwarding entries in hardware, each forwarding entry mapping a destination accelerator identifier to an egress port; a centralized controller coupled to management agents on the switches via an out-of-band management network, the centralized controller configured to generate and distribute the forwarding entries to the switches via the management agents; wherein the forwarding entries persist in the switches independently of the centralized controller; and wherein when the centralized controller fails, the switches continue routing transactions between the accelerators using the persisted forwarding entries, and executing workloads on the accelerators continue. The switches may store the forwarding entries in hardware route tables within the switch silicon. The route tables may be indexed by destination accelerator identifier and may contain an allow or deny indication and an egress port designation for each entry. The forwarding entries may remain in the route tables regardless of the state of the centralized controller or the management agents, because the route tables are implemented in persistent hardware registers that do not depend on software processes for retention. The centralized controller may generate the forwarding entries based on a topology constructed from identity information and operational state received from the management agents, and may distribute the entries to the switches via the management agents for installation into the route tables. When the centralized controller fails, the management agents may continue operating locally, and the switches may continue forwarding transactions between accelerators using the route tables without any software intervention.

In some implementations of the system, when a management agent managing one or more of the switches fails, executing workloads continue, and the forwarding entries persist in the switch hardware. The management agent managing switches may fail due to software errors, platform reboot, or resource exhaustion. Because the forwarding entries are in switch hardware, the management agent failure may not affect the data plane. The management agent may recover independently and re-gather state from the switches upon restart.

In some implementations of the system, when a management agent managing one or more of the accelerators fails, executing workloads continue. The management agent managing accelerators may fail without affecting executing workloads because the accelerators continue to send and receive transactions via the protocol level interface, and the switches continue routing using the persisted forwarding entries. Recovery of this management agent may be performed in a targeted time to minimize management plane downtime.

In some implementations of the system, no timeout mechanism causes the forwarding entries to expire during failure of the centralized controller. The absence of a route expiration timeout may prevent a scenario where forwarding entries are silently removed after a fixed duration, causing workload failures that would be difficult to diagnose. The forwarding entries may remain installed indefinitely until explicitly modified by the centralized controller upon recovery.

In some implementations of the system, each device in the UALink-based network generates error records in a common platform error record format upon workload-impacting failures, the error records persisting across device reboots and comprising a creator identifier matching a unique device identifier of the generating device. The error records may follow a standardized format that includes a valid record header, a creator identifier field, and a section containing vendor-defined diagnostic information sufficient for debugging common failures. The creator identifier may match the device's unique identifier assigned during device admission, enabling correlation of error records with specific devices during root cause analysis.

In some implementations of the system, the workload-impacting failures are recorded with a fatal error severity classification in the error records. The fatal error severity classification may distinguish workload-impacting failures from informational or warning-level events, enabling automated monitoring systems to prioritize fatal events for immediate attention.

In some implementations of the system, the centralized controller monitors management agent health via keepalive messages over the out-of-band management network, and detects a management agent failure when keepalive responses are not received within a dead interval. The keepalive messages may be exchanged at a configurable interval. The dead interval may be configured as a multiple of the keepalive interval with a jitter factor to avoid synchronized timeouts across multiple management agents. Upon detecting a management agent failure, the centralized controller may prepare for reconnection.

In some implementations of the system, during failure of the centralized controller, ports on the switches that are in an operationally-up state continue to carry transactions, and port operational states persist. Port operational states may include operationally-up, operationally-down, initializing, and degraded. Ports that were operationally-up before the centralized controller failure may remain in that state and continue forwarding transactions. Port state transitions that occur during headless operation, such as a transition from operationally-up to degraded due to increasing errors, may be recorded locally by the management agent for reporting upon controller recovery.

In some implementations, the system further comprises a secondary centralized controller configured to monitor a health of the centralized controller and assume management responsibilities upon failure of the centralized controller. The secondary centralized controller may maintain a synchronized copy of the intended network state and may take over management responsibilities upon detecting primary controller failure. This may provide continuous management without entering headless operation, and may enable faster recovery of the management plane.

In some implementations of the system, during failure of the centralized controller, the management agents continue local management operations comprising monitoring device health and collecting operational state changes from the switches and the accelerators. The management agents may continue to receive asynchronous notifications from the devices, monitor keepalive mechanisms local to each switch platform or system node, and accumulate operational state changes. Upon controller recovery, the management agents may report the accumulated changes to the centralized controller as part of the reconciliation process.

FIG. 3B illustrates a method for maintaining workload continuity during a management failure, comprising the continued use of forwarding entries stored in switch hardware while the centralized controller is unavailable. The method may further involve reconciling the intended network state with the actual state upon controller recovery, including re-gathering identity, configuration, and operational state from all management agents and correcting any discrepancies.

In various implementations, a method for maintaining workload continuity in an Ultra Accelerator Link (UALink)-based network during a management failure, comprising: storing forwarding entries in switch hardware, each forwarding entry mapping a destination accelerator identifier to an egress port; operating management agents on the switches under direction of a centralized controller via an out-of-band management network; upon failure of the centralized controller, continuing to route transactions between accelerators via UALink-based links using the forwarding entries stored in the switch hardware; and upon recovery of the centralized controller, reconciling intended state with actual state by re-gathering identity, configuration, and operational information from the management agents. The method may be applicable to failures of the centralized controller, management agents managing switches, and management agents managing accelerators. In each case, the data plane may continue operating using the forwarding entries stored in switch hardware. The reconciliation upon recovery may involve the centralized controller re-establishing connections to all management agents, comparing re-gathered state with the controller's intended state, and correcting any discrepancies found. The method may enable workload continuity across all management failure types without requiring workload checkpoint or restart.

In some implementations of the method, upon failure of the centralized controller, the management agents continue local management operations comprising monitoring device health and collecting operational state changes. The continued local operations may allow the management agents to maintain an accurate representation of device state that can be reported to the centralized controller upon recovery, enabling efficient differential reconciliation.

In some implementations of the method, no timeout mechanism causes the forwarding entries to expire during failure of the centralized controller. The indefinite persistence of forwarding entries may allow workloads to execute for an unbounded duration during controller failure, limited by factors external to the management plane. In some implementations of the method, a non-transitory computer-readable medium comprising instructions which, when executed by a processor, cause the processor to perform the method.

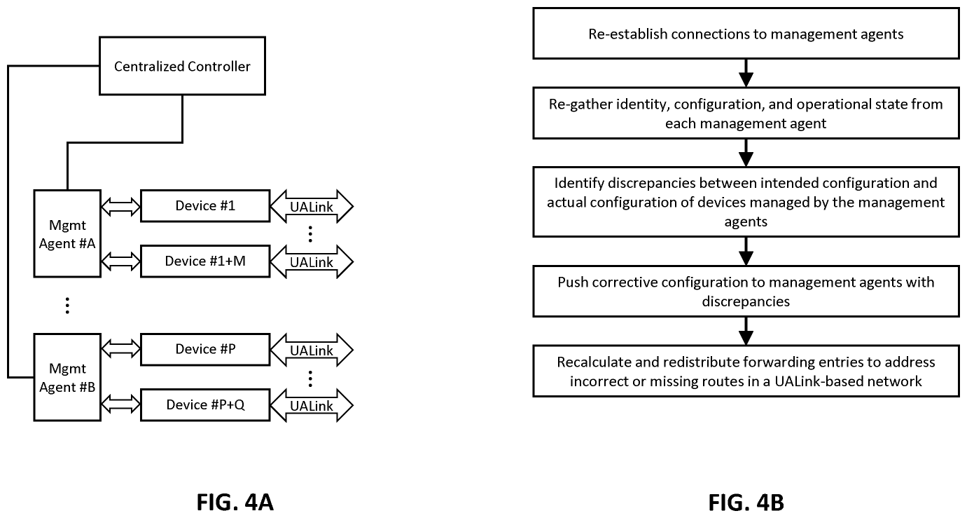

FIG. 4A illustrates system comprising a centralized controller that upon recovery from a failure may execute a reconciliation pipeline to restore management plane consistency. The reconciliation pipeline may involve re-establishing connections to all management agents, re-gathering the current identity, configuration, and operational state of all devices, comparing this re-gathered state with the controller's intended state, identifying and correcting any discrepancies, and recalculating and redistributing forwarding entries to address incorrect or missing routes. The pipeline may be designed to restore data plane correctness as quickly as possible, prioritizing forwarding entry reconciliation over configuration attribute reconciliation. The centralized controller may maintain a cached copy of the last-known state for each management agent, enabling differential reconciliation that identifies the changes that occurred during the disconnection rather than requiring a full re-sweep of all state.

In various implementations, a management system for an Ultra Accelerator Link (UALink)-based network, comprising: a centralized controller coupled to a plurality of management agents via an out-of-band management network, each management agent managing one or more devices in the UALink-based network; wherein upon failure and recovery of the centralized controller, the centralized controller is configured to: re-establish connections to the plurality of management agents via the out-of-band management network; re-gather identity, configuration, and operational state from each management agent; identify discrepancies between intended configuration and actual configuration; push corrective configuration to management agents with discrepancies; and recalculate and redistribute forwarding entries to address incorrect or missing routes in the UALink-based network. The centralized controller may maintain an intended state representing the desired configuration and route tables for the entire network. Upon recovery, the centralized controller may compare the re-gathered state from each management agent with the intended state to determine whether any configuration was lost, modified, or corrupted during the disconnection. The corrective configuration may include device identifiers, virtual partition membership, port administrative states, and neighbor validation parameters. Forwarding entries may be recalculated based on the current operational state, which may have changed if devices failed and recovered during the controller's absence. The redistributed forwarding entries may be installed into switch route tables via the management agents, restoring correct routing for all active virtual partitions.

In some implementations of the system, the centralized controller maintains a cached copy of a last-known state for each management agent, and upon reconnection, performs differential reconciliation by comparing re-gathered state with the cached state to identify changes that occurred during the disconnection. Differential reconciliation may be more efficient than a full re-sweep because the changed state elements need correction. The cached state may include operational attributes of ports, neighbor validation states, and forwarding entry contents at the time of the last successful synchronization.

In some implementations of the system, the centralized controller re-establishes connections to the plurality of management agents concurrently. Concurrent re-connection may minimize total recovery time by initiating connection establishment to all management agents in parallel rather than sequentially. The centralized controller may proceed with re-gathering from each management agent as soon as its connection is established.

In some implementations of the system, the centralized controller prioritizes reconciliation of the forwarding entries over configuration attributes, restoring data plane correctness before management plane completeness. Prioritizing forwarding entry reconciliation may reduce the time during which incorrect routes could affect executing workloads. Configuration attributes such as port naming, administrative metadata, and monitoring parameters may be reconciled after the data plane is confirmed correct.

In some implementations of the system, a management agent presenting a resource tree describing accelerators maintains the resource tree in a stable state across disconnections from the centralized controller and across management agent restarts. The stable resource tree may allow the centralized controller to find the same device model upon reconnection, simplifying the re-gathering process. The resource tree may persist in non-volatile storage or be reconstructed deterministically from hardware enumeration.

In some implementations of the system, upon recovery of a management agent managing one or more switches, the centralized controller collects all forwarding entries from the switches via the recovered management agent to confirm that forwarding state did not change during management agent downtime. Collecting all forwarding entries may allow the centralized controller to compare each installed entry against the intended entry. If all entries match, the centralized controller may confirm that no corrective action is needed and may proceed to reconcile configuration attributes.

In some implementations of the system, upon recovery, the centralized controller gathers error records from all devices, correlates records with matching timestamps across devices to identify systemic failures, and generates a correlated failure report. Correlated error records may indicate systemic issues such as power supply failures, cable degradation, or environmental conditions affecting multiple devices simultaneously. The correlated failure report may assist operators in identifying root causes that individual device error records would not reveal.

In some implementations of the system, upon completing the reconciliation, the centralized controller notifies a workload orchestrator of configuration changes that occurred during the disconnection, enabling the workload orchestrator to take corrective action at an application level. The notification may include which virtual partitions were affected, whether any forwarding entries were modified, and whether any devices experienced failures during the controller's absence. The workload orchestrator may use this information to determine whether workloads need to be restarted, migrated, or can continue operating.

In some implementations of the system, after recovering a failed switch, the centralized controller triggers re-execution of a port bringup sequence on affected ports of the switch, the sequence comprising re-enabling data link layers, re-validating neighbors, and re-installing forwarding entries before enabling the affected ports to carry transactions. The port bringup sequence may follow an ordered set of sub-steps where each sub-step gates the next. Re-enabling data link layers may trigger neighbor discovery, neighbor validation may confirm correct connectivity, and forwarding entry installation may restore correct routing before transactions are permitted.

In some implementations of the system, the centralized controller pre-computes recovery actions for anticipated failure scenarios, enabling faster reconciliation upon actual failure by executing a pre-computed plan rather than computing corrections in real time. Pre-computed recovery plans may include alternate forwarding entry sets for common failure scenarios such as the loss of a single switch, a single accelerator, or a single link. Upon detecting the specific failure, the centralized controller may apply the pre-computed plan, reducing the time required to restore correct routing.

FIG. 4B illustrates a method for recovering management of an accelerator interconnect network, which may be executed by a centralized controller upon recovering from a failure. The method may involve re-establishing connections to all management agents, re-gathering the current state of all devices, and identifying and correcting any discrepancies between the intended and actual network state. The method may prioritize restoring data plane correctness and may use differential comparison with cached pre-failure state to efficiently identify changes.

In various implementations, a method for recovering management of an Ultra Accelerator Link (UALink)-based network after a centralized controller failure, comprising: re-establishing, by the centralized controller, connections to a plurality of management agents via an out-of-band management network; re-gathering identity, configuration, and operational state from each management agent; identifying discrepancies between intended configuration and actual configuration of devices managed by the management agents; pushing corrective configuration to management agents with discrepancies; and recalculating and redistributing forwarding entries to address incorrect or missing routes in the UALink-based network. The method may be performed each time the centralized controller recovers from a failure, whether the failure was caused by a software crash, a hardware reboot, or a network partition. The re-establishing step may involve the centralized controller initiating connection setup with each management agent, including mutual authentication and protocol capability negotiation. The re-gathering step may involve requesting identity information describing device types and firmware versions, configuration information describing assigned identifiers and virtual partition membership, and operational state including port states, neighbor validation results, and link quality indicators. The identifying step may compare the re-gathered state against the intended state that the centralized controller maintained before the failure. The corrective configuration may include any intended configuration that was not yet applied or that was lost during device events that occurred during the failure. The forwarding entry recalculation may account for devices that failed and recovered during the controller's absence.

In some implementations of the method, the re-establishing comprises connecting to the plurality of management agents concurrently, tracking a connection state for each management agent independently, and proceeding with re-gathering from each management agent upon successful connection without waiting for all connections to be established. Independent tracking may allow the centralized controller to begin reconciling devices managed by an already-connected management agent while other management agents are still being contacted. This progressive approach may reduce total recovery time compared to waiting for all connections before beginning any re-gathering.

In some implementations of the method, the identifying discrepancies comprises: comparing the re-gathered identity, configuration, and operational state with a cached copy of a last-known state maintained by the centralized controller before the failure, the cached state comprising operational attributes of ports, neighbor validation states, and forwarding entry contents; and categorizing discrepancies as additions, deletions, or modifications that occurred during the centralized controller failure. Categorizing discrepancies may enable the centralized controller to apply targeted corrections. Additions may represent new devices admitted during the failure. Deletions may represent devices that were removed or failed. Modifications may represent configuration changes made by management agents acting on local policies.

In some implementations, the method further comprises verifying forwarding entries installed in the switches against intended forwarding entries computed by the centralized controller; correcting any forwarding entry mismatches before verifying configuration attributes; and upon completing forwarding entry correction, verifying and correcting configuration attributes comprising accelerator identifiers, virtual partition membership, and port administrative states. Verifying forwarding entries first may minimize the window during which incorrect routes could affect executing workloads. Accelerator identifiers, virtual partition membership, and port administrative states may be reconciled after the data plane routing is confirmed correct.

In some implementations, the method further comprises upon completing the reconciliation, generating a reconciliation report identifying which virtual partitions were affected by changes during the centralized controller failure, whether any forwarding entries were modified or missing, and whether any devices experienced failures; and transmitting the reconciliation report to a workload orchestrator, enabling the workload orchestrator to determine whether affected workloads require restart or can continue. The reconciliation report may include a per-virtual-partition summary of changes, a list of devices that experienced failures and their recovery status, and an overall network health assessment. The workload orchestrator may use this information to reschedule workloads, trigger checkpoints, or confirm that running workloads are unaffected. In some implementations of the method, a non-transitory computer-readable medium comprising instructions which, when executed by a processor, cause the processor to perform the method.

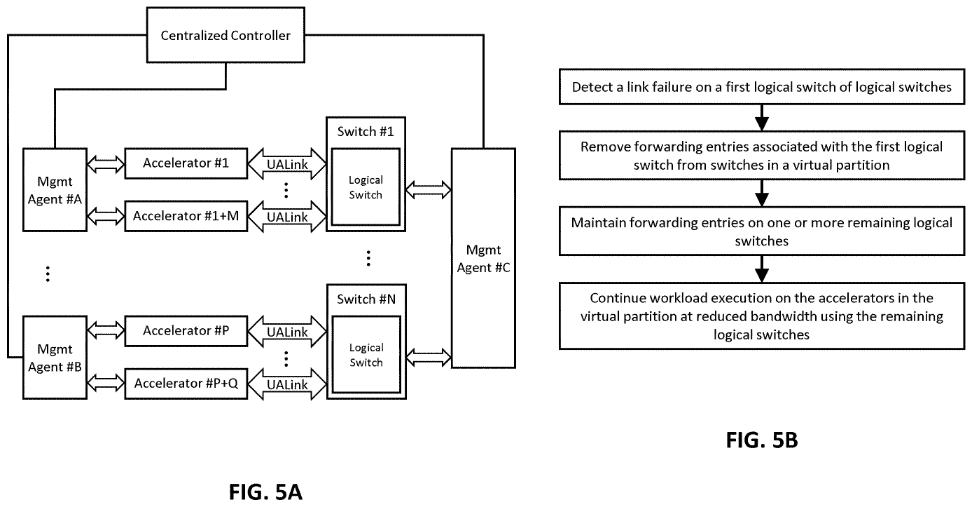

FIG. 5A illustrates accelerators coupled to switches via high-bandwidth links, wherein each physical switch may include one or more logical switches providing multiple independent switching paths. When a link fails on one logical switch, the centralized controller may remove forwarding entries on that logical switch from the affected virtual partition while maintaining forwarding entries on other logical switches, enabling continued operation at reduced bandwidth. This scoped containment approach may prevent a single link failure from disrupting the entire virtual partition. The centralized controller may evaluate the impact of the failure on active workloads before removing forwarding entries, and may coordinate with a workload orchestrator to trigger application-level checkpoints or workload migration when the reduced bandwidth is insufficient for the workload's communication pattern.

In various implementations, a system for managing errors in an Ultra Accelerator Link (UALink)-based network, comprising: a plurality of accelerators coupled to a plurality of switches via UALink-based links, each switch comprising one or more logical switches; a centralized controller configured to: receive a notification of a link failure on a first logical switch; in response to the link failure, remove forwarding entries on the first logical switch from a virtual partition while maintaining forwarding entries on a second logical switch; and wherein the virtual partition continues operating at reduced bandwidth using the second logical switch. The plurality of logical switches within each physical switch may provide independent switching paths between accelerators, and the centralized controller may maintain separate forwarding entries for each logical switch. When a link fails on one logical switch, the failure may affect the forwarding entries on that logical switch, while forwarding entries on other logical switches may remain valid and operational. The reduced bandwidth may correspond to the aggregate bandwidth of the remaining logical switches. The centralized controller may receive the notification from a management agent on the switch or accelerator at either end of the failed link. The forwarding entry removal may be performed by instructing the management agent to delete the relevant route entries from the route table on the affected logical switch. In some examples, a virtual partition refers to a virtual pod comprising a non-overlapping subset of accelerators within a pod that may communicate amongst themselves but not with accelerators outside the subset. The virtual partition may be assigned to a single tenant, and the switches may enforce traffic isolation between virtual partitions by partitioning switch ports into non-overlapping subsets. The centralized controller may create and tear down virtual partitions independently without affecting other active virtual partitions.

In some implementations of the system, when the first logical switch is the only logical switch serving a pair of accelerators in the virtual partition, the centralized controller removes the impacted accelerator from the virtual partition. When no alternative logical switch exists, removing forwarding entries on the only logical switch would leave the affected accelerators unreachable. Removing the impacted accelerator from the virtual partition may allow the remaining accelerators to continue operating and accepting new work.

In some implementations of the system, the link failure comprises a long-lasting failure of a physical layer to enter or remain in a trained state, excluding transient failures automatically recovered by link-level retry. Transient failures that are automatically recovered by link-level retry mechanisms may not require management-level intervention. The scoped containment may be triggered for persistent failures where the physical layer cannot maintain a trained link state.

In some implementations of the system, upon the link failure, both a switch and an accelerator on each end of a failed link generate error records that persist across device reboots, the error records including a device-unique identifier in a creator field. The error records at both ends of the failed link may provide diagnostic information from each device's perspective. The device-unique identifier in the creator field may enable correlation of error records with specific devices when multiple failures occur simultaneously.

In some implementations of the system, before removing forwarding entries on the first logical switch, the centralized controller evaluates impact on active workloads by determining whether reduced bandwidth provided by remaining logical switches is sufficient for a workload communication pattern, and if insufficient, triggering workload migration before route removal. The impact assessment may compare the remaining bandwidth against the workload's communication requirements. For workloads tolerant of reduced bandwidth, such as batch training with relaxed synchronization deadlines, the centralized controller may proceed with route removal. For latency-sensitive workloads, migration to a fully connected virtual partition may be initiated first.

In some implementations of the system, the centralized controller tracks a number of healthy logical switches per virtual partition and transitions a health status based on the number of remaining logical switches, alerting a workload orchestrator at each health transition. The health status may transition through levels such as healthy, degraded, and a reduced state based on the ratio of healthy logical switches to total logical switches. The workload orchestrator may use these transitions to adjust scheduling decisions or prepare migration plans.

In some implementations of the system, when removing forwarding entries from the first logical switch, the centralized controller redistributes affected traffic flows to the remaining logical switches based on available bandwidth capacity, using flow-based forwarding entries to balance load. Flow-based forwarding entries may allow the centralized controller to direct different source-destination pairs through different logical switches, distributing the traffic previously carried by the failed logical switch across the remaining logical switches in proportion to their available capacity.

In some implementations of the system, upon detecting the link failure that will impact a running workload, the centralized controller notifies a workload orchestrator to trigger an application-level checkpoint before removing forwarding entries. Triggering a checkpoint before route removal may allow the workload to be resumed from a recent state if the reduced bandwidth proves insufficient, rather than restarting from the beginning of the training iteration or from a much older checkpoint.

In some implementations of the system, after repair of the failed link on the first logical switch, the centralized controller re-validates neighbors on affected ports, re-installs forwarding entries on the first logical switch, and restores the virtual partition to full bandwidth operation. The restoration sequence may include re-enabling the data link layer, re-executing neighbor validation to confirm the repaired link connects the correct devices, and re-installing forwarding entries on the first logical switch. The centralized controller may redistribute traffic flows back across all logical switches to restore balanced full-bandwidth operation.

In some implementations of the system, the centralized controller notifies a workload orchestrator when the virtual partition transitions between full bandwidth and reduced bandwidth states, enabling the workload orchestrator to adjust workload scheduling based on available bandwidth. The notification may include the current number of healthy logical switches, the estimated available bandwidth, and the affected virtual partition. The workload orchestrator may use this information to defer launching new communication-intensive workloads until bandwidth is restored.

FIG. 5B illustrates a method for recovering from a link failure in an accelerator interconnect network, which may involve detecting the failure, evaluating its impact, removing forwarding entries on the impacted logical switch, and continuing workload execution at reduced bandwidth. The method may be performed by a centralized controller in response to notifications from management agents.

In various implementations, a method for recovering from a link failure in an Ultra Accelerator Link (UALink)-based network, comprising: detecting a link failure on a first logical switch of a plurality of logical switches, the plurality of logical switches coupling a plurality of accelerators to a plurality of switches via UALink-based links; removing, by a centralized controller, forwarding entries associated with the first logical switch from the switches in a virtual partition; maintaining forwarding entries on one or more remaining logical switches; and continuing workload execution on the accelerators in the virtual partition at reduced bandwidth using the remaining logical switches. The method may be triggered by a notification from a management agent on a switch or accelerator at either end of the failed link. The centralized controller may identify which logical switch is affected by the failure and may selectively remove the forwarding entries associated with that logical switch from each switch in the virtual partition. The remaining forwarding entries on other logical switches may continue directing traffic between accelerators. The reduced bandwidth may be proportional to the number of remaining healthy logical switches relative to the original number.

In some implementations of the method, the removing comprises selectively deleting forwarding entries associated with the first logical switch from route tables on each switch in the virtual partition, while preserving all forwarding entries associated with the remaining logical switches in the route tables. Selective deletion may be performed by the centralized controller instructing management agents to remove specific route entries indexed by destination accelerator identifier on the impacted logical switch, without modifying entries on other logical switches within the same physical switch.

In some implementations, the method further comprises before removing the forwarding entries, evaluating whether reduced bandwidth provided by the remaining logical switches is sufficient for a communication pattern of an active workload; and when the reduced bandwidth is insufficient, triggering workload migration before the removing. The evaluation may compare the aggregate bandwidth of the remaining logical switches against bandwidth requirements derived from the workload's communication pattern, such as all-to-all collective operations or gradient synchronization.

In some implementations of the method, a non-transitory computer-readable medium comprising instructions which, when executed by a processor, cause the processor to perform the method.

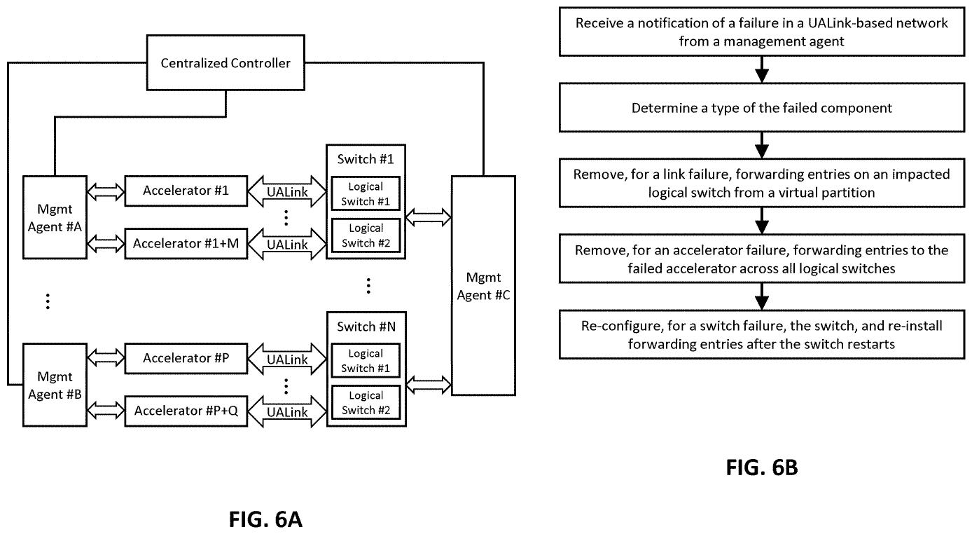

FIG. 6A illustrates a centralized controller that may apply different recovery strategies based on the type of component that failed. For a link failure, the centralized controller may remove forwarding entries on the impacted logical switch from the affected virtual partition, allowing continued operation at reduced bandwidth. For an accelerator failure, the centralized controller may remove all forwarding entries to the failed accelerator across all logical switches, allowing remaining accelerators to continue and accept new work. For a switch failure, the centralized controller may perform a full recovery including re-configuration, neighbor re-validation, and forwarding entry re-installation after the switch restarts. The centralized controller may receive failure notifications from management agents via the out-of-band management network and may determine the failure type based on the notification content.

In various implementations, a system for managing errors in an Ultra Accelerator Link (UALink)-based network, comprising: a plurality of accelerators coupled to a plurality of switches via UALink-based links, each switch comprising one or more logical switches; a centralized controller coupled to management agents on the switches and the accelerators via an out-of-band management network; wherein the centralized controller is configured to apply a recovery strategy based on a type of failed component: for a link failure, the centralized controller is configured to remove forwarding entries on an impacted logical switch from a virtual partition; for an accelerator failure, the centralized controller is configured to remove forwarding entries to the failed accelerator across all logical switches; and for a switch failure, the centralized controller is configured to re-configure the switch and re-install forwarding entries after the switch restarts. The centralized controller may receive failure notifications from management agents and may determine the failure type based on the content of the notification, including which device reported the failure, the nature of the failure, and the scope of impact. The three recovery strategies may reflect the different containment scopes: a link failure may be contained to a single logical switch, an accelerator failure may affect all paths to that accelerator across all logical switches, and a switch failure may require complete re-initialization of the switch. The centralized controller may execute the appropriate strategy automatically upon failure detection without manual intervention.

In some implementations of the system, for the accelerator failure, removing forwarding entries to the failed accelerator permits remaining accelerators in the virtual partition to accept new work. By removing the forwarding entries directed to the failed accelerator, the remaining accelerators may continue communicating with each other. The virtual partition may operate with fewer accelerators, and the workload orchestrator may assign new work to the remaining accelerators or schedule a replacement accelerator.

In some implementations of the system, for the switch failure, the recovery strategy further comprises: a management agent on the switch gathering error records after the switch restarts, the centralized controller re-gathering state from the management agent, the centralized controller pushing correct configuration, re-enabling data link layers on ports of the switch, re-validating neighbors, and re-installing forwarding entries. The switch failure recovery may follow an ordered sequence where each step depends on successful completion of the previous step. Error record gathering may provide diagnostic information about the failure cause. Re-gathering state may allow the centralized controller to determine the switch's current configuration after restart. Neighbor re-validation may confirm correct physical connectivity before forwarding entries are installed.

In some implementations of the system, for a management agent failure, executing workloads continue, and the centralized controller reconciles state upon management agent recovery. Management agent failures may not affect the data plane because forwarding entries persist in switch hardware independently of the management agent. Upon management agent recovery, the centralized controller may re-gather state to confirm that no changes occurred during the management agent's absence.

In some implementations of the system, the centralized controller correlates error records from a switch and an accelerator on both ends of a failed link, using device identifiers and timestamps to distinguish between cable failure, switch port failure, and accelerator port failure. Cable failures may produce symmetric error records at both ends with similar timestamps. Port failures may produce asymmetric records where one end reports errors before the other. The centralized controller may use these patterns to guide repair actions and generate diagnostic reports.

In some implementations of the system, upon concurrent failures of components, the centralized controller prioritizes recovery of components serving active workloads over components serving idle virtual partitions. Prioritizing active workloads may minimize the aggregate GPU-hours lost due to failures. The centralized controller may query the workload orchestrator or maintain an internal mapping of virtual partitions to workload states to determine priority.

In some implementations of the system, the centralized controller monitors telemetry trends including error correction histograms and link quality indicators, and initiates proactive route redistribution when a link quality indicator transitions from healthy to marginal, before the link fails. Proactive route redistribution may shift traffic away from a degrading link before it fails completely, preventing the sudden loss of bandwidth that occurs with reactive recovery. The link quality indicator may be derived from physical layer error rates and forward error correction statistics.

In some implementations of the system, when both a switch and an accelerator report failures simultaneously, the centralized controller coordinates recovery sequencing to restart the switch and re-install forwarding entries before re-admitting the accelerator. Coordinated sequencing may prevent the centralized controller from attempting to configure routes to an accelerator through a switch that has not yet completed its own recovery. Restarting the switch first may provide a functioning switching path for the accelerator to use upon re-admission.

In some implementations of the system, each device generates error records in a common platform error record format upon workload-impacting failures, the error records persisting across device reboots and including a creator identifier matching a unique device identifier of the generating device. The error records may follow a standardized format with a valid record header and vendor-defined diagnostic content. Persistence across reboots may allow error records generated before a device restart to be collected by the management agent after the restart completes.

In some implementations of the system, upon completing a recovery, the centralized controller notifies a workload orchestrator of the resulting network state, including the number of healthy logical switches per virtual partition and whether any accelerators were removed. The notification may enable the workload orchestrator to resume normal scheduling, launch deferred workloads, or initiate workload rebalancing based on the restored network capacity. The notification may include a summary of all actions taken during recovery.

FIG. 6B illustrates a method for managing errors in an accelerator interconnect network, which may involve receiving a failure notification, determining the type of failed component, and applying different recovery actions based on the failure type. The method may be performed by a centralized controller and may involve coordinating with management agents on switches and accelerators to execute the appropriate recovery strategy.

In various implementations, a method for managing errors in an Ultra Accelerator Link (UALink)-based network, comprising: receiving, at a centralized controller via an out-of-band management network, a notification of a failure in the UALink-based network from a management agent; determining, by the centralized controller, a type of the failed component; for a link failure, removing forwarding entries on an impacted logical switch from a virtual partition; for an accelerator failure, removing forwarding entries to the failed accelerator across all logical switches; and for a switch failure, re-configuring the switch and re-installing forwarding entries after the switch restarts. The method may be triggered by asynchronous notifications from management agents. The centralized controller may determine the failure type based on the content of the notification, including which device reported the failure and the nature of the failure event. The method may be executed automatically without manual intervention. For each failure type, the centralized controller may generate appropriate error records and update the network health status for monitoring purposes.

In some implementations of the method, the determining comprises analyzing the notification content including a device identifier of the reporting device, a port identifier of the affected port, and a failure reason indicating which protocol layer failed, and classifying the failure as a link failure, an accelerator failure, or a switch failure based on the analysis. The failure reason may distinguish physical layer failures, data link layer failures, device-level failures, and management agent failures. The device identifier and port identifier may enable the centralized controller to locate the failure in the topology and determine which virtual partitions are affected.

In some implementations of the method, for the link failure, the removing comprises identifying which logical switch is impacted based on a mapping between the failed link and logical switches, and selectively removing forwarding entries on the impacted logical switch from route tables on each switch in the virtual partition while preserving forwarding entries on all other logical switches. The mapping between physical links and logical switches may be maintained by the centralized controller as part of its topology representation. Selective removal may target specific route table entries indexed by destination accelerator identifier on the impacted logical switch.

In some implementations of the method, for the accelerator failure, the removing comprises removing forwarding entries to the failed accelerator from route tables on each logical switch of each switch in the virtual partition, permitting remaining accelerators in the virtual partition to continue operating and to accept new work. Removing forwarding entries across all logical switches may prevent any switch from attempting to forward transactions to the unreachable accelerator. The remaining accelerators may continue communicating with each other using the unaffected forwarding entries.

In some implementations of the method, when both a switch and an accelerator report failures simultaneously, coordinating recovery sequencing to restart the switch and re-install forwarding entries before re-admitting the accelerator. Coordinated sequencing may prevent the centralized controller from installing routes to an accelerator through a switch that has not completed recovery. The switch recovery may be prioritized to restore the switching infrastructure before re-admitting endpoint devices. In some implementations of the method, a non-transitory computer-readable medium comprising instructions which, when executed by a processor, cause the processor to perform the method.

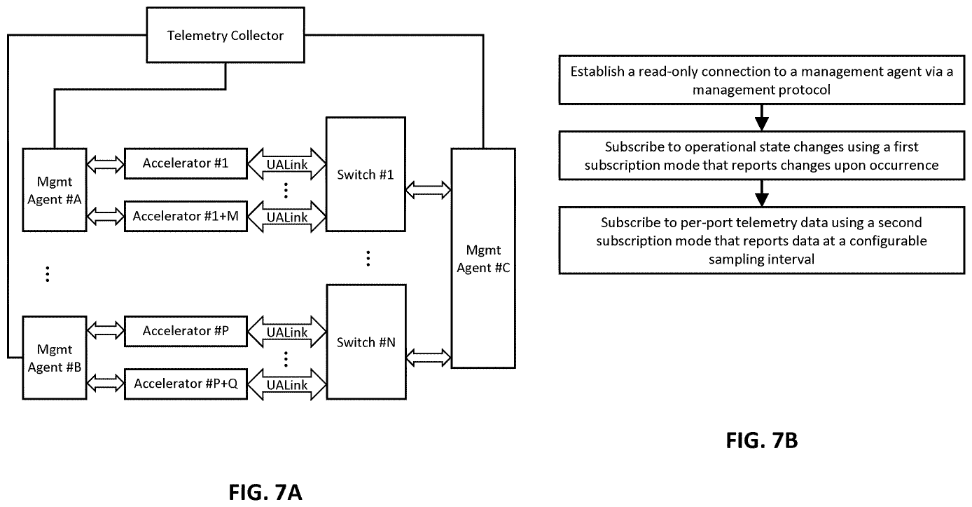

FIG. 7A illustrates telemetry collection that may provide visibility into the health and performance of devices and links. A telemetry collector may connect to management agents via a management protocol and may subscribe to operational state changes and telemetry data using different subscription modes. A first subscription mode may report operational state changes upon occurrence, enabling real-time visibility into port state transitions, neighbor validation events, and link quality changes. A second subscription mode may report telemetry data at a configurable sampling interval, enabling periodic collection of counters and histograms. The telemetry collector may have read-only access, meaning it may observe but not modify device configuration. When a device cannot push telemetry data to the management agent, the management agent may poll the device for the telemetry data and report the polled data to the telemetry collector, providing a transparent abstraction where the collector receives a uniform telemetry stream regardless of the underlying collection mechanism.

In various implementations, a telemetry system for an Ultra Accelerator Link (UALink)-based network, comprising: a plurality of devices comprising switches and accelerators, each device having one or more UALink-based ports, the devices managed by management agents; a telemetry collector configured to connect to the management agents via a management protocol, the telemetry collector having read-only access; and wherein the management agents are configured to support at least two subscription modes: a first subscription mode reporting operational state changes upon occurrence, and a second subscription mode reporting per-port telemetry data at a configurable sampling interval. The telemetry collector may connect to one or more management agents and may independently subscribe to different data categories using the appropriate subscription mode. Operational state changes may include port state transitions, link quality indicator changes, neighbor validation state changes, and device health events. Per-port telemetry data may include counters and histograms collected at multiple protocol layers. The configurable sampling interval may allow the telemetry collector to balance collection frequency against management network bandwidth consumption. The management protocol may provide mutual authentication and encryption for secure telemetry transport over the out-of-band management network.

In some implementations of the system, when a device cannot push telemetry data, the management agent is configured to poll the device for the telemetry data and report the polled data to the telemetry collector. The poll-fallback may be transparent to the telemetry collector, which may receive a uniform telemetry stream regardless of whether the device pushed the data or the management agent polled for it. The management agent may use a hardware abstraction interface to poll the device at the configured sampling interval.

In some implementations of the system, a plurality of telemetry collectors connect to a same management agent concurrently, each having read-only access and each receiving independent telemetry streams. Multiple concurrent telemetry collectors may serve different operational functions such as real-time monitoring, historical data collection, alerting, and analytics. Each collector may independently subscribe to different data categories with different sampling intervals without affecting other collectors.

In some implementations of the system, the management agents are configured to sample error-related telemetry attributes at a higher frequency than performance telemetry attributes. Error-related attributes may include physical layer error correction histograms, data link layer CRC error counters, and replay counters. Performance attributes may include byte transmission and reception counters. Higher sampling frequency for error attributes may enable faster detection of degrading links.

In some implementations, the system further comprises a second type of management agent associated with the accelerators, the second type of management agent configured to collect telemetry data from the accelerators via a vendor-defined interface and report the telemetry data to the telemetry collector. The vendor-defined interface may allow each accelerator vendor to implement telemetry collection in a manner appropriate for their hardware. The second type of management agent may normalize the vendor-specific telemetry into a common format before reporting to the telemetry collector.

In some implementations of the system, a centralized controller configures different sampling intervals for different telemetry categories based on a workload type, using higher sampling rates for credit utilization histograms during latency-sensitive operations and lower sampling rates during batch operations. Latency-sensitive operations such as real-time inference may benefit from frequent credit histogram sampling to detect congestion quickly. Batch training operations may tolerate longer sampling intervals, reducing management network bandwidth consumption during high-throughput phases.

In some implementations of the system, the telemetry collector stores collected telemetry data in a time-series database with configurable retention periods, enabling historical trend analysis across the UALink-based network. The time-series database may store per-port telemetry counters and histograms with timestamps, enabling queries over historical time ranges. The configurable retention periods may allow operators to balance storage cost against the depth of historical data available for analysis.

In some implementations of the system, the telemetry collector exports collected telemetry data to an external monitoring system via a telemetry export protocol, enabling integration with existing network monitoring infrastructure. The external monitoring system may include time-series databases, visualization dashboards, or alerting platforms. The telemetry export protocol may carry per-port counters, histograms, and operational state in a format compatible with the external system.

FIG. 7B illustrates a method for collecting telemetry in an accelerator interconnect network comprising a telemetry collector establishing a read-only connection to a management agent and subscribing to different data categories using appropriate subscription modes. The method may enable real-time visibility into operational state changes and periodic collection of per-port telemetry data.

In various implementations, a method for collecting telemetry in an Ultra Accelerator Link (UALink)-based network, comprising: establishing, by a telemetry collector, a read-only connection to a management agent via a management protocol, the management agent managing one or more devices having UALink-based ports; subscribing to operational state changes using a first subscription mode that reports changes upon occurrence; and subscribing to per-port telemetry data using a second subscription mode that reports data at a configurable sampling interval. The method may be performed by each telemetry collector independently for each management agent it monitors. The read-only connection may prevent the telemetry collector from modifying device configuration. The operational state subscription may provide immediate notification of events such as port state transitions and neighbor validation changes. The per-port telemetry subscription may provide periodic snapshots of counters and histograms at the configured interval.

In some implementations, the method further comprises at the management agent, determining that a managed device cannot push telemetry data; polling the device for the telemetry data at the configurable sampling interval; and reporting the polled telemetry data to the telemetry collector. The management agent may determine the device's push capability during device discovery. Polling may use a hardware abstraction interface to read counters and histograms from the device at each sampling interval.

In some implementations, the method further comprises receiving, from a centralized controller, sampling interval configurations for different telemetry categories based on a workload type; and applying the sampling interval configurations to the per-port telemetry subscriptions. The centralized controller may adjust sampling intervals when workload types change, enabling higher resolution monitoring during latency-sensitive phases and lower resolution during throughput-oriented phases.

In some implementations of the method, a non-transitory computer-readable medium comprising instructions which, when executed by a processor, cause the processor to perform the method.

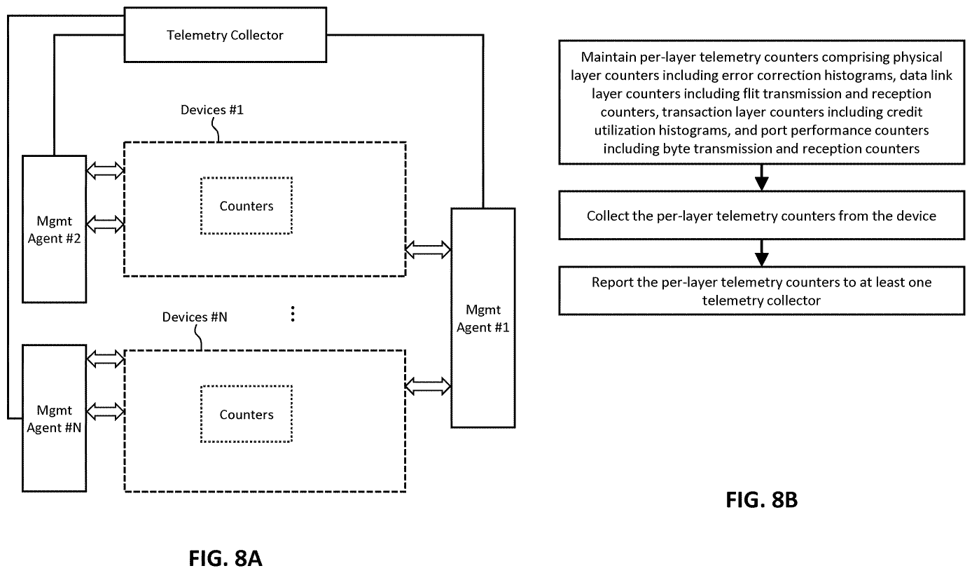

FIG. 8A illustrates a system wherein each port on a device in the accelerator interconnect network may maintain per-layer telemetry counters comprising counters and histograms at multiple protocol layers. Physical layer counters may include error correction histograms tracking the distribution of corrected symbol errors across codewords. Data link layer counters may include flit transmission and reception counters and error indicators. Transaction layer counters may include credit utilization histograms indicating how much time the port spends at different credit utilization levels. Port performance counters may include mandatory byte transmission and reception counters. A management agent may collect these per-layer counters and report them to a telemetry collector. The credit utilization histograms may be particularly valuable for detecting congestion and underutilization, as a high proportion of time in a stalled bin (zero available credits) may indicate congestion, while a high proportion of time in an idle bin (near-full credits) may indicate underutilization.

In various implementations, a telemetry system for an Ultra Accelerator Link (UALink)-based network, comprising: a plurality of devices, each device having one or more UALink-based ports, each port configured to maintain per-layer telemetry counters comprising: physical layer counters including error correction histograms, data link layer counters including flit transmission and reception counters, transaction layer counters including credit utilization histograms, and port performance counters including byte transmission and reception counters; and a management agent configured to collect the per-layer telemetry counters from the device and report them to at least one telemetry collector; wherein the credit utilization histograms comprise a plurality of bins, each bin indicating time spent at a corresponding credit utilization level. The per-layer telemetry counters may provide comprehensive visibility into the health and performance of each port at every protocol layer. The physical layer counters may indicate the quality of the physical medium and the effectiveness of error correction. The data link layer counters may indicate flit-level throughput and error rates. The transaction layer counters may indicate credit utilization patterns that reflect flow control health. The port performance counters may indicate aggregate byte-level throughput. The management agent may collect these counters at configurable intervals and may report them to one or more telemetry collectors via a management protocol. The credit utilization histograms may be implemented as hardware counters that accumulate time samples at each credit utilization level, providing a distribution over time rather than a point-in-time snapshot.

In some implementations of the system, the error correction histograms comprise a forward error correction histogram with a plurality of bins, each bin counting codewords with a corresponding number of corrected symbol errors. The forward error correction histogram may indicate the distribution of error severity across received codewords. A concentration of counts in the zero-error bin may indicate a healthy link. A shift toward higher error counts may indicate degrading physical medium or environmental conditions.

In some implementations of the system, the credit utilization histograms comprise at least: a first bin indicating zero available credits corresponding to a stalled state, bins indicating progressively higher credit utilization ranges, and a last bin indicating near-full credit availability corresponding to an idle state. The first bin may count time intervals where no credits were available, indicating the port was unable to send transactions. The progressively higher utilization bins may correspond to quartile ranges of the initial credits released. The last bin may indicate near-idle operation where available credits exceed a high proportion of the initial credits released.

In some implementations of the system, the credit utilization histograms are provided per virtual channel, with a separate histogram for each of a plurality of virtual channels on each port. Per-virtual-channel histograms may enable congestion detection and analysis at the individual virtual channel level. Congestion on one virtual channel may not affect other virtual channels, and per-VC monitoring may identify which traffic class is experiencing flow control pressure.

In some implementations of the system, the data link layer counters further comprise bad CRC error counters, link-level replay counters for both transmit and receive directions, and good flit counters. Bad CRC error counters may indicate flit corruption at the data link layer. Link-level replay counters may indicate how frequently the data link layer initiates or responds to replay requests due to detected errors. Good flit counters may provide a baseline for computing error rates.

In some implementations of the system, the byte transmission and reception counters at the port performance layer are mandatory for all devices in the UALink-based network. The mandatory byte counters may provide a universal baseline for computing port utilization and throughput across all devices in the network, regardless of vendor implementation. The counters may be accumulated with full resolution at the device.

In some implementations of the system, the telemetry collector or a centralized controller computes a link health score from the credit utilization histograms, wherein a high proportion of time in a stalled bin indicates congestion and a high proportion of time in an idle bin indicates underutilization. The link health score may be computed as a weighted combination of the histogram bin proportions, where time in the stalled bin contributes negatively and time in mid-range utilization bins contributes positively. The health score may be used to trigger alerts, inform routing decisions, or guide workload placement.

In some implementations of the system, the telemetry collector or a centralized controller correlates physical layer error correction events with data link layer replay events and transaction layer credit starvation events to identify a root cause of performance degradation as originating at a specific protocol layer. Cross-layer correlation may distinguish between performance degradation caused by physical medium issues (high FEC error counts), data link layer issues (high replay rates), and flow control issues (credit starvation). Identifying the originating layer may guide targeted corrective actions.

In some implementations of the system, a centralized controller monitors trends in the error correction histograms over time and triggers proactive maintenance when error rates increase beyond a threshold, before a link quality indicator transitions from healthy to marginal. Trend monitoring may involve comparing successive FEC histogram snapshots to detect a shift toward higher corrected-error bins over time. Proactive maintenance may include scheduling cable inspection, initiating link testing, or pre-computing alternate routing in anticipation of a potential failure.

In some implementations of the system, the credit utilization histograms further comprise a pool credit histogram that is maintained separately from the per-virtual-channel credit histograms, the pool credit histogram indicating overall protocol level interface credit utilization across all virtual channels. The pool credit histogram may reflect the aggregate credit utilization at the protocol level interface, while the per-virtual-channel histograms may reflect utilization within each individual virtual channel. Congestion at the pool level may indicate overall port saturation, while congestion at the VC level may indicate traffic class imbalance.

In some implementations of the system, the transaction layer credit utilization histograms comprise a control credit histogram and a data credit histogram maintained separately, the control credit histogram tracking credit utilization for control messages and the data credit histogram tracking credit utilization for data messages. The separate control and data credit histograms may enable identification of whether congestion originates in the control path or the data path. Control credit exhaustion may indicate excessive metadata or management traffic, while data credit exhaustion may indicate high data throughput demand.

In some implementations of the system, a centralized controller uses the byte transmission and reception counters from the per-layer telemetry counters to detect traffic imbalance across logical switches and adjusts flow-based forwarding entries to redistribute traffic to less utilized logical switches. The centralized controller may compute per-logical-switch utilization from the byte counters aggregated across ports and may compare utilization ratios to detect imbalance. Adjusting flow-based forwarding entries may redistribute source-destination flows to underutilized logical switches, improving overall network throughput.

FIG. 8B illustrates a method for monitoring an accelerator interconnect network comprising maintaining per-layer telemetry counters at each port, collecting the counters via a management agent, and reporting them to a telemetry collector. The per-layer counters may provide visibility into physical layer error correction, data link layer throughput and errors, transaction layer credit utilization, and port-level byte throughput. The credit utilization histograms may enable health assessment and congestion detection.

In various implementations, a method for monitoring an Ultra Accelerator Link (UALink)-based network, comprising: maintaining, at each UALink-based port on a device, per-layer telemetry counters comprising physical layer counters including error correction histograms, data link layer counters including flit transmission and reception counters, transaction layer counters including credit utilization histograms, and port performance counters including byte transmission and reception counters; collecting, by a management agent, the per-layer telemetry counters from the device; and reporting, by the management agent, the per-layer telemetry counters to at least one telemetry collector; wherein the credit utilization histograms comprise a plurality of bins, each bin indicating time spent at a corresponding credit utilization level. The method may be performed continuously during device operation, with the management agent collecting counters at configurable intervals. The per-layer counters may be accumulated with full resolution at the device, and the management agent may read the current counter values at each collection interval. The credit utilization histograms may be hardware-implemented counters that sample credit levels at regular intervals and increment the appropriate bin. The telemetry collector may receive the counters and histograms for analysis, storage, and alerting.

In some implementations, the method further comprises computing, by the telemetry collector or a centralized controller, a link health score from the credit utilization histograms, wherein a high proportion of time in a stalled bin indicates congestion and a high proportion of time in an idle bin indicates underutilization. The health score computation may be applied to each port independently and may be aggregated across ports to produce device-level and network-level health assessments. The scoring may be configurable to reflect workload-specific performance requirements.

In some implementations, the method further comprises correlating, by the telemetry collector or a centralized controller, physical layer error correction events with data link layer replay events and transaction layer credit starvation events to identify a root cause of performance degradation as originating at a specific protocol layer. The correlation may involve comparing temporal patterns across layers. An increase in physical layer errors followed by increased data link layer replays and subsequent transaction layer credit starvation may indicate a physical medium issue propagating through the protocol stack.

In some implementations, the method further comprises monitoring, by a centralized controller, trends in the error correction histograms over time; and triggering proactive maintenance when error rates increase beyond a threshold, before a link quality indicator transitions from healthy to marginal. Trend monitoring may use successive histogram snapshots to compute error rate derivatives. An increasing trend may indicate gradual physical medium degradation or environmental changes affecting signal quality.

In some implementations of the method, the collecting comprises collecting per-virtual-channel credit utilization histograms separately for each of a plurality of virtual channels on each port, enabling identification of congestion on individual virtual channels. Per-virtual-channel collection may allow the centralized controller to identify which traffic class is experiencing congestion and may inform virtual channel assignment policy adjustments to balance load across virtual channels. In some implementations of the method, a non-transitory computer-readable medium comprising instructions which, when executed by a processor, cause the processor to perform the method.

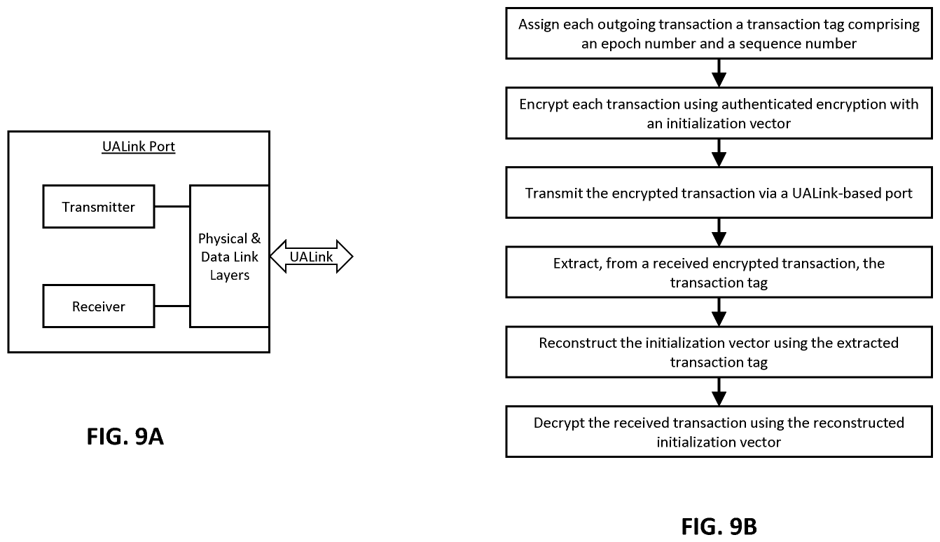

FIG. 9A illustrates a device for UALink-based network comprising a transmitter and a receiver. In computing environments where accelerators communicate through a UALink-based network, transactions may traverse multiple physical paths between a source device and a destination device, such as through different switches. When authenticated encryption protects transactions on these links, the receiver may need to reconstruct the initialization vector used for encryption in order to decrypt each received transaction. In implementations where transactions may arrive out of order due to traversing different paths, the transmitter may embed a transaction tag in the initialization vector, and the receiver may extract this tag to reconstruct the correct initialization vector without relying on arrival order. The transaction tag may include an epoch number and a sequence number that together uniquely identify each transaction within a bounded window. The transmitter may organize transmission into phases, each phase comprising a set of epochs, and each epoch comprising a set of sequence numbers. A counter value in the invocation field of the initialization vector may increment at phase boundaries, providing an additional dimension of uniqueness. The device may implement the authenticated encryption at a protocol layer before transactions enter a transaction layer for flit packing and transmission over the link. The device may be implemented as an accelerator, an integrated circuit, a chiplet, or other suitable device coupled to the UALink-based network via a UALink-based port.

In various implementations, a device for an Ultra Accelerator Link (UALink)-based network, the device comprising: a UALink-based port coupled to a link in the UALink-based network; a transmitter configured to: assign each outgoing transaction a transaction tag comprising an epoch number and a sequence number, and encrypt each transaction using authenticated encryption with an initialization vector comprising a fixed field and an invocation field, the fixed field comprising a source accelerator identifier and a destination accelerator identifier, the invocation field comprising a counter value and the transaction tag; and a receiver configured to: extract the transaction tag from a received encrypted transaction, reconstruct the initialization vector using the extracted transaction tag, and decrypt the received transaction using the reconstructed initialization vector. The device may enable authenticated encryption of transactions that may arrive at the destination in an order different from the order in which they were transmitted. By embedding the transaction tag in the invocation field of the initialization vector, each transaction may carry sufficient information for the receiver to independently determine the initialization vector used for encryption. The transmitter may assign transaction tags sequentially within each epoch, resetting the sequence number at the start of each new epoch and advancing the epoch number. The fixed field may remain constant for a given source-destination-port-stream-VC combination, while the invocation field may change per transaction. The receiver may extract the transaction tag from the received transaction, combine it with the counter value and the fixed field, and use the resulting initialization vector for decryption and authentication verification. The method may be performed by hardware, firmware, software, or combinations thereof.

In some implementations of the device, the epoch number comprises 2 bits identifying one of four epochs, the sequence number comprises 9 bits identifying one of 512 transactions within the epoch, and the transaction tag comprises 11 bits. The 2-bit epoch may allow four epochs to be tracked simultaneously, and the 9-bit sequence may support up to 512 transactions per epoch. The 11-bit tag may occupy the lower portion of the invocation field.

In some implementations of the device, the initialization vector comprises 96 bits, the fixed field further comprising a source port number, a stream identifier, and a virtual channel identifier, and the invocation field comprising a 21-bit integer counter concatenated with the 11-bit transaction tag. The fixed field may identify the communication context by including source and destination accelerator identifiers, a source port number, a stream identifier, and a virtual channel identifier. The 21-bit integer counter may provide the phase identity while the 11-bit tag may provide per-transaction uniqueness within the phase.

In some implementations of the device, the counter value is incremented when the epoch number wraps from a maximum epoch value to zero, corresponding to a phase boundary in which transmission transitions from a completed set of epochs to a subsequent set of epochs. The counter may increment at phase boundaries rather than per transaction. Each phase may span four epochs of 512 transactions each, so the counter may advance every 2048 transactions. This may reduce the counter update frequency compared to a per-transaction monotonic counter.

In some implementations of the device, the transmitter and the receiver operate with two encryption streams: a request stream carrying requests, and a response stream carrying read responses and write responses, wherein the read responses and the write responses share a derived encryption key and the counter value; and wherein when a plurality of virtual channels target the same destination device, the transmitter uses the same counter value and the same derived encryption key for the plurality of virtual channels. The two-stream model may reduce the number of independent encryption contexts compared to operating with separate streams for requests, read responses, and write responses. Sharing the derived encryption key and counter value across virtual channels targeting the same destination may further reduce hardware resources for crypto state management.

In some implementations of the device, the authenticated encryption comprises Advanced Encryption Standard in Galois/Counter Mode (AES-GCM) with 256-bit keys, and each encrypted transaction is accompanied by an authentication tag. The authentication tag may provide integrity verification, enabling the receiver to detect tampering or corruption of the transaction payload during transmission.

In some implementations of the device, the transmitter is further configured to stop issuing new transactions to a destination device when all sequence numbers in a current epoch are assigned and outstanding transactions from an oldest tracked epoch have not received responses, and resume issuing new transactions upon receiving responses that free sequence numbers in the oldest tracked epoch. The flow control may prevent the transmitter from exceeding the receiver's tracking capacity. If outstanding transactions remain in the oldest tracked epoch when the current epoch is exhausted, further transmission may overwrite tracking state that the receiver still needs. The transmitter may maintain a timeout for outstanding transactions and may signal an error if a response is not received within a configurable period.

In some implementations of the device, the transmitter is further configured to maintain a transaction tracker per destination device, each entry corresponding to an outstanding transaction identified by the transaction tag, wherein upon receiving a response matching a transaction tag the transmitter deallocates the corresponding entry, and wherein a response with a transaction tag that does not match an outstanding entry is detected as an error. The transaction tracker may enforce a one-to-one mapping between transaction tags and outstanding transactions for each destination. A duplicate or spurious response may indicate a replay attack or a protocol violation.

In some implementations of the device, the plurality of paths comprise physical links between the device and the destination device through different switches in the UALink-based network, wherein each switch comprises forwarding entries indexed by a destination accelerator identifier that determine an egress port for each transaction. Multiple physical paths through different switches may provide higher aggregate bandwidth and may distribute traffic across switching planes. The forwarding entries may include source-destination pair routing information that distributes transactions across the available paths.

In some implementations of the device, the device comprises an accelerator, and wherein in an operating mode supporting out-of-order delivery only uncompressed responses are permitted, each uncompressed response preserving a source accelerator identifier used by the receiver to reconstruct the fixed field of the initialization vector. Compressed responses may aggregate data from multiple sources, which may cause the individual source accelerator identifier to be lost. Since the fixed field of the initialization vector may include the source accelerator identifier, the receiver may need this identifier to reconstruct the initialization vector for decryption. Restricting the operating mode to uncompressed responses may preserve this identifier.

In some implementations of the device, the transmitter is further configured to initiate key derivation for a new encryption key as a first transaction of a first epoch in a new phase, and both the transmitter and the receiver switch to the new encryption key starting from a first transaction of a first epoch of a subsequent phase. Initiating key derivation at the start of a phase and activating the derived key at the start of the subsequent phase may provide a full phase interval for both the transmitter and the receiver to complete the derivation. The transmitter may wait for confirmation from the receiver before advancing to the subsequent phase.

In some implementations, the device further comprises a management agent configured to receive, from a centralized controller via an out-of-band management network, a configuration for a security mode, the security mode being one of an ordered mode or an unordered mode, wherein in the ordered mode the transmitter uses a monotonic counter as the invocation field and transactions are delivered in order, and in the unordered mode the transmitter assigns the transaction tag and transactions are transmitted via the plurality of paths. The centralized controller may configure the security mode during initial link setup or may reconfigure it during operation. The ordered mode may be compatible with devices that do not support multipath routing, and the unordered mode may be selected when multipath routing is available and desired. The out-of-band management network may carry configuration messages separately from data-plane traffic.

In some implementations of the device, the management agent is further configured to receive an indication that the security mode was selected based on a workload communication pattern, wherein an all-to-all communication pattern is associated with the unordered mode and multipath routing, and a nearest-neighbor communication pattern is associated with the ordered mode and single-path routing. All-to-all communication patterns, such as those used in gradient reduction during distributed training, may benefit from multipath routing for increased bandwidth. Nearest-neighbor patterns, such as halo exchange in spatial partitioning, may benefit from single-path routing for lower latency and simpler crypto state.

In some implementations of the device, the management agent is further configured to report, via the out-of-band management network, telemetry comprising a current epoch number, a current counter value, and a count of outstanding transactions per destination device, enabling the centralized controller to monitor encryption state of the device. The telemetry may enable the centralized controller to detect stalled epoch progression, counter drift between communicating devices, or accumulation of outstanding transactions that may indicate a failing path. The telemetry may be reported periodically or upon a triggering event such as a counter advancement or an error condition.

FIG. 9B illustrates a method for performing authenticated encryption in a UALink-based network where transactions may be transmitted on multiple paths and may arrive at the destination in a different order than they were sent. By assigning each transaction a tag comprising an epoch number and a sequence number and embedding this tag in the initialization vector, the method may enable the receiver to reconstruct the initialization vector for each transaction independently of the order in which transactions arrive. The method may be performed by an accelerator, a chiplet, firmware executing on a processor, or other suitable device.

In various implementations, a method comprising: assigning, by a device in an Ultra Accelerator Link (UALink)-based network, each outgoing transaction a transaction tag comprising an epoch number and a sequence number; encrypting each transaction using authenticated encryption with an initialization vector comprising an invocation field that embeds the transaction tag; transmitting the encrypted transaction via a UALink-based port on one of a plurality of paths to a destination device; extracting, from a received encrypted transaction, the transaction tag; reconstructing the initialization vector using the extracted transaction tag; and decrypting the received transaction using the reconstructed initialization vector. The method may enable authenticated encryption to function correctly when transactions traverse different physical paths and arrive at the receiver in an arbitrary order. The initialization vector may further comprise a fixed field and a counter value within the invocation field, where the fixed field identifies the communication context and the counter value identifies the phase of transmission. The assigning may be performed sequentially within each epoch, and the epoch number may advance when the sequence numbers within an epoch are exhausted. The method may be performed at a protocol layer before transactions enter a transaction layer for flit packing and link transmission.

In some implementations, the method further comprises receiving, from a centralized controller, an updated set of routing entries for the plurality of paths; and coordinating activation of the updated routing entries with a phase boundary of a counter value embedded in the invocation field, wherein transactions transmitted before the phase boundary complete on original paths and transactions transmitted after the phase boundary use the updated routing entries. Coordinating route changes with phase boundaries may prevent in-flight transactions from being misrouted. Transactions transmitted before the boundary may use the original paths and may be decrypted with the original counter value, while transactions after the boundary may use updated paths and a new counter value.

In some implementations of the method, when authentication of the received transaction fails, the method further comprises: discarding the received transaction, signaling an error event to a management agent of the device, and incrementing an error counter associated with a source of the received transaction. Discarding the transaction may prevent corrupted or tampered data from reaching an application. The error counter may enable the management agent to detect persistent authentication failures indicative of link quality degradation or an active attack on a specific link.

In some implementations, the method further comprises configuring, by a centralized controller, different virtual partitions of the UALink-based network with different security modes based on workload communication patterns of each virtual partition, wherein a first virtual partition operates in an unordered mode with multipath routing and a second virtual partition operates in an ordered mode with single-path routing concurrently on the UALink-based network. Different workloads running on the same UALink-based network may have different routing and security requirements. The concurrent operation may be achieved by maintaining separate crypto state per virtual partition, such that each virtual partition independently manages its own encryption streams, keys, and initialization vector construction. In some examples, a virtual partition refers to a virtual pod.

In some implementations, the method further comprises transitioning from an ordered mode to an unordered mode by: draining in-flight transactions on existing streams, initiating key derivation for new stream keys corresponding to the unordered mode, and reconfiguring the initialization vector construction from a monotonic counter to the invocation field embedding the transaction tag. The drain step may wait for all outstanding transactions to complete or for a configurable timeout to expire. The key derivation may produce new stream keys appropriate for the two-stream model of the unordered mode. The initialization vector reconfiguration may switch the invocation field format from a 32-bit monotonic counter to a 21-bit counter concatenated with an 11-bit transaction tag. In some implementations of the method, a non-transitory computer-readable medium comprising instructions which, when executed by a processor, cause the processor to perform the method.

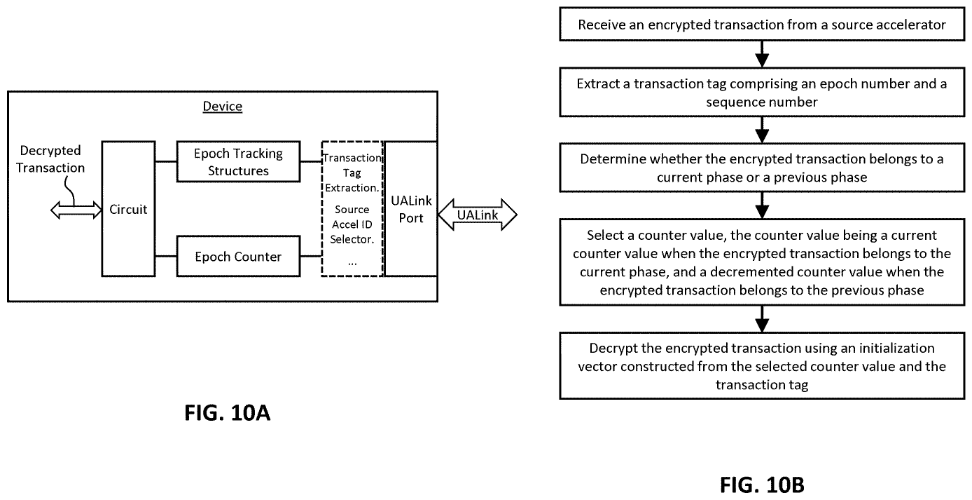

FIG. 10A illustrates a device configured to receive and decrypt encrypted transactions that arrive out of order. The device comprises a UALink-based port, per-source-accelerator-identifier storage comprising an epoch counter and epoch tracking structures each comprising a bit vector, and a circuit. Encrypted transactions are received via the UALink-based port. A transaction tag comprising an epoch number and a sequence number is extracted from each received transaction along with a source accelerator identifier. The source accelerator identifier selects the epoch counter and the epoch tracking structures associated with the source. The circuit receives the epoch number, the sequence number, the current epoch from the epoch counter, and completion state from the epoch tracking structures. The circuit determines whether the received transaction belongs to a current phase or a previous phase by comparing the received epoch number against the current epoch, selects a counter value based on the phase determination, constructs an initialization vector comprising a fixed field and an invocation field, and decrypts the received transaction using the initialization vector. The fixed field comprises a source accelerator identifier, a destination accelerator identifier, a source port number, a stream identifier, and a virtual channel identifier. The invocation field comprises the selected counter value concatenated with the transaction tag. The circuit updates the bit vector of the epoch tracking structure corresponding to the received epoch number to indicate that the sequence number has been received. The epoch tracking structures may be implemented as register files, SRAM arrays, or other suitable storage, and the circuit may include comparator logic and counter management logic. The device may be implemented as an accelerator, an integrated circuit, a chiplet, or other suitable device.

In various implementations, a device for an Ultra Accelerator Link (UALink)-based network, the device comprising: a UALink-based port; for each source accelerator identifier from which encrypted transactions are received via the UALink-based port, a plurality of epoch tracking structures, each epoch tracking structure comprising a bit vector indicating which sequence numbers within an epoch have been received; and a circuit configured to maintain a current counter value, to determine for each received encrypted transaction whether the received encrypted transaction belongs to a current phase or a previous phase based on an epoch number of the received encrypted transaction, and to decrypt the received encrypted transaction using a selected counter value, the selected counter value being the current counter value when the received encrypted transaction belongs to the current phase and a decremented counter value when the received encrypted transaction belongs to the previous phase. The device may maintain independent tracking state for each source accelerator from which encrypted transactions are received. For each source, the epoch tracking structures may record which sequence numbers have been received within each epoch, enabling the device to detect duplicates, track completion of epochs, and determine when to advance the counter value. The circuit may determine the phase membership of each received transaction by comparing the epoch number of the received transaction against the current epoch tracking state. Transactions whose epoch numbers have been reached in the current phase may be decrypted with the current counter value, while transactions whose epoch numbers have not yet been reached in the current phase may be attributed to the previous phase and decrypted with a counter value one less than the current counter value. The device may implement this mechanism per encryption stream and may maintain separate state for the request stream and the response stream.

In some implementations of the device, the circuit is configured to: identify a current epoch of the device based on a most recently assigned epoch number for the source accelerator identifier, determine that the epoch number of the received encrypted transaction belongs to the current phase when the epoch number has been reached in the current phase, and determine that the epoch number of the received encrypted transaction belongs to the previous phase when the epoch number has not yet been reached in the current phase. The device may maintain an epoch counter that tracks which epoch the device is currently processing for a given source accelerator identifier. In some examples, the epoch counter identifies the current epoch (a 2-bit value cycling through four epochs), while each epoch tracking structure comprises a bit vector recording which individual sequence numbers within that epoch have been received. Both the epoch counter and the epoch tracking structures may operate on encrypted transactions received via the UALink-based port, where each received transaction carries a transaction tag from which the epoch number and sequence number are extracted. The current epoch may advance as the transmitter at the source accelerator progresses through epochs. An epoch number that is ahead of the current epoch within the phase's epoch sequence may indicate the receiver has not yet processed transactions from that epoch in the current phase, attributing it to the previous phase.

In some implementations of the device, each bit vector comprises 512 bits, each bit corresponding to one of 512 possible sequence numbers within the epoch, and wherein the plurality of epoch tracking structures comprises four epoch tracking structures per source accelerator identifier. The four epoch tracking structures may provide a bounded tracking window of 2048 transactions per source accelerator identifier. The total tracking state per source may be 256 bytes (four epochs of 512 bits each), enabling scalable implementation for systems with many source accelerators.

In some implementations of the device, the circuit is configured to increment the current counter value when a current epoch number is a maximum epoch value and all bits in the bit vector of an epoch tracking structure corresponding to a first epoch of the current phase are set. The increment condition may indicate that the transmitter has completed the current phase and the receiver has received all transactions from the first epoch. After incrementing, the epoch tracking structure for the first epoch may be cleared and reused for the next phase.

In some implementations of the device, the device comprises an accelerator, the accelerator further comprising a trusted execution environment (TEE), wherein master keys for the authenticated encryption are stored within the TEE and are accessible to a tenant virtual machine associated with the accelerator, and wherein stream keys are derived from the master keys and loaded into the circuit. The TEE may provide hardware-enforced isolation for key material, preventing access by the infrastructure provider or other tenants. Stream keys derived within the TEE may be loaded into dedicated registers accessible to the circuit for encryption and decryption operations.

In some implementations of the device, the device comprises an accelerator, and wherein when a source accelerator is removed from a virtual partition associated with the device, the circuit is configured to clear the epoch tracking structures and reset the current counter value associated with the removed source accelerator identifier. Clearing the epoch tracking structures may free tracking resources and may prevent stale state from interfering with future communication if the source accelerator identifier is reassigned. The reset may be triggered by a configuration update received from a centralized controller via a management agent.

FIG. 10B illustrates a method describing receiver-side operations for decrypting encrypted transactions that arrive out of order. The method may involve extracting a transaction tag from each received transaction, determining the phase to which the transaction belongs based on the epoch number, selecting the correct counter value, and reconstructing the initialization vector for decryption. The method may be performed by a circuit, a processor, firmware, or other suitable implementation within a device coupled to a UALink-based network.

In various implementations, a method comprising: receiving, at a device in an Ultra Accelerator Link (UALink)-based network via a UALink-based port, an encrypted transaction from a source accelerator; extracting from the encrypted transaction a transaction tag comprising an epoch number and a sequence number; determining whether the encrypted transaction belongs to a current phase or a previous phase based on the epoch number; selecting a counter value, the counter value being a current counter value when the encrypted transaction belongs to the current phase, and a decremented counter value when the encrypted transaction belongs to the previous phase; and decrypting the encrypted transaction using an initialization vector constructed from the selected counter value and the transaction tag. The method may enable a receiver to correctly decrypt each transaction regardless of the order in which transactions arrive, provided the transactions fall within a bounded tracking window. The epoch number may indicate which group of sequence numbers the transaction belongs to, and the phase determination may select the correct counter value based on whether that epoch has been reached in the current phase of transmission. The initialization vector may further include a fixed field comprising source and destination accelerator identifiers, a source port number, a stream identifier, and a virtual channel identifier.

In some implementations, the method further comprises updating a bit vector of an epoch tracking structure corresponding to the epoch number and the source accelerator to indicate that the sequence number has been received, the epoch tracking structure being one of a plurality of epoch tracking structures maintained per source accelerator; and prior to the updating, checking whether the bit corresponding to the sequence number is already set in the bit vector, and when the bit is already set, detecting a duplicate transaction and signaling an error. The bit vector may enable the receiver to track which transactions within each epoch have been received. Checking for duplicates before setting the bit may detect replay attacks or retransmission errors at the transaction level. The error signal may be reported to a management agent for further investigation.

In some implementations, the method further comprises detecting a failure of one of a plurality of paths between the device and the source accelerator; in response to the failure, draining outstanding transactions within epoch tracking structures associated with the source accelerator; rederiving encryption keys for an ordered mode of operation; and switching the initialization vector construction from the counter value concatenated with the transaction tag to a monotonic counter, transitioning the device from an unordered mode supporting multipath routing to an ordered mode supporting single-path routing. The fallback may be triggered by link failure detection, persistent error rates, or an administrative command from a centralized controller. The drain may wait for outstanding transactions to complete within a configurable timeout before transitioning. After rederiving keys for the ordered mode, the device may operate with a monotonic counter and strict in-order delivery until the failed path is restored. In some implementations of the method, a non-transitory computer-readable medium comprising instructions which, when executed by a processor, cause the processor to perform the method.

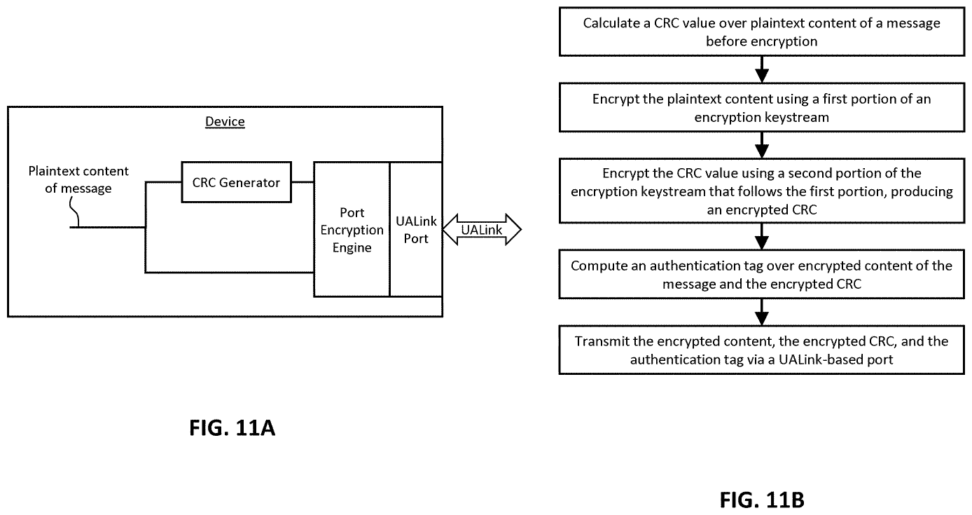

In environments where accelerators communicate via an encrypted interconnect, the encryption and decryption engines at each port may be susceptible to internal faults, including single-bit errors, multi-bit errors, stuck-at faults, and soft errors. These faults may silently corrupt data without being detected by authentication tags, because the authentication tag may be computed on the corrupted ciphertext rather than on the original plaintext. FIG. 11A illustrates a mechanism to detect faults by computing a CRC over plaintext content before encryption, encrypting the CRC using a portion of the encryption keystream, and including the encrypted CRC in the authentication tag computation. Because the encrypted CRC is derived from the plaintext and encrypted using keystream bits that would otherwise be unused, the mechanism may detect crypto engine faults without consuming additional bandwidth on the interconnect.

In various implementations, a device for an Ultra Accelerator Link (UALink)-based network, the device comprising: a UALink-based port; a CRC generator configured to calculate a CRC value over plaintext content of a message before encryption; a port encryption engine coupled to the UALink-based port, the port encryption engine configured to: encrypt the plaintext content using a first portion of an encryption keystream, encrypt the CRC value using a second portion of the encryption keystream, producing an encrypted CRC, and compute an authentication tag over encrypted content of the message and the encrypted CRC; and wherein the encrypted CRC does not increase bandwidth consumed by the message on the UALink-based network. The device may include an accelerator, a switch, or other entity participating in the UALink-based network. The CRC generator may operate on plaintext content before the port encryption engine encrypts the message, such that the CRC value reflects the original data prior to any encryption transformation. The port encryption engine may encrypt the CRC value by performing an exclusive-or (XOR) operation between the CRC value and the second portion of the encryption keystream. The encrypted CRC may occupy keystream bits that would otherwise be unused after encrypting the message content, thereby achieving zero bandwidth overhead. The authentication tag may be computed using a Galois field multiplication and accumulation over the encrypted content and the encrypted CRC, such that any perturbation in either the plaintext CRC or the encryption process produces a different authentication tag.

In some implementations of the device, the CRC value is calculated using polynomial 1EDC 6F41h with a seed value of FFFF_FFFFh, and finalized by taking a one's complement of an accumulated 32-bit value. The polynomial 1EDC 6F41h may correspond to a CRC-32C polynomial. The seed value of FFFF_FFFFh may initialize the CRC accumulator. The one's complement finalization may invert the accumulated value to produce the final CRC.

In some implementations of the device, the second portion of the encryption keystream comprises keystream bits generated for a counter block following a last counter block used to encrypt the plaintext content, wherein the encrypted CRC is cryptographically bound to a same nonce and key as the encrypted content. The counter block following the last counter block used for message encryption may produce keystream bits that are otherwise unused. The encrypted CRC being bound to the same nonce and key may prevent an adversary from substituting a valid encrypted CRC from a different message or session.

In some implementations of the device, the port encryption engine implements authenticated encryption using AES-GCM with 256-bit keys, and the encryption keystream comprises an AES keystream. AES-GCM with 256-bit keys may provide authenticated encryption with associated data (AEAD), combining confidentiality and integrity in a single operation. The AES keystream may be generated by encrypting sequential counter blocks using the 256-bit key.

In some implementations of the device, the encrypted CRC is generated for each of: read requests, write requests, read responses, atomic operations, and vendor-defined commands, with a position of the CRC value within the encryption keystream determined by a message type of the message. Different message types may have different payload sizes, and the CRC position within the keystream may correspond to the first 32 keystream bits following the last byte of plaintext for each respective message type. Vendor-defined commands may carry vendor-specific payloads with vendor-defined byte positions, and the CRC may be positioned accordingly.

In some implementations of the device, the CRC generator is optionally enabled, configurable per the UALink-based port. The CRC generator may be enabled or disabled through a configuration register associated with each port. Disabling the CRC generator may reduce computational overhead in deployments where crypto engine fault detection is not required.

In some implementations of the device, a mismatch of the authentication tag at a receiving device indicates at least one of: a single-bit error in a data path of the port encryption engine, a multi-bit error in a decryption engine data path at the receiving device, a stuck-at fault in round logic, or a soft error in keystream generation circuitry; and wherein upon detecting the mismatch, the receiving device logs a hardware error record and transitions an affected port to an error state without tearing down a security session on other ports of the receiving device. The authentication tag mismatch may indicate an internal fault in the crypto engine rather than an external data tampering event. By transitioning the affected port to an error state, the device may isolate the faulty engine while allowing other ports and their associated security sessions to continue operating. The hardware error record may include a fault classification, a timestamp, and a port identifier.

In some implementations of the device, the CRC value is calculated across all bytes of plaintext messages that are part of a given authentication tag scope. When multiple messages are aggregated under a single authentication tag, the CRC may span all plaintext bytes across the aggregated messages, providing a single CRC that covers the entire authentication tag scope.

In some implementations of the device, when a switch in the UALink-based network performs in-network data reduction on decrypted collective data from a plurality of accelerators, the switch recalculates a new CRC value over a reduced result before re-encryption by a switch port encryption engine, enabling end-to-end crypto engine verification across the switch. During in-network data reduction, the switch may decrypt incoming data from multiple accelerators, perform a reduction operation such as a sum, min, max, or logical operation, and re-encrypt the reduced result for transmission to a destination accelerator. Recalculating the CRC over the reduced result before re-encryption may enable the destination accelerator to verify the integrity of the switch port encryption engine as well as its own decryption engine.

In some implementations of the device, when a data beat of the message has a data error indicator, the CRC generator excludes the data beat from the CRC calculation, and the port encryption engine excludes the data beat from encryption and from the authentication tag computation. A data beat with a data error indicator may carry corrupted data that should not be included in the CRC or authentication tag computation. Excluding the data beat from both the CRC and the encryption may maintain consistency, such that the CRC and the authentication tag each reflect non-Poisoned data beats.

In some implementations of the device, the device is configured to perform a self-test of the port encryption engine by processing a known plaintext and a known key through the CRC generator and the port encryption engine, and comparing a resulting authentication tag against a predetermined expected value, the self-test being performed at least one of: during device initialization or periodically during operation. The self-test may exercise the CRC generator and the port encryption engine using predetermined test vectors with known expected results. By comparing the resulting authentication tag against the predetermined expected value, latent faults in the crypto engine data path may be detected before they affect live traffic. The self-test may be triggered by firmware during device initialization or scheduled periodically by a management agent.

FIG. 11B illustrates a method for verifying the integrity of encryption engines in a UALink-based network by computing a CRC over plaintext content, encrypting the CRC, and including the encrypted CRC in an authentication tag without consuming additional bandwidth.

In various implementations, a method for verifying encryption integrity in an Ultra Accelerator Link (UALink)-based network, comprising: calculating, at a device comprising a port encryption engine and a UALink-based port, a CRC value over plaintext content of a message before encryption; encrypting, by the port encryption engine, the plaintext content using a first portion of an encryption keystream; encrypting, by the port encryption engine, the CRC value using a second portion of the encryption keystream that follows the first portion, producing an encrypted CRC; computing an authentication tag over encrypted content of the message and the encrypted CRC; and transmitting the encrypted content, the encrypted CRC, and the authentication tag via the UALink-based port, wherein the encrypted CRC does not consume additional bandwidth beyond that consumed by the encrypted content and the authentication tag. The method may be performed by an accelerator, a switch, or other entity in the UALink-based network. The device comprising the port encryption engine and the UALink-based port may implement the CRC calculation, encryption, and authentication tag computation in a pipeline, such that the CRC value is computed in parallel with or immediately preceding the encryption of the plaintext content. The second portion of the encryption keystream following the first portion may include remainder keystream bits generated for a counter block that is not consumed by the message content encryption. Transmitting the encrypted CRC without consuming additional bandwidth may be achieved by embedding the encrypted CRC within the keystream allocation already reserved for the message.

In some implementations of the method, the CRC value is calculated using polynomial 1EDC 6F41h with a seed value of FFFF_FFFFh, and finalized by taking a one's complement of an accumulated 32-bit value. The polynomial and seed may produce a 32-bit CRC value that is finalized by bitwise inversion of the accumulated result.

In some implementations of the method, the second portion of the encryption keystream comprises keystream bits generated for a counter block following a last counter block used to encrypt the plaintext content, wherein the encrypted CRC is cryptographically bound to a same nonce and key as the encrypted content. The counter block following the last counter block used for plaintext encryption may produce keystream bits that bind the encrypted CRC to the same cryptographic session, preventing substitution attacks.

In some implementations of the method, the port encryption engine implements authenticated encryption using AES-GCM with 256-bit keys, and the encryption keystream comprises an AES keystream. AES-GCM with 256-bit keys may provide authenticated encryption where the keystream is generated from sequential counter blocks encrypted with the key.

In some implementations of the method, when a switch in the UALink-based network performs in-network data reduction on decrypted collective data, the switch recalculates a new CRC value over a reduced result before re-encryption, enabling end-to-end crypto engine verification across the switch. The switch may decrypt data from multiple accelerators, perform a reduction operation, and re-encrypt the result. Recalculating the CRC over the reduced result may extend crypto engine fault coverage across the switch boundary.

In some implementations of the method, when a data beat of the message has a data error indicator, the CRC calculation excludes the data beat, and the port encryption engine excludes the data beat from encryption and from the authentication tag computation. Excluding a poisoned data beat from both the CRC and the encryption may maintain consistency between the CRC domain and the authentication tag domain, preventing false authentication failures caused by data errors.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

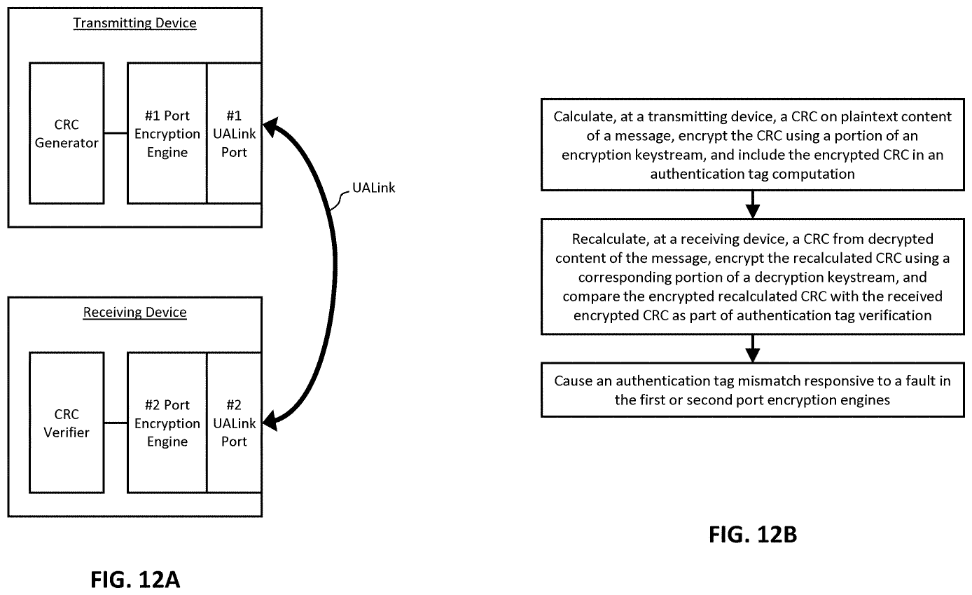

FIG. 12A illustrates a system comprising an end-to-end crypto engine fault detection mechanism where a transmitting device and a receiving device each independently compute a CRC-based integrity check that is embedded within the authentication tag. Because the CRC is computed on plaintext at the transmitting device and independently recalculated from decrypted content at the receiving device, a fault in either the encryption engine or the decryption engine may cause a divergence in the encrypted CRC, which in turn causes an authentication tag mismatch. This bidirectional fault coverage may be achieved without additional messages, protocol handshakes, or bandwidth overhead.

In various implementations, an interconnect system for an Ultra Accelerator Link (UALink)-based network, comprising: a transmitting device comprising a first port encryption engine, a CRC generator, and a first UALink-based port; a receiving device comprising a second port encryption engine, a CRC verifier, and a second UALink-based port; the transmitting device coupled to the receiving device via a UALink-based link; wherein at the transmitting device, a CRC is calculated on plaintext content of a message, encrypted using a portion of an encryption keystream, and included in authentication tag computation; and at the receiving device, a CRC is independently recalculated from decrypted content of the message, encrypted using a corresponding portion of a decryption keystream, and compared with the received encrypted CRC as part of authentication tag verification; wherein a fault in either the first port encryption engine or the second port encryption engine causes an authentication tag mismatch. The transmitting device and the receiving device may each comprise an accelerator or a switch in the UALink-based network. The CRC generator at the transmitting device may compute the CRC over plaintext content before the first port encryption engine encrypts the message. The CRC verifier at the receiving device may independently recalculate the CRC from the decrypted content and encrypt the recalculated CRC using the corresponding keystream portion. If the first port encryption engine introduces an error during encryption, the encrypted CRC transmitted will differ from what the receiving device expects, causing the authentication tag to diverge. Conversely, if the second port encryption engine introduces an error during decryption, the recalculated CRC from the corrupted plaintext will produce a different encrypted CRC than the one received, also causing the authentication tag to diverge. In both cases, the authentication tag mismatch may indicate an internal crypto engine fault rather than an external data tampering event.

In some implementations of the system, upon detecting the authentication tag mismatch, the receiving device logs a hardware error record and transitions an affected port to an error state without tearing down a security session on other ports of the receiving device. Transitioning the affected port to an error state may enable continued operation on other ports whose crypto engines are functioning correctly. The hardware error record may facilitate root cause analysis by recording fault type, port identifier, and timestamp.

In some implementations of the system, the UALink-based network connects a plurality of accelerators via one or more switches, and the CRC verification at the receiving device is performed at each accelerator port without requiring involvement of the one or more switches. The one or more switches may forward encrypted traffic without decrypting or verifying the CRC, such that the CRC verification may be an end-to-end operation between the transmitting and receiving accelerators. This point-to-point verification model may reduce switch complexity and latency.

In some implementations of the system, the CRC is distinct from a Peripheral Component Interconnect Express (PCIe) End-to-End CRC (ECRC) that protects an entire transaction layer packet including a header, the CRC operating on payload-plaintext content within an authenticated encryption context. PCIe ECRC may be computed over an entire transaction layer packet including its header and may be appended to the packet for end-to-end verification. The CRC in this implementation may be computed on payload-plaintext content and encrypted using a portion of the encryption keystream, such that the CRC verification is embedded within the authentication tag rather than appended as a separate field.

FIG. 12B illustrates a method for detecting faults in encryption engines across a UALink-based link, where both the transmitting and receiving devices independently process a CRC that is compared via the authentication tag.

In various implementations, a method for detecting encryption faults in an Ultra Accelerator Link (UALink)-based network, comprising: at a transmitting device comprising a first port encryption engine coupled to a first UALink-based port, calculating a CRC on plaintext content of a message, encrypting the CRC using a portion of an encryption keystream, and including the encrypted CRC in an authentication tag computation; at a receiving device comprising a second port encryption engine coupled to a second UALink-based port, the receiving device coupled to the transmitting device via a UALink-based link, independently recalculating a CRC from decrypted content of the message, encrypting the recalculated CRC using a corresponding portion of a decryption keystream, and comparing the encrypted recalculated CRC with the received encrypted CRC as part of authentication tag verification; and wherein a fault in the first port encryption engine or the second port encryption engine causes an authentication tag mismatch. The method may be performed by accelerators, switches, or other entities coupled via the UALink-based link. At the transmitting device, the CRC may be calculated on plaintext before encryption and encrypted using remainder keystream bits. At the receiving device, the CRC may be independently recalculated from the decrypted content and encrypted using the corresponding remainder keystream bits. If either port encryption engine introduces an error, the encrypted CRC values diverge, causing the authentication tags to diverge. The method may enable detection of faults in the encryption engine, the decryption engine, or both, using a single authentication tag comparison without additional messages or bandwidth.

In some implementations of the method, the CRC is calculated using polynomial 1EDC 6F41h with a seed value of FFFF_FFFFh. The polynomial and seed may be used identically at both the transmitting and receiving devices. Both devices may independently produce the same CRC value from the same plaintext content.

In some implementations of the method, the portion of the encryption keystream and the corresponding portion of the decryption keystream each comprise keystream bits generated for a counter block following a last counter block used to encrypt or decrypt the plaintext content, respectively. The transmitting device and the receiving device may each derive keystream bits from corresponding counter blocks, ensuring that the same keystream portion is used for encrypting and decrypting the CRC, respectively.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

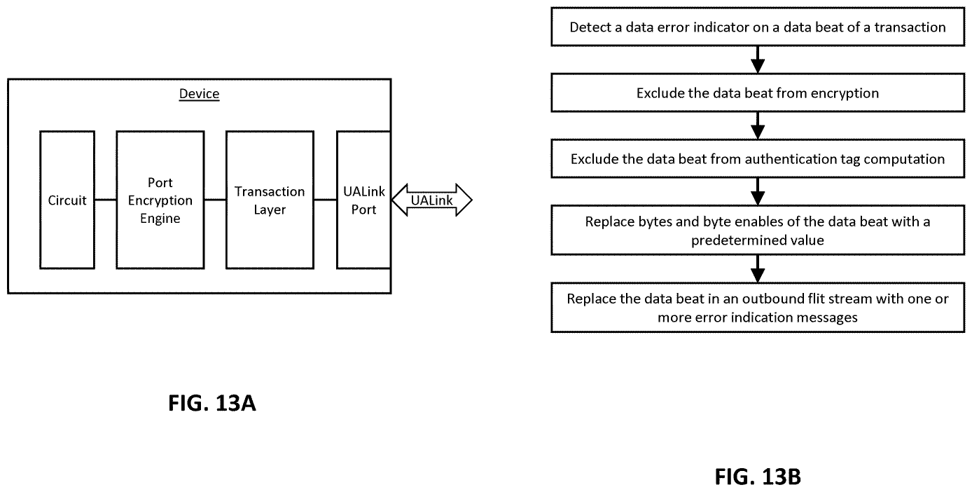

In encrypted interconnects, data errors may occur upstream of the encryption engine due to parity failures, memory errors, or other fault conditions. When a data beat carries an error indicator, the encryption engine faces a choice: encrypt the corrupted data normally and risk a false authentication tag failure at the receiver, or bypass the corrupted data entirely. FIG. 13A illustrates a bypass mechanism where the encryption engine excludes a poisoned data beat from both encryption and authentication tag computation, sets the data beat to a predetermined value, and the transaction layer replaces the data beat with error indication messages. This coordinated bypass may prevent data errors from being misinterpreted as security violations while preserving the authentication tag correctness for non-poisoned portions of the transaction.

In various implementations, a device for an Ultra Accelerator Link (UALink)-based network, the device comprising: a UALink-based port; a circuit coupled to the UALink-based port, the circuit configured to detect a data error indicator on a data beat of a transaction; a port encryption engine configured to, upon detection of the data error indicator: exclude the data beat from encryption, exclude the data beat from authentication tag computation, and set bytes and byte enables of the data beat to a predetermined value; and a transaction layer configured to replace the data beat with one or more error indication messages in an outbound flit stream on the UALink-based port. The device may include an accelerator or a switch in the UALink-based network. The circuit may detect the data error indicator on a per-beat basis, where each data beat may be 64 bytes. The port encryption engine may exclude the data beat by advancing past the data beat without consuming keystream bits for encryption and without including the data beat in the Galois field accumulation for authentication tag computation. Setting bytes and byte enables to a predetermined value may replace corrupted data with a known pattern before the data is handed to the transaction layer. The transaction layer may generate error indication messages that encode the data error condition in a format recognizable by a receiving transaction layer.

In some implementations of the device, the predetermined value for bytes and byte enables of the data beat is zero. Setting bytes and byte enables to zero may establish a known data pattern that the receiving device may expect when reconstructing the poisoned data beat on the UPLI interface.

In some implementations of the device, each error indication message comprises a 32-byte Poisoned Data TL Message Half-Flit, and each 64-byte data beat with the data error indicator is replaced with two of the Poisoned Data TL Message Half-Flits. Each 64-byte data beat may be replaced with two 32-byte Poisoned Data TL Message Half-Flits, maintaining the flit stream slot allocation while encoding the error condition. The Poisoned Data TL Message Half-Flit may include a message indicator bit and a message type field.

In some implementations of the device, the data error indicator is evaluated independently for each 64-byte data beat within a multi-beat transaction, wherein one data beat is excluded from encryption and authentication tag computation while other data beats in the same transaction are encrypted and authenticated. In a multi-beat transaction comprising up to four 64-byte data beats, each beat may independently carry or not carry a data error indicator. A transaction may contain a mixture of poisoned and non-poisoned beats, where the poisoned beats are excluded from encryption and authentication tag computation.

In some implementations of the device, the data error indicator comprises at least one of: an OrigDataError indicator on an originator data channel for write data, or a RdRspDataError indicator on a read response data channel for read response data. The OrigDataError indicator may be asserted by an originator when a parity error is detected on write data. The RdRspDataError indicator may be asserted by a completer when a parity error is detected on read response data. Both indicators may trigger the same bypass behavior in the port encryption engine.

In some implementations of the device, the excluding of the data beat from encryption and authentication tag computation prevents the data error from causing an authentication tag mismatch at a receiving device, thereby avoiding teardown of a security session between the device and the receiving device. Without the bypass, a data error would cause the authentication tags at the transmitting and receiving devices to diverge, because the transmitting device would include the poisoned data in the tag computation while the receiving device would compute the tag over different data. The tag mismatch may be indistinguishable from a security violation, potentially triggering session teardown and loss of connectivity between the devices.

In some implementations of the device, the port encryption engine advances at full throughput without stalling when the data beat with the data error indicator is encountered, maintaining line-rate processing for non-poisoned data beats. The bypass mechanism may enable the port encryption engine to advance its pipeline state past the poisoned data beat without waiting for error recovery or retransmission, such that non-poisoned data beats continue to be encrypted at line rate.

In some implementations of the device, when plaintext CRC protection is enabled, a CRC calculation over plaintext content also excludes the data beat with the data error indicator, maintaining consistency between the CRC exclusion and the encryption exclusion. When a CRC is computed over plaintext content for crypto engine fault detection, the CRC may also exclude poisoned data beats, such that both the CRC and the authentication tag reflect non-poisoned data beats. This consistency may prevent a situation where the CRC includes a poisoned beat but the authentication tag does not, or vice versa.

In some implementations of the device, the device comprises a switch in the UALink-based network, and when the switch performs in-network data reduction on decrypted collective data and the data beat has the data error indicator, the switch excludes the data beat from a reduction operation, marks a corresponding beat in a reduced result with a data error indicator, and a switch port encryption engine excludes the data beat from re-encryption and re-authentication tag computation. During in-network data reduction, the switch may receive encrypted data from multiple accelerators, decrypt the data, perform a reduction operation, and re-encrypt the result. If any accelerator's contribution has a poisoned beat, the switch may exclude that beat from the reduction arithmetic and propagate the data error indicator into the corresponding beat of the reduced result. The switch port encryption engine may then exclude the poisoned beat from re-encryption and re-authentication tag computation, maintaining the bypass coordination through the full switch pipeline.

In some implementations of the device, the device comprises a switch in the UALink-based network, and when the switch replicates a collective write operation to a plurality of destination accelerators and the data beat has the data error indicator, the switch propagates the data error indicator for the data beat in all replicated requests to the plurality of destination accelerators. During a multicast write operation, the switch may replicate the request and data to each destination accelerator. Propagating the data error indicator in all replicated requests may maintain consistency across the collective, such that all destination accelerators observe the same data error condition for the same data beat.

In some implementations of the device, the port encryption engine implements authenticated encryption using AES-GCM with 256-bit keys. AES-GCM with 256-bit keys may provide authenticated encryption where the keystream is generated from sequential counter blocks encrypted with the key. The bypass mechanism may be compatible with the Galois field accumulation used for authentication tag computation in AES-GCM.

FIG. 13B illustrates a method for propagating data errors through an encryption pipeline in a UALink-based network without causing false authentication failures, by excluding the poisoned data beat from encryption and authentication tag computation.

In various implementations, a method for propagating data errors in an Ultra Accelerator Link (UALink)-based network, comprising: detecting, at a device comprising a port encryption engine coupled to a UALink-based port, a data error indicator on a data beat of a transaction; excluding, by the port encryption engine, the data beat from encryption; excluding, by the port encryption engine, the data beat from authentication tag computation; replacing bytes and byte enables of the data beat with a predetermined value; and replacing the data beat in an outbound flit stream with one or more error indication messages. The method may be performed by an accelerator, a switch, or other entity in the UALink-based network. Detecting the data error indicator may include monitoring a per-beat error signal on a UPLI interface. Excluding the data beat from encryption may include advancing the encryption pipeline past the data beat without consuming keystream bits. Excluding the data beat from authentication tag computation may include omitting the data beat from the Galois field accumulation. Replacing bytes and byte enables with the predetermined value may establish a known pattern for the receiving device. Replacing the data beat with error indication messages may encode the data error condition in the outbound flit stream.

In some implementations of the method, the predetermined value is zero, and each error indication message comprises a 32-byte Poisoned Data TL Message Half-Flit, and each 64-byte data beat with the data error indicator is replaced with two of the Poisoned Data TL Message Half-Flits. Replacing each 64-byte data beat with two 32-byte Poisoned Data TL Message Half-Flits may maintain the flit stream timing while encoding the error condition in a recognizable message format.

In some implementations of the method, the data error indicator is evaluated independently for each 64-byte data beat within a multi-beat transaction, wherein one data beat is excluded from encryption and authentication tag computation while other data beats in the same transaction are encrypted and authenticated. Per-beat evaluation may enable surgical handling where the affected data beat is excluded from encryption, and remaining data beats in the same transaction proceed through the encryption pipeline normally.

In some implementations of the method, the excluding of the data beat from encryption and authentication tag computation prevents the data error from causing an authentication tag mismatch at a receiving device, thereby avoiding teardown of a security session between the device and the receiving device. Without the excluding, a data error may cause the transmitting and receiving devices to compute different authentication tags, which may be indistinguishable from a security violation and may trigger session teardown.

In some implementations of the method, when plaintext CRC protection is enabled, a CRC calculation over plaintext content also excludes the data beat with the data error indicator. Excluding the data beat from the CRC calculation may maintain consistency with the encryption exclusion, such that both the CRC and the authentication tag reflect non-poisoned data beats.

In some implementations of the method, the device comprises a switch in the UALink-based network, and when the switch performs in-network data reduction on decrypted collective data and the data beat has the data error indicator, the switch excludes the data beat from a reduction operation, marks a corresponding beat in a reduced result with a data error indicator, and excludes the data beat from re-encryption and re-authentication tag computation. The switch may coordinate the bypass across decryption, reduction, and re-encryption, such that the poisoned beat is excluded from the entire switch pipeline and propagated as a data error in the reduced result.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

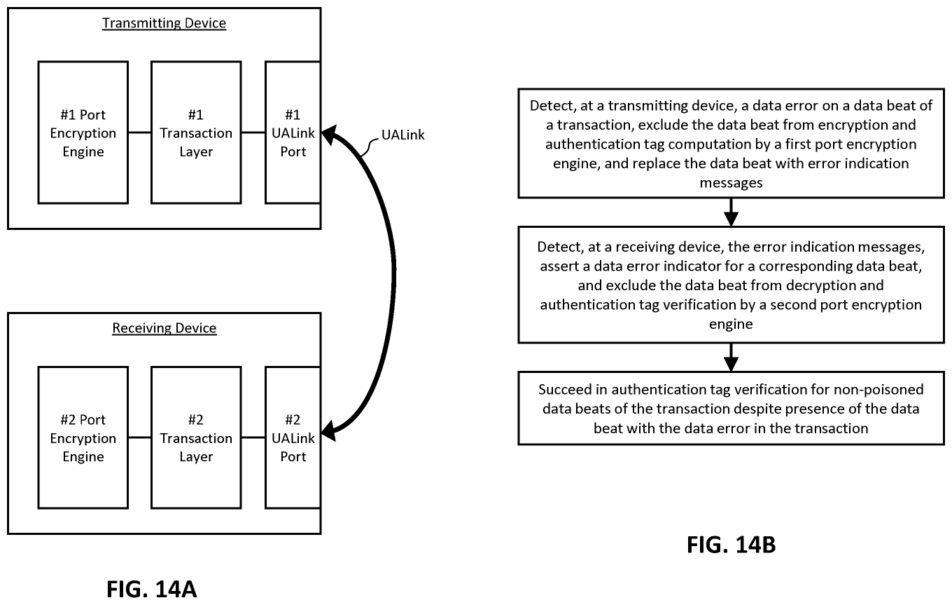

FIG. 14A illustrates a system comprising a transmitting device and a receiving device each independently exclude a poisoned data beat from their respective encryption and decryption operations, including authentication tag computation and verification. Because both devices exclude the same data beat, the authentication tag computed at the transmitting device and the authentication tag verified at the receiving device may agree for the non-poisoned portions of the transaction, despite the presence of the poisoned data beat. The coordination may be achieved through error indication messages that are inserted by the transmitting transaction layer and detected by the receiving transaction layer, signaling which data beats are poisoned.

In various implementations, an interconnect system for an Ultra Accelerator Link (UALink)-based network, comprising: a transmitting device comprising a first port encryption engine, a first transaction layer, and a first UALink-based port; a receiving device comprising a second port encryption engine, a second transaction layer, and a second UALink-based port; the transmitting device coupled to the receiving device via a UALink-based link; wherein at the transmitting device, when a data error is detected on a data beat of a transaction, the first port encryption engine excludes the data beat from encryption and authentication tag computation, and the first transaction layer replaces the data beat with error indication messages; and at the receiving device, the second transaction layer detects the error indication messages, asserts a data error indicator for a corresponding data beat, and the second port encryption engine excludes the data beat from decryption and authentication tag verification; wherein the authentication tag verification succeeds for non-poisoned data beats of the transaction despite the presence of the data beat with the data error in the transaction. The transmitting device and the receiving device may each comprise an accelerator or a switch in the UALink-based network. At the transmitting device, the first port encryption engine may exclude the data beat by skipping the encryption keystream consumption and the Galois field accumulation for that beat. The first transaction layer may replace the data beat with error indication messages in the outbound flit stream. At the receiving device, the second transaction layer may detect the error indication messages and assert a data error indicator on the UPLI interface for the corresponding data beat. The second port encryption engine may then exclude that data beat from decryption and from the Galois field accumulation for authentication tag verification. Because both the first and second port encryption engines exclude the same data beat, the authentication tags may be computed over the same subset of non-poisoned data beats, and the authentication tag verification may succeed for the non-poisoned portions.

In some implementations of the system, at the receiving device, the second transaction layer decodes the error indication messages and sets bytes of a reconstructed 64-byte data beat to zero and byte enables to zero on a UPLI interface. The receiving transaction layer may reconstruct the poisoned data beat by setting bytes and byte enables to zero, establishing a known data pattern on the UPLI interface. The data error indicator asserted alongside the reconstructed beat may signal to the receiving device that the data is corrupted.

In some implementations of the system, the transmitting device or the receiving device logs each data error event, recording at least one of: a transaction tag, source and destination accelerator identifiers, or a beat offset, enabling post-mortem analysis of data error patterns. Logging data error events with transaction-level and beat-level detail may enable identification of recurring error sources, such as a faulty memory bank or a degrading interconnect, through post-mortem pattern analysis.

In some implementations of the system, the error indication messages at the transmitting device and the data error indicator at the receiving device propagate data error semantics analogous to Peripheral Component Interconnect Express (PCIe) and Compute Express Link (CXL) poisoned transaction layer packet handling, enabling consistent error semantics across a system where accelerators connect to hosts via CXL and to peers via the UALink-based network. PCIe and CXL may define a Poison field in transaction layer packets to propagate data errors without triggering protocol-level error recovery. The bypass mechanism in the UALink-based network may provide analogous data error propagation semantics, such that a system comprising both CXL host links and UALink peer links may handle data errors consistently across protocol boundaries.

FIG. 14B illustrates a method for propagating data errors through encryption at both the transmitting and receiving devices, such that the authentication tag verification succeeds for non-poisoned data beats despite the presence of poisoned beats.

In various implementations, a method for coordinating data error propagation through encryption in an Ultra Accelerator Link (UALink)-based network, comprising: at a transmitting device comprising a first port encryption engine, a first transaction layer, and a first UALink-based port, detecting a data error on a data beat of a transaction, excluding the data beat from encryption and authentication tag computation by the first port encryption engine, and replacing the data beat with error indication messages by the first transaction layer; at a receiving device comprising a second port encryption engine, a second transaction layer, and a second UALink-based port, the receiving device coupled to the transmitting device via a UALink-based link, detecting the error indication messages by the second transaction layer, asserting a data error indicator for a corresponding data beat, and excluding the data beat from decryption and authentication tag verification by the second port encryption engine; wherein the authentication tag verification succeeds for non-poisoned data beats of the transaction despite the presence of the data beat with the data error in the transaction. The method may be performed by accelerators, switches, or other entities coupled via the UALink-based link. At the transmitting device, detecting the data error may include monitoring a per-beat error indicator on a UPLI interface. At the receiving device, detecting the error indication messages may include recognizing a message type associated with poisoned data in the inbound flit stream. The coordinated exclusion at both devices may result in authentication tags that are computed over the same subset of non-poisoned data beats, enabling the authentication tag verification to succeed despite the presence of one or more poisoned data beats.

In some implementations of the method, at the receiving device, the second transaction layer decodes the error indication messages and sets bytes of a reconstructed 64-byte data beat to zero and byte enables to zero on a UPLI interface. Setting bytes and byte enables to zero may reconstruct the poisoned data beat with a known value on the UPLI interface, accompanied by the data error indicator.

In some implementations of the method, the data error is detected on a per-beat basis, and data beats without the data error are encrypted, decrypted, and included in authentication tag computation and verification independently of the data beat with the data error. Per-beat independence may enable the encryption and decryption pipelines to process non-poisoned data beats at full throughput without waiting for error resolution on the poisoned data beat.

In some implementations of the method, a non-transitory computer-readable medium comprising instructions which, when executed by a processor, cause the processor to perform the method. In some implementations of the method, an apparatus configured to operate as a switch, wherein the apparatus comprises switching circuitry and is configured to perform the method.

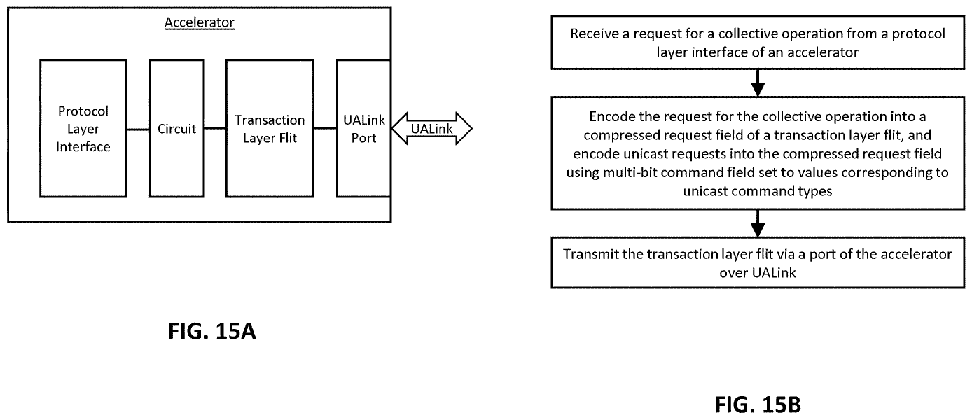

FIG. 15A illustrates accelerators communicating via transaction layer flits over UALink-based links. The transaction layer may encode requests in compressed and uncompressed field formats. A compressed request field may occupy fewer sectors than an uncompressed request field, enabling higher bandwidth utilization within the transaction layer flit. In some implementations, the compressed request field may include a multi-bit command field that encodes both collective operation command types, such as commands targeting a group of accelerators for reduction, multicast, or block collective operations, and unicast command types, such as commands targeting a single destination accelerator for read, write, or atomic operations. By sharing the same compressed field format for both collective and unicast commands, the transaction layer may avoid the bandwidth penalty of requiring collective operations to use the larger uncompressed request format. The accelerator may communicate via a port over a UALink-based link, and a circuit coupled to the port may perform the encoding and decoding of transaction layer flit fields. The collective operation may target a group of accelerators identified by a group identifier carried in a destination identifier field of the compressed request field.

In various implementations, an accelerator for an Ultra Accelerator Link (UALink)-based network, comprising: a port configured to communicate via a UALink-based link; and a circuit coupled to the port, the circuit configured to: receive, from a protocol layer interface of the accelerator, a request for a collective operation targeting a group of accelerators in the UALink-based network; and encode the request for the collective operation into a compressed request field of a transaction layer flit, the compressed request field comprising a multi-bit command field set to a value corresponding to a collective operation command type; wherein the circuit is further configured to encode unicast requests into the compressed request field using the multi-bit command field set to values corresponding to unicast command types. The circuit may receive requests from the protocol layer interface and encode them into fields of the transaction layer flit for transmission over the UALink-based link. The compressed request field may occupy two sectors of a control half-flit within the transaction layer flit, whereas an uncompressed request field may occupy four sectors, enabling the compressed format to carry more requests per flit. The multi-bit command field may encode values for collective operations including reduction, multicast, and block collective operations, in addition to unicast operations including read, write, and full-write operations. The circuit may determine whether a request received from the protocol layer interface is a collective operation or a unicast operation based on the command information provided by the protocol layer interface, and may set the command field value accordingly.

In some implementations of the accelerator, the multi-bit command field comprises 3 bits encoding a plurality of command types comprising: a read command, a read-reduce command, a block-read command, a write-multicast command, a write command, a write-full-multicast command, a write-full command, and a block-write-full command. The 3-bit command field may encode eight command types, utilizing all available encoding positions. The read, write, and write-full commands may correspond to unicast operations directed to a single destination accelerator. The read-reduce, block-read, write-multicast, write-full-multicast, and block-write-full commands may correspond to collective operations directed to a group of accelerators.

In some implementations of the accelerator, a destination identifier field of the compressed request field carries a physical accelerator identifier when the request is a unicast request, and carries a group identifier identifying the group of accelerators when the request is the collective operation request. The destination identifier field may include 10 bits and may serve a dual purpose depending on the command type. For unicast requests, the field may carry a physical accelerator identifier that identifies a single destination accelerator for point-to-point routing. For collective operation requests, the field may carry a group identifier that identifies a set of accelerators participating in the collective operation, enabling a switch to route the request to all members of the group.

In some implementations of the accelerator, the compressed request field for the collective operation request occupies the same number of sectors in a control half-flit of the transaction layer flit as the compressed request field for a unicast request. Both collective and unicast compressed request fields may occupy two sectors of a control half-flit, enabling collective operations to be encoded without additional bandwidth overhead compared to unicast operations.

In some implementations of the accelerator, the circuit comprises an address cache, the address cache indexed by the group identifier for the collective operation request and indexed by the physical accelerator identifier for a unicast request. The address cache may store address region information enabling the circuit to compress the address field in the compressed request field. For collective operations, the address cache may maintain entries indexed by the group identifier, enabling address compression for collective traffic targeting groups of accelerators. For unicast operations, the address cache may be indexed by the physical accelerator identifier of the destination.

In some implementations of the accelerator, a source identifier field of the compressed request field carries a reduction operation type and a data type when the collective operation command type corresponds to a read-reduce command issued from the accelerator to a switch of the UALink-based network, and carries a physical accelerator identifier for other command types. The source identifier field may include 10 bits and may be overloaded for read-reduce commands to carry information specifying the arithmetic or logical operation to be performed and the data type of the operands, enabling the switch to perform the reduction operation without additional signaling. For other command types, the field may carry the physical accelerator identifier of the originating accelerator.

In some implementations of the accelerator, the circuit is further configured to encode, within a single control half-flit of the transaction layer flit, at least one compressed request field for the collective operation and at least one compressed request field for a unicast request. The control half-flit may accommodate multiple compressed request fields subject to sector alignment constraints. By packing both collective and unicast compressed request fields into the same control half-flit, the circuit may optimize bandwidth utilization when both traffic types are pending for transmission.

In some implementations of the accelerator, the accelerator is coupled to a host via a Compute Express Link (CXL) interface, and wherein the circuit is further configured to: receive a CXL.io memory request from the host, and translate the CXL.io memory request into the request for the collective operation encoded in the compressed request field, wherein the CXL.io memory request comprises at least one of a CXL.io Memory Read (MRd) request or a CXL.io Unordered Input/Output Memory Read (UIOMRd) request, and wherein a completion returned to the host comprises a CXL DevLoad (CDL) field. The CXL.io memory request from the host may be translated into a collective operation when the request targets a memory region associated with a collective operation, such as a reduction buffer or a multicast destination range. The CDL field in the completion returned to the host may carry load indication information reflecting the accelerator's or the UALink-based network's current utilization level.

In some implementations of the accelerator, the accelerator is coupled to a host via a Compute Express Link (CXL) interface, and wherein the circuit is further configured to: receive a CXL.mem master-to-subordinate (M2S) request from the host targeting memory associated with the accelerator, and translate the CXL.mem M2S request into the request for the collective operation encoded in the compressed request field, wherein the CXL.mem M2S request comprises at least one of a MemRd opcode or a MemWr opcode, and wherein a subordinate-to-master (S2M) response returned to the host comprises a MetaField and a MetaValue. The CXL.mem M2S request may target memory that is shared among a group of accelerators and may trigger a collective operation to synchronize or aggregate data across the group. The MetaField and MetaValue in the S2M response may convey coherency state information about the data returned to the host.

In some implementations of the accelerator, the accelerator is coupled to a host via a Compute Express Link (CXL) interface, and wherein the circuit is further configured to coordinate a CXL.cache coherency operation with the collective operation, the CXL.cache coherency operation comprising at least one of: obtaining data from the host via a CXL.cache device-to-host (D2H) request comprising at least one of a RdShared opcode, a RdOwn opcode, or a RdCurr opcode, or evicting data to the host via a CXL.cache D2H data message comprising at least one of a DirtyEvict opcode or a CleanEvict opcode. The accelerator may coordinate CXL.cache coherency operations with UALink collective operations to maintain data consistency between the host's cache hierarchy and the data being operated on by the group of accelerators. For example, the accelerator may obtain data from the host cache via a RdShared or RdOwn request before initiating a collective reduction, or may evict modified data back to the host via a DirtyEvict after completing a collective operation.

In some implementations of the accelerator, the accelerator is coupled to a host via a Peripheral Component Interconnect Express (PCIe) interface, and wherein the circuit is further configured to: receive a PCIe Transaction Layer Packet (TLP) from the host comprising a PCIe memory request, and translate the PCIe memory request into the request for the collective operation encoded in the compressed request field, wherein the circuit maps between a Tag field of the PCIe TLP and a tag field of the compressed request field. The PCIe TLP Tag field may have a different width and encoding than the tag field of the compressed request field, and the circuit may maintain a mapping between the two Tag spaces to correlate responses with their originating PCIe requests. The PCIe memory request may be a Memory Read (MRd) or Memory Write (MWr) TLP directed to a memory region associated with a collective operation.

FIG. 15B illustrates a method for encoding transactions in a UALink-based network comprising receiving requests for collective operations from a protocol layer interface and encoding them into compressed request fields of transaction layer flits for transmission over a UALink-based link. The method may identify collective operations using a group identifier carried in the request, and may set a multi-bit command field in the compressed request field to a value corresponding to the specific collective operation command type. The method may further encode unicast requests into the same compressed request field format using unicast command type values, enabling both collective and unicast traffic to share the same bandwidth-efficient compressed encoding.

In various implementations, a method for encoding transactions in an Ultra Accelerator Link (UALink)-based network, comprising: receiving, at a circuit of an accelerator, a request for a collective operation from a protocol layer interface of the accelerator, the request targeting a group of accelerators in the UALink-based network via a group identifier; encoding, by the circuit, the request for the collective operation into a compressed request field of a transaction layer flit, the compressed request field comprising a multi-bit command field set to a value corresponding to a collective operation command type; transmitting the transaction layer flit via a port of the accelerator over a UALink-based link; and wherein the encoding further comprises encoding unicast requests into the compressed request field using the multi-bit command field set to values corresponding to unicast command types. The method may be implemented in hardware, firmware, software, or combinations thereof, and may be performed by various types of devices including an accelerator, a switch, a processor, or a semiconductor device. The group identifier may identify a set of accelerators participating in the collective operation and may be carried in a destination identifier field of the compressed request field. The multi-bit command field may distinguish among multiple types of collective operations, such as reduction, multicast, and block collective operations, as well as multiple types of unicast operations.

In some implementations, the method further comprises managing flow control credits for collective operation requests separately from flow control credits for unicast requests, wherein the circuit allocates dedicated credit resources for the collective operation requests to prevent blocking between collective operation traffic and unicast traffic. The dedicated credit resources may include separate pool credit allocations or separate virtual channel credit reservations for collective and unicast traffic. By preventing one traffic type from consuming all available credits, the method may reduce interference between collective and unicast traffic at the transaction layer.

In some implementations, the method further comprises limiting, by the circuit, a proportion of compressed request fields within a single control half-flit of the transaction layer flit that are encoded with collective operation command types, to allocate bandwidth in the transaction layer flit between collective operation requests and unicast requests. The proportion may be controlled by a policy that reserves a minimum number of sector positions in the control half-flit for unicast requests when both collective and unicast requests are pending, preventing collective traffic from monopolizing the available bandwidth.

In some implementations of the method, the encoding of the collective operation request into the compressed request field is subject to: a transfer size that is a multiple of 64 bytes, a 64-byte-aligned address, and the address hitting in a transaction layer address cache. The compression restrictions may apply equally to collective and unicast compressed requests and may be enforced by the circuit before encoding a request into the compressed format. Requests that do not meet the compression restrictions may be encoded in an uncompressed request field format occupying more sectors in the control half-flit.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an apparatus configured to operate as a switch, wherein the apparatus comprises switching circuitry and is configured to perform the method.

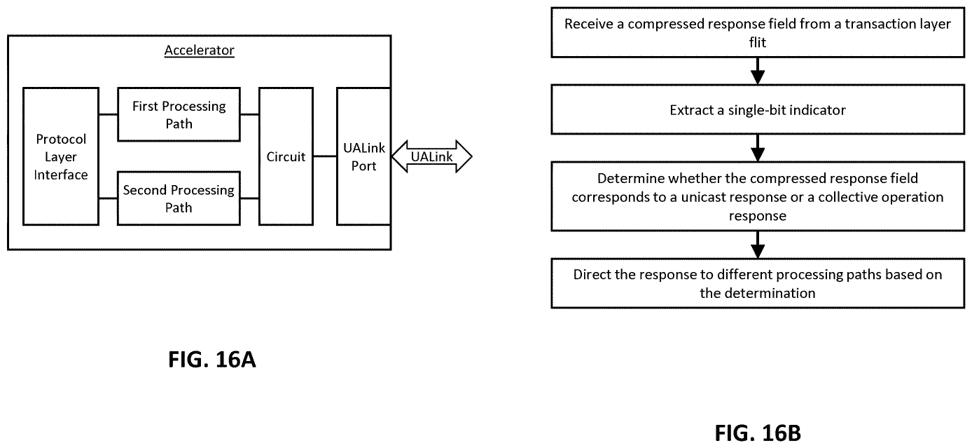

FIG. 16A illustrates an accelerator comprising a circuit that processes incoming responses from transaction layer flits, while distinguishing between responses corresponding to collective operations and responses corresponding to unicast operations. In some implementations, the circuit may extract a single-bit indicator from a compressed response field to determine whether the response corresponds to a collective operation or a unicast operation, without maintaining state information about the original request that generated the response. This stateless approach may be beneficial in switch implementations where maintaining per-transaction state for all in-flight requests across all ports may be prohibitively expensive. By embedding the response type in the response itself, the circuit may route collective and unicast responses to different processing paths, such as different decryption paths, different flow control credit return paths, or different forwarding paths. The compressed response field may occupy a single sector of a control half-flit, and the single-bit indicator may occupy a bit position that was previously unassigned in earlier versions of the compressed response format.

In various implementations, an accelerator for an Ultra Accelerator Link (UALink)-based network, comprising: a port configured to receive transaction layer flits via a UALink-based link; and a circuit coupled to the port, the circuit configured to: receive a compressed response field from a transaction layer flit; extract a single-bit indicator from the compressed response field, the single-bit indicator indicating whether the compressed response field corresponds to a unicast response or a collective operation response; and direct the response to a first processing path when the single-bit indicator indicates a collective operation response, and to a second processing path when the single-bit indicator indicates a unicast response; wherein the directing is based on the single-bit indicator without reference to an original request that generated the response. The circuit may receive compressed response fields from transaction layer flits arriving via the UALink-based link and may inspect the single-bit indicator in each compressed response field to determine the response type. The first processing path for collective operation responses may include operations such as reduction result aggregation, multicast acknowledgment tracking, or collective completion signaling to the protocol layer interface. The second processing path for unicast responses may include standard response delivery to the protocol layer interface. The stateless differentiation may eliminate the need for the circuit to maintain a lookup table or tracker entries mapping outstanding request TAGs to their request types.

In some implementations of the accelerator, the single-bit indicator occupies a bit position that was an unassigned spare bit in a prior version of the compressed response field. The bit position may have been reserved or unassigned in earlier versions of the compressed response format, and may be repurposed to carry the collective/unicast indication without altering the overall size of the compressed response field.

In some implementations of the accelerator, the circuit is further configured to identify block collective responses using dedicated compressed response field types that are distinct from compressed response field types used for unicast responses and non-block collective responses. The dedicated compressed response field types may enable the circuit to identify block collective responses based on the field type value alone, without inspecting the single-bit indicator. Block collective responses may include responses for block-read and block-write-full operations.

In some implementations of the accelerator, the circuit is further configured to: receive an uncompressed response field from the transaction layer flit, the uncompressed response field comprising a multi-bit response type field indicating whether the response corresponds to a unicast request, a collective primitive request, or a block collective request; and map the multi-bit response type field to protocol layer interface signals comprising a read response type information signal and a write response type information signal. The multi-bit response type field may include 2 bits and may be located in bit positions that were previously unassigned in the uncompressed response format. The read response type information signal and the write response type information signal may each comprise 2 bits and may be provided on the protocol layer interface to enable higher-layer logic to identify the response type.

In some implementations of the accelerator, the accelerator, when acting as a completer for a received request, is configured to retain the type of the received request and set the read response type information signal or the write response type information signal in a corresponding response based on the retained type. The accelerator may maintain the type of each received request, such as whether it was a unicast, collective primitive, or block collective request, and may embed the corresponding type information in the response generated for that request. This enables the originating accelerator or an intermediary switch to determine the response type without maintaining its own request-tracking state.

In some implementations of the accelerator, a switch of the UALink-based network is configured to: receive the transaction layer flit on an ingress port of the switch, determine, based on the single-bit indicator, whether to decrypt the response at the ingress port or to bypass decryption, wherein collective operation responses are directed to decryption and unicast responses bypass decryption. The switch may use the single-bit indicator to differentiate between collective operation responses that require authentication and decryption at the ingress port and unicast responses that may bypass decryption. This stateless determination may enable the switch to make per-response security decisions without maintaining per-transaction state.

In some implementations of the accelerator, responses with a successful completion status use the compressed response field, and wherein error responses use an uncompressed response field comprising a multi-bit status field. The multi-bit status field in the uncompressed response field may include 4 bits and may carry detailed error information. Restricting the compressed response format to successful completions may enable the compressed format to omit the status field and use the saved bits for other purposes, such as the single-bit indicator.

In some implementations of the accelerator, the circuit selects between the compressed response field and an uncompressed response field for a collective operation response based on whether the collective operation response meets compression restrictions, the compression restrictions comprising a successful completion status. The circuit may evaluate each outgoing collective operation response against the compression restrictions and may select the compressed response field format when the restrictions are met, or the uncompressed response field format when the restrictions are not met, such as when the response carries an error status.

FIG. 16B illustrates a method for processing responses in a UALink-based network comprising extracting a single-bit indicator from compressed response fields received via a UALink-based link, and directing responses to different processing paths based on the indicator value. The method may enable stateless response differentiation without maintaining tracking state for outstanding requests.

In various implementations, a method for processing responses in an Ultra Accelerator Link (UALink)-based network, comprising: receiving, at a circuit of an accelerator, a compressed response field from a transaction layer flit received via a port of the accelerator over a UALink-based link; extracting, by the circuit, a single-bit indicator from the compressed response field; determining, based on the single-bit indicator, whether the compressed response field corresponds to a unicast response or a collective operation response; and directing the response to different processing paths based on the determining; wherein the determining is performed without reference to an original request that generated the response. The method may be implemented in hardware, firmware, software, or combinations thereof, and may be performed by various types of devices including an accelerator, a switch, a processor, or a semiconductor device. The different processing paths may include separate credit return paths, separate buffering paths, or separate forwarding paths for collective and unicast responses. The stateless determination may enable the method to process responses at line rate without the latency overhead of a state table lookup.

In some implementations, the method further comprises processing, within a single control half-flit of the transaction layer flit, at least one compressed response field corresponding to a collective operation response and at least one compressed response field corresponding to a unicast response, wherein the extracting and the determining are performed independently for each compressed response field in the control half-flit. The control half-flit may contain multiple compressed response fields, each occupying a single sector, and the circuit may process each compressed response field independently by extracting the single-bit indicator from each and directing each response to the appropriate processing path.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

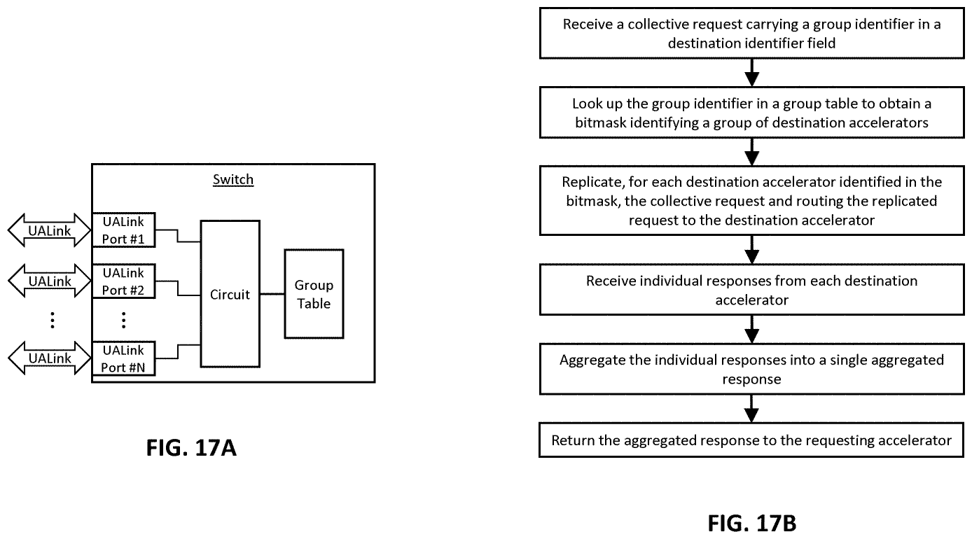

FIG. 17A illustrates a switch for a UALink-based network which may perform in-network collective operations by replicating a single collective request from a requesting accelerator to a group of destination accelerators, and aggregating the individual responses from the group into a single response returned to the requesting accelerator. The switch may maintain a group table with entries that map group identifiers to bitmasks identifying which accelerators belong to each collective group. When a collective request arrives at the switch, the switch may look up the group identifier carried in the request to determine the membership of the target group, replicate the request to each member, and track individual responses until all have been received. The switch may then produce a single aggregated response, including data reduction for read-type collective requests and status reduction for all collective request types. This approach may offload collective coordination from the accelerators to the switch, reducing the number of messages traversing the interconnect and lowering latency for collective operations such as gradient all-reduce during AI training. The circuit performing these operations may be implemented as combinational logic, a state machine, a microcontroller, or a combination thereof.

In various implementations, a switch for an Ultra Accelerator Link (UALink)-based network, comprising: a plurality of UALink-based ports; a group table comprising a plurality of entries, each entry associated with a group identifier and comprising a valid indicator and a bitmask identifying a group of accelerators; and a circuit configured to: receive a collective request from a requesting accelerator on an ingress port of the plurality of UALink-based ports, the collective request carrying the group identifier in a destination identifier field of the collective request; look up the group identifier in the group table to obtain the bitmask; replicate the collective request to each accelerator identified in the bitmask; track responses from each accelerator identified in the bitmask; and return a single aggregated response to the requesting accelerator when all individual responses have been received. The switch may route requests and responses among accelerators in a UALink-based network comprising up to 1024 accelerators. Each UALink-based port may correspond to a UALink link coupling the switch to an accelerator, and each link may include one or more lanes. The group table may be stored in on-chip memory within the switch, such as SRAM or register files, and may be indexed by the group identifier carried in the destination identifier field of the incoming collective request. The bitmask may have a width equal to the radix of the switch, with each bit position corresponding to a physical accelerator identifier. The circuit may replicate the collective request by issuing a separate request to a route table for each physical accelerator identifier whose corresponding bit is set in the bitmask. The route table may map the physical accelerator identifier to an egress port on the switch. The circuit may maintain tracking state for each outstanding replicated request, such as a counter or bitmask of pending responses, and may produce the aggregated response after all individual responses have been received and processed. For read-type collective requests, the aggregation may include data reduction. For write-type and atomic-type collective requests, the aggregation may include status reduction. The circuit may be implemented in hardware, firmware, software, or combinations thereof.

In some implementations of the switch, the destination identifier field carries a physical accelerator identifier for non-collective requests and the group identifier for collective requests, the group identifier indexing the group table to identify the group of accelerators. The destination identifier field may include a 10-bit field carried on the request channel. For non-collective requests, each bit pattern may correspond to a unique physical accelerator in the network. For collective requests, the same bit pattern may serve as an index into the group table, enabling the switch to determine the set of destination accelerators from the bitmask entry rather than from the field value itself.

In some implementations of the switch, the circuit is further configured to: verify that the valid indicator of the looked-up entry is set and that a bit corresponding to the requesting accelerator is set in the bitmask; and when the valid indicator is not set or the bit corresponding to the requesting accelerator is not set, drop the collective request and return a target abort response to the requesting accelerator. The valid indicator check may prevent the switch from processing collective requests that reference uninitialized or deallocated group table entries. The membership check may prevent an accelerator that is not a member of the collective group from issuing requests to that group, providing an access control mechanism at the switch level.

In some implementations of the switch, for each replicated request, the circuit passes an address space identifier, a transaction tag, a number of beats, an address, a command, a length, metadata, and a virtual channel of the collective request unchanged from the collective request to the replicated request, and routes the replicated request to the accelerator via a route table indexed by a physical accelerator identifier corresponding to the accelerator. Passing signals unchanged from the initial collective request to each replicated request may allow the destination accelerators to process the replicated requests identically, as each replicated request may appear to the destination as if it originated directly from the requesting accelerator. The route table may be the same route table used for non-collective unicast requests, indexed by the physical accelerator identifier corresponding to each bit set in the bitmask.

In some implementations of the switch, the circuit is further configured to reduce individual response statuses from the group of accelerators into a single aggregated status, the reduction comprising: returning an okay status when all individual statuses are okay, returning a non-okay status when all non-okay statuses are of a same type, and returning a mixed-response error status when individual non-okay statuses are of different types. The status reduction may allow the requesting accelerator to receive a single status representing the collective outcome of all individual responses. The mixed-response error status may indicate that different destination accelerators returned different types of non-okay responses, which may require software-level error handling to determine the appropriate recovery action.

In some implementations of the switch, when a data error indicator is asserted on a beat of data accompanying the collective request, the circuit marks the beat with the data error indicator in all replicated requests. Propagating the data error indicator to all replicated requests may allow each destination accelerator to independently detect and handle the corrupted beat, rather than silently consuming corrupted data.

In some implementations of the switch, the group table is programmed by a centralized controller via an out-of-band management interface, and the centralized controller dynamically updates group table entries when accelerators are added to or removed from the group of accelerators. The centralized controller may program the group table via a management protocol such as gNMI or Redfish, separate from the data-plane links carrying accelerator traffic. Dynamic updates may enable the centralized controller to reconfigure collective groups at runtime without interrupting collective operations on other groups.

In some implementations of the switch, the group table entries are partitioned by virtual partition, wherein a group identifier used by a first virtual partition references accelerators allocated to the first virtual partition, preventing a collective request from the first virtual partition from accessing accelerators in a second virtual partition. Partitioning the group table by virtual partition may enable multi-tenant deployments where different tenants share the same physical switch without risk of cross-tenant collective operations accessing another tenant's accelerators. In some examples, a virtual partition refers to a virtual pod.

In some implementations of the switch, each entry of the group table corresponds to a group of accelerators hosting a subset of experts in a Mixture-of-Experts AI model, enabling expert-parallel collective communication wherein each expert group has a dedicated group identifier. In a Mixture-of-Experts AI model, different subsets of experts may be distributed across different accelerators. Each expert group may have a dedicated group identifier in the group table, allowing the switch to replicate expert-parallel collective operations to those accelerators hosting the relevant experts, reducing unnecessary traffic to non-participating accelerators.

In some implementations of the switch, for a read-reduce collective request, the circuit sets a source accelerator identifier field on each replicated request to a physical accelerator identifier of the requesting accelerator, obtained from a per-port register programmed by a centralized controller. For read-reduce collective requests, the source identifier field on the replicated requests may identify the requesting accelerator rather than the switch, allowing destination accelerators to use the source identifier for memory protection checks or address translation. The per-port register may be programmed by the centralized controller during group table configuration.

In some implementations of the switch, the group table further comprises hot-standby entries pre-provisioned by the centralized controller, each hot-standby entry comprising a bitmask with a replacement accelerator substituted for a failed accelerator, enabling the circuit to switch from a current group table entry to a hot-standby entry upon detection of an accelerator failure without re-programming the group table. Pre-provisioning hot-standby entries may enable the switch to continue collective operations with minimal disruption when an accelerator fails. The centralized controller may create hot-standby entries that mirror the current group membership but with a replacement accelerator substituted for each accelerator that may fail, and the switch may activate a hot-standby entry upon receiving a failure indication from the centralized controller or from a timeout event.

FIG. 17B illustrates a method for performing a collective operation in a UALink-based network comprising receiving a collective request at a switch, looking up a group identifier in a group table to determine the set of destination accelerators, replicating the collective request to each destination accelerator, receiving and aggregating individual responses, and returning a single aggregated response to the requesting accelerator. The method may be applicable to various types of collective operations, including read-reduce operations where data payloads from destination accelerators are arithmetically combined, multicast write operations where data is distributed to all group members, and multicast atomic operations. The method may be performed by hardware circuitry within the switch, by firmware executing on a processor within the switch, or by a combination thereof.

In various implementations, a method for performing a collective operation in an Ultra Accelerator Link (UALink)-based network, comprising: receiving, at a switch via a UALink-based port, a collective request from a requesting accelerator, the collective request carrying a group identifier in a destination identifier field; looking up the group identifier in a group table at the switch to obtain a bitmask identifying a group of destination accelerators; for each destination accelerator identified in the bitmask, replicating the collective request and routing the replicated request to the destination accelerator; receiving individual responses from each destination accelerator; aggregating the individual responses into a single aggregated response; and returning the aggregated response to the requesting accelerator. The method may be performed by the switch each time a collective request arrives on an ingress port. The group table lookup may be performed in a single clock cycle or across multiple clock cycles depending on the group table implementation. The replication may occur sequentially or in parallel depending on the switch architecture. The aggregation may include both data aggregation (for read-type collectives where response data payloads are combined) and status aggregation (for all collective types where individual response statuses are reduced to a single status). The method may support groups ranging from two accelerators to the full radix of the switch.

In some implementations of the method, the collective request comprises a read-reduce request, and aggregating the individual responses comprises performing a data reduction operation on data payloads received from the destination accelerators and returning a single reduced data payload to the requesting accelerator. The data reduction operation may include an arithmetic or logical operation applied element-wise across the data payloads from all destination accelerators. The switch may accumulate partial results as each response arrives, or may buffer all responses and perform the reduction after all have been received.

In some implementations of the method, the collective request comprises a multicast write request, and replicating comprises sending copies of write data accompanying the collective request to each destination accelerator identified in the bitmask. The multicast write request may carry data on an originator data channel, and the switch may replicate both the request and the accompanying data to each destination accelerator identified in the bitmask.

In some implementations of the method, the read-reduce request is issued by an accelerator executing a data-parallel training workload of an AI model, and the data reduction operation comprises addition of gradient values from the group of destination accelerators. During data-parallel training, each accelerator may compute gradients for its local data partition. The read-reduce collective operation may aggregate these gradients across all participating accelerators using addition, producing a sum or average of gradients that may then be applied to update model parameters.

In some implementations of the method, the switch is a first switch of a plurality of switches in the UALink-based network, and a centralized controller programs consistent group table entries across the plurality of switches to enable multi-switch collective coordination. In a network with multiple switches, a collective group may span accelerators coupled to different switches. The centralized controller may program matching group table entries on each switch such that the same group identifier maps to the correct subset of accelerators reachable from that switch, enabling coordinated multi-switch collective operations.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an apparatus configured to operate as a switch, wherein the apparatus comprises switching circuitry and is configured to perform the method.

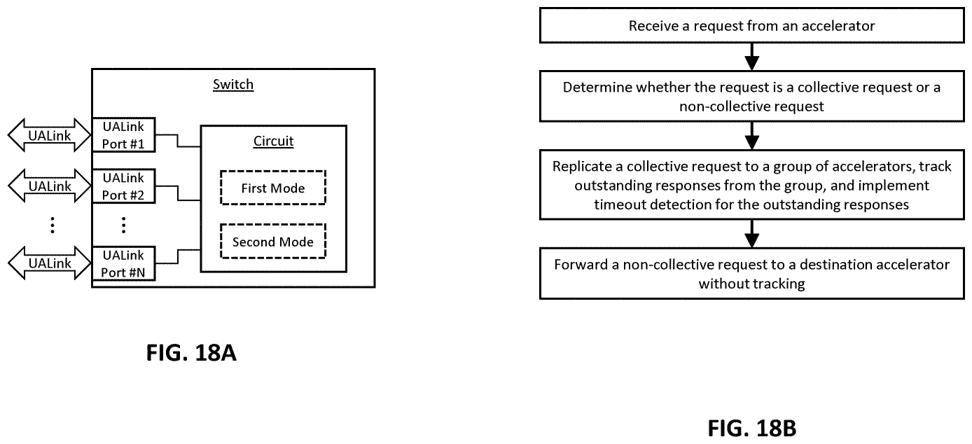

FIG. 18A illustrates a switch for a UALink-based network which may operate in two distinct modes depending on the type of request received. For collective requests that involve multiple destination accelerators, the switch may operate in a stateful mode where it tracks outstanding replicated requests, maintains response state, and implements timeout detection to handle unresponsive accelerators. For non-collective unicast requests that target a single destination accelerator, the switch may operate in a stateless mode where it forwards requests without tracking, consistent with the traditional switch behavior. The switch may determine which mode to use based on the command type field of each incoming request, enabling the same switch to simultaneously serve both collective and unicast traffic with the appropriate level of state management for each. This dual-mode architecture may enable the switch to provide the reliability and coordination needed for collective operations while maintaining the low-overhead forwarding efficiency for unicast traffic.

In various implementations, a switch for an Ultra Accelerator Link (UALink)-based network, comprising: a plurality of UALink-based ports; and a circuit configured to operate in a first mode for collective requests and a second mode for non-collective requests; wherein in the first mode, the circuit is configured to track outstanding replicated requests issued to a group of accelerators and implement timeout detection for the outstanding replicated requests; and wherein in the second mode, the circuit is configured to forward requests without tracking; and wherein the circuit determines the first mode or the second mode based on a command type field of a received request. The circuit may inspect the command type field of each incoming request to determine whether the request corresponds to a collective operation or a unicast operation. Collective operations may include read-reduce, multicast write, multicast full-beat write, and multicast atomic operations. The tracking in the first mode may include maintaining a count or bitmask of pending responses for each outstanding collective request, and the timeout detection may include per-port timers that expire if any replicated request does not receive a response within a configurable time period. In the second mode, the circuit may forward requests based on the destination identifier field and the route table without allocating any tracking resources or starting any timers. The dual-mode behavior may be implemented using shared hardware that is dynamically allocated to either mode based on the incoming request type, or using dedicated hardware paths for each mode.

In some implementations of the switch, in the first mode, the circuit is further configured to: reduce individual response statuses from the group of accelerators into a single aggregated status, comprising returning a mixed-response error status when individual non-okay statuses are of different types; and for a read-reduce collective request, perform a data reduction operation on data payloads received from the group of accelerators. The mixed-response error status may indicate to the requesting accelerator that the destination accelerators returned inconsistent error conditions, which may require software-level diagnosis. The data reduction operation for read-reduce requests may be performed incrementally as each response arrives, accumulating partial results in a buffer within the switch.

In some implementations of the switch, the timeout detection comprises a per-port watch dog timer for each outstanding collective request, and upon timer expiration, the switch enters an isolation mode on the affected port. The isolation mode may cause the switch to stop issuing new requests on the affected port and provide completion timeout responses for all outstanding requests on that port. The per-port isolation may prevent a timeout on one port from affecting collective operations on other ports, containing the failure to the affected accelerator.

In some implementations of the switch, the watch dog timer values for collective requests in the first mode are configured independently of timeout values for non-collective requests, with longer timeouts for collective operations involving larger groups of accelerators. Collective operations involving larger groups may require longer completion times because the switch waits for responses from all group members. Configuring collective timeouts independently from unicast timeouts may allow the switch to use longer timeouts for collectives without delaying failure detection for unicast traffic.

In some implementations of the switch, the circuit is further configured to, in the first mode, process collective requests from a plurality of different groups concurrently, interleaving replicated requests from different groups according to a scheduling policy. The scheduling policy may include round-robin, priority-based, or weighted fair scheduling among concurrent groups. The circuit may maintain separate tracking state for each active group to enable concurrent processing without interference between groups.

In some implementations of the switch, the circuit is further configured to, in the first mode, allocate bandwidth to collective requests from different groups based on a quality-of-service policy, the quality-of-service policy configurable per group or per virtual partition. The quality-of-service policy may allocate a guaranteed minimum bandwidth to each group or virtual partition, with remaining bandwidth distributed proportionally or based on priority levels. The policy may be programmed by the centralized controller as part of the group table configuration.

FIG. 18B illustrates a method for processing requests at a switch in a UALink-based network comprising determining, for each incoming request, whether the request is a collective request or a non-collective request, and processing the request differently based on the determination. For collective requests, the switch may replicate the request, track outstanding responses, and implement timeout detection. For non-collective requests, the switch may forward the request without tracking. This dual-mode processing approach may enable the switch to provide stateful coordination for collective operations while maintaining efficient stateless forwarding for unicast traffic.

In various implementations, a method for processing requests at a switch in an Ultra Accelerator Link (UALink)-based network, comprising: receiving, at the switch via a UALink-based port, a request from an accelerator; determining, based on a command type field of the request, whether the request is a collective request or a non-collective request; when the request is a collective request: replicating the request to a group of accelerators, tracking outstanding responses from the group, and implementing timeout detection for the outstanding responses; and when the request is a non-collective request: forwarding the request to a destination accelerator without tracking. The method may be performed continuously as requests arrive at the switch. The determination may be based on matching the command type field against a set of collective command type encodings. The tracking may include allocating a tracking entry for the collective request, recording the number of expected responses, and updating the tracking entry as responses arrive. The timeout detection may include starting a timer when the collective request is replicated and stopping the timer when all responses have been received. The forwarding for non-collective requests may include looking up the destination identifier in a route table to determine the egress port.

In some implementations of the method, the collective request comprises at least one of: a ReadReduce command, a WriteMulticast command, a WriteFullMulticast command, or an AtomicNRMulticast command. The ReadReduce command may instruct the switch to replicate a read request to all group members and perform data reduction on the returned payloads. The WriteMulticast and WriteFullMulticast commands may instruct the switch to replicate write data to all group members. The AtomicNRMulticast command may instruct the switch to replicate a non-returning atomic operation to all group members.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an apparatus configured to operate as a switch, wherein the apparatus comprises switching circuitry and is configured to perform the method.

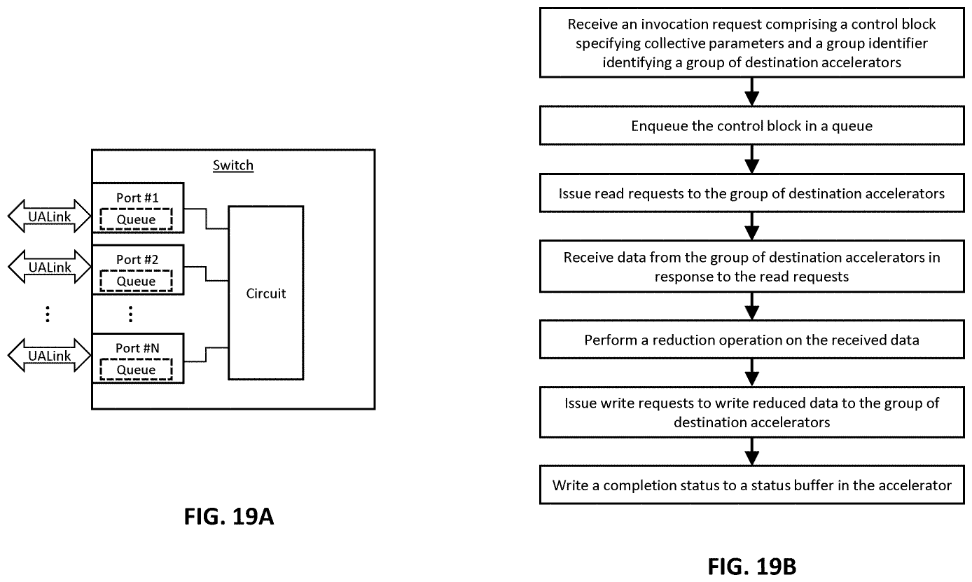

FIG. 19A illustrates a switch for a UALink-based network, which may offload entire collective operations from accelerators by receiving a single invocation request carrying a control block that specifies all parameters for the collective, and then generating the memory access requests needed to complete the operation. The switch may read data from input buffers at a group of destination accelerators, perform a reduction operation on the read data, write the reduced results to output buffers at the destination accelerators, and write a completion status to a status buffer in the requesting accelerator's memory. This autonomous operation may transform the switch from a passive packet relay into an active computation engine capable of processing collective operations such as all-reduce, broadcast, and reduce with a single invocation from the accelerator. The queue at each port may store control blocks for multiple pending collective operations, enabling pipelining where the accelerator submits multiple collective invocations without waiting for prior invocations to complete. The circuit performing these operations may be implemented as a state machine, a microcontroller, dedicated hardware logic, or a combination thereof.

In various implementations, a switch for an Ultra Accelerator Link (UALink)-based network, comprising: a plurality of UALink-based ports, each port comprising a queue for storing collective operation parameters; and a circuit configured to: receive an invocation request from an accelerator via one of the plurality of UALink-based ports, the invocation request carrying a control block specifying collective parameters and a group identifier identifying a group of destination accelerators; enqueue the control block in the queue; issue read requests to the group of destination accelerators; perform a reduction operation on data received in response to the read requests; issue write requests to write reduced data to the group of destination accelerators; and write a completion status to a status buffer in the accelerator. The switch may receive the invocation request on an ingress port and extract the control block from an originator data channel accompanying the request. The group identifier may index a group table at the switch to determine the set of destination accelerators. The circuit may autonomously generate read requests to input buffer locations at each destination accelerator, collect the response data, perform the specified reduction operation across the collected data, and generate write requests to output buffer locations at the destination accelerators. The read and write requests generated by the circuit may be routed through the switch's route table in the same manner as requests originating from accelerators. The completion status may be written to a pre-designated status buffer location in the requesting accelerator's memory via a write request generated by the switch. The entire autonomous sequence, from the initial read requests through the reduction to the final write requests and status notification, may complete without any further involvement from the requesting accelerator after the initial invocation. The queue may store multiple pending control blocks, enabling the circuit to process collective operations in sequence or, in some implementations, with interleaved memory access requests.

In some implementations of the switch, the control block specifies a collective type, a reduction operation, an input buffer offset, an output buffer offset, and a status buffer offset; and the circuit computes buffer addresses by adding the offsets to a base address carried in the invocation request, the base address being aligned to a 4K boundary. The base address may be carried in the address field of the invocation request, with low-order bits zeroed to achieve alignment. The offsets may be concatenated with zero bits to achieve 256-byte alignment for the buffer addresses. The collective type may specify the communication pattern, such as broadcast, reduce, or all-reduce. The reduction operation may specify the arithmetic or logical operation to perform on the collected data.

In some implementations of the switch, upon receiving the invocation request, the switch returns an acknowledgment response to the accelerator without waiting for the collective operation to complete. The immediate acknowledgment may enable the accelerator to issue subsequent invocation requests without waiting for prior operations to complete, allowing pipelining of multiple collective operations at the switch.

In some implementations of the switch, the collective parameters specify a collective type comprising at least one of: broadcast, reduce, or all-reduce, each available in strided and non-strided variants. In a broadcast collective, the circuit may read data from an input buffer at a single source accelerator and write copies to output buffers at all destination accelerators. In a reduce collective, the circuit may read data from input buffers at all destination accelerators, perform a reduction operation, and write the result to an output buffer at a single destination. In an all-reduce collective, the circuit may read, reduce, and write the result back to all destination accelerators. Strided variants may access non-contiguous memory regions.

In some implementations of the switch, when a read request or a write request issued by the circuit receives a non-okay response, the circuit ceases issuing new requests for the collective operation, waits for outstanding requests to complete, and writes the completion status to the status buffer indicating the failure. The error containment may prevent the switch from issuing additional requests to accelerators that may be in a degraded state. The circuit may wait for all previously issued requests to receive responses before writing the status buffer, so that the status buffer reflects the complete error state of the collective operation.

In some implementations of the switch, tags for the read requests and the write requests issued by the circuit are independent of tags used for unicast requests and collective primitive requests. The independent tag space may allow the switch to generate tags for its autonomous memory access requests without coordinating with the tag spaces used by accelerators for their own requests. The tag values for switch-generated requests and accelerator-generated requests may overlap without conflict.

In some implementations of the switch, the status buffer comprises valid indicators, an invocation status, a read/write error indicator, an error response status, a failing accelerator identifier, and a failing address; and the circuit writes the status buffer to the accelerator via a write request. The valid indicators may include two separate valid bits, a first indicating the invocation status is valid and a second indicating the error detail fields are valid. The invocation status may indicate success, invalid invocation, insufficient resources, or termination. The failing accelerator identifier and failing address may enable the requesting accelerator's software to diagnose which accelerator and which memory address caused the failure.

In some implementations of the switch, the collective parameters further comprise strided memory access parameters specifying a number of contiguous blocks per row, a number of rows, and a skip size between rows, and the circuit generates addresses for the read requests and the write requests according to the strided pattern. The strided memory access pattern may enable the circuit to read and write non-contiguous memory regions that correspond to multi-dimensional data structures in accelerator memory. The circuit may generate addresses by iterating over rows, where each row comprises a contiguous sequence of memory blocks followed by a skip to the start of the next row.

In some implementations of the switch, the number of contiguous blocks per row corresponds to a first dimension of a multi-dimensional tensor stored in accelerator memory, the number of rows corresponds to a second dimension, and the skip size corresponds to a stride between non-contiguous elements of the second dimension. The strided parameters may map directly to the memory layout of multi-dimensional tensors used in AI training, such as weight matrices, activation tensors, or gradient buffers, enabling the switch to process tensor-shaped data without requiring the accelerator to rearrange the data into a contiguous buffer before the collective operation.

In some implementations, the switch further comprises a register configured to constrain addresses of the read requests and the write requests generated by the circuit to a bounded memory region, preventing the circuit from issuing memory access requests to addresses outside the bounded memory region. The register may include bits corresponding to high-order address bits, loaded with a contiguous set of active values starting at the highest-order bit. The effect may be that all addresses generated by the circuit are masked to fall within a bounded region defined by the register contents, providing hardware-enforced memory protection against out-of-bounds memory access by the switch.

In some implementations of the switch, the register is programmed by a centralized controller based on a virtual partition allocated to the accelerator, constraining the collective operation to memory regions allocated to the virtual partition. In a multi-tenant deployment, different virtual partitions may be allocated different memory regions. The centralized controller may program the register to match the memory region of the virtual partition to which the requesting accelerator belongs, preventing the switch from generating memory access requests that cross virtual partition boundaries. In some examples, a virtual partition refers to a virtual pod.

In some implementations of the switch, the collective parameters specify a broadcast collective type, and the circuit distributes model parameters from a source accelerator to the group of destination accelerators for an AI model checkpointing operation. During AI model checkpointing, a primary accelerator may hold the authoritative copy of model parameters. The broadcast block collective may distribute these parameters to backup accelerators, with the strided access pattern matching the tensor layout of the model's weight matrices.

In some implementations of the switch, the collective parameters specify a vendor-defined collective type, and the circuit processes the vendor-defined collective type according to vendor-specific logic. The vendor-defined collective type may enable switch vendors to implement proprietary collective communication patterns beyond the standard broadcast, reduce, and all-reduce types. The vendor-specific logic may be implemented in firmware, hardware, or a combination thereof.

FIG. 19B illustrates a method for offloading a collective operation to a switch in a UALink-based network, comprising receiving a single invocation request from an accelerator, enqueuing the associated control block, and executing the entire collective operation at the switch without further accelerator involvement. The switch may issue read requests to collect data from destination accelerators, perform a reduction operation on the collected data, issue write requests to distribute results, and write a completion status to the accelerator's memory. This method may reduce the number of requests the accelerator manages individually, consolidating what would otherwise require many separate accelerator-initiated read and write transactions into a single invocation.

In various implementations, a method for offloading a collective operation to a switch in an Ultra Accelerator Link (UALink)-based network, comprising: receiving, at the switch via a UALink-based port, an invocation request from an accelerator, the invocation request comprising a control block specifying collective parameters and a group identifier identifying a group of destination accelerators; enqueuing the control block in a queue at the switch; issuing, by the switch, read requests to the group of destination accelerators; receiving data from the group of destination accelerators in response to the read requests; performing a reduction operation on the received data; issuing, by the switch, write requests to write reduced data to the group of destination accelerators; and writing a completion status to a status buffer in the accelerator. The method may be initiated by a single invocation request from the accelerator and may complete without any further involvement from the accelerator. The switch may generate read requests sequentially or in parallel across the group of destination accelerators. The reduction operation may be performed incrementally as responses arrive or after all responses have been collected. The write requests may distribute the reduced data to output buffer locations at each destination accelerator. The completion status may inform the accelerator whether the collective operation completed successfully or encountered an error. The method may be applicable to gradient synchronization during AI training, model parameter broadcast, and other collective communication patterns.

In some implementations of the method, for reduction operations that are not associative, the switch performs the reduction operation in an order that remains the same for every collective instance with the same group of destination accelerators. The deterministic ordering may be based solely on the set of participating accelerators, such as by processing responses in ascending order of physical accelerator identifier. This may enable reproducible results across repeated executions of the same collective operation with the same data.

In some implementations of the method, software on the accelerator clears valid indicators in the status buffer before issuing the invocation request and polls the valid indicators to detect completion of the collective operation. The polling-based completion notification may avoid the overhead of interrupt generation and handling, enabling lower-latency detection of completion for workloads that actively wait for collective results. The valid indicators may include separate bits for invocation status validity and error detail validity.

In some implementations of the method, the completion status comprises a first valid indicator indicating the invocation status is valid, a second valid indicator indicating error detail fields are valid, the invocation status, a read/write error indicator, an error response status, a failing accelerator identifier, and a failing address. The two-stage valid indicator mechanism may allow the switch to write the invocation status first and the error details subsequently, enabling the accelerator to quickly determine whether the operation succeeded before examining detailed error information.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an apparatus configured to operate as a switch, wherein the apparatus comprises switching circuitry and is configured to perform the method.

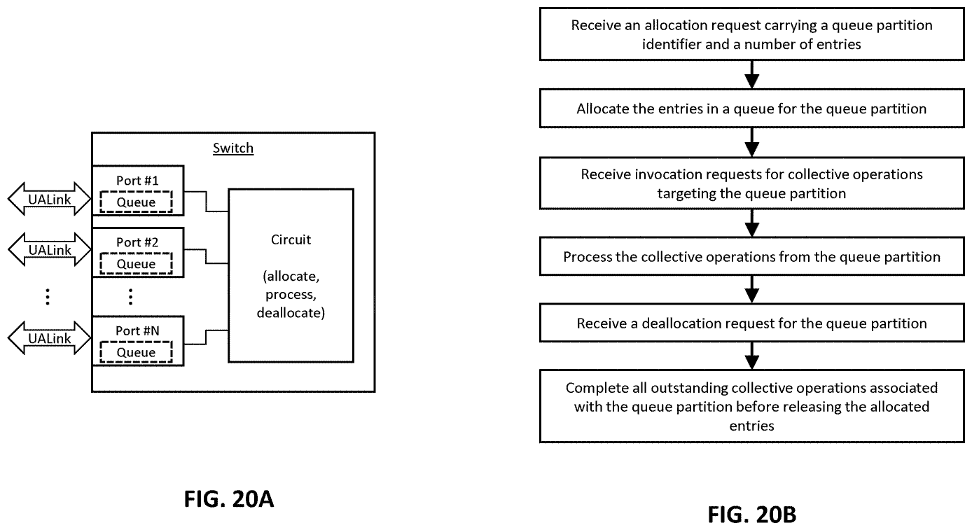

FIG. 20A illustrates a switch for a UALink-based network which may manage queue resources for block collective operations through a lifecycle of allocation, invocation, and deallocation. An accelerator may request allocation of entries in a per-port queue by specifying a queue partition identifier and a number of entries. The switch may allocate the requested entries and subsequently accept invocation requests for collective operations targeting the allocated partition. Multiple queue partitions may be active concurrently, enabling the switch to process collective operations from different partitions in an interleaved fashion. When the accelerator issues a deallocation request, the switch may complete all outstanding collective operations associated with the partition before releasing the allocated entries, providing a clean shutdown sequence that prevents data loss. This queue lifecycle management may enable pipelining of multiple collective operations and concurrent execution across different partitions.

The queue partition may be a submission queue within a per-port control block queue on the switch. The queue may store control blocks for pending collective operations, and the queue partition may be one of a plurality of numbered logical portions of the queue, each dynamically allocated by the accelerator. The queue partition identifier may be a submission queue number identifying the logical portion, and the number of entries may specify the capacity allocated to that logical portion. The queue partition identifier and the number of entries may be encoded in designated bit positions within the address field of the allocation request.

In various implementations, a switch for an Ultra Accelerator Link (UALink)-based network, comprising: a plurality of UALink-based ports, each port comprising a queue for storing collective operation parameters; and a circuit configured to: receive an allocation request from an accelerator via one of the plurality of UALink-based ports, the allocation request carrying a queue partition identifier and a number of entries to allocate, the queue partition identifier and the number of entries encoded in an address field of the allocation request; allocate the entries in the queue for the queue partition; receive invocation requests for collective operations targeting the queue partition, each invocation request carrying a control block specifying collective parameters; process the collective operations from the queue partition; and upon receiving a deallocation request for the queue partition, complete all outstanding collective operations associated with the queue partition before releasing the allocated entries. The queue may be implemented as an on-chip memory structure at each port, partitioned into logical portions identified by the queue partition identifier. The queue partition identifier and the number of entries may be encoded in specific bit positions of the address field of the allocation request, leveraging the existing request format without requiring additional signal fields. The circuit may maintain a set of management registers tracking the allocation state of each queue partition, including which partitions are allocated, how many entries each has, and how many entries are currently in use. The invocation requests may be accepted and their control blocks enqueued as long as the queue partition has available entries. The deallocation sequence may involve the circuit ceasing to accept new invocations for the partition, waiting for all in-progress collective operations to complete their memory access sequences and write their status buffers, and then marking the partition as available for reallocation. This drain-before-release behavior may prevent data loss or incomplete collective operations.

In some implementations of the switch, upon receiving the allocation request, the circuit returns a status indicating one of: successful allocation, invalid allocation, or duplicate allocation; wherein duplicate allocation is returned when the queue partition has already been allocated. The invalid allocation status may be returned when the allocation request specifies an invalid queue partition identifier or an invalid number of entries. The duplicate allocation status may prevent an accelerator from inadvertently overwriting an active queue partition that is already in use.

In some implementations of the switch, when the queue partition has no available entries, the circuit returns an insufficient resources status for invocation requests targeting the queue partition. The insufficient resources status may signal to the accelerator that the queue partition cannot accept additional invocations until one or more pending collective operations complete and free entries. The accelerator may retry the invocation after a delay or after polling for completion of a prior operation.

In some implementations of the switch, the circuit is further configured to process collective operations from different queue partitions concurrently, interleaving memory access requests from different collective operations. The interleaving may allow the switch to overlap the read and write latencies of different collective operations, improving overall throughput. The circuit may use round-robin, priority-based, or fair scheduling across active queue partitions.

In some implementations of the switch, the circuit processes collective operations from different queue partitions according to a priority-based scheduling policy, the priority configurable per queue partition. The priority may be assigned by the centralized controller or by the requesting accelerator as part of the allocation request. Higher-priority collective operations may receive a larger share of the switch's memory access bandwidth, enabling latency-sensitive operations to complete faster.

FIG. 20B illustrates a method for managing collective operation resources at a switch in a UALink-based network, comprising a lifecycle of allocation, invocation, processing, and deallocation. The method may begin with the accelerator requesting allocation of queue entries, proceed through one or more collective operation invocations, and conclude with deallocation where the switch drains all outstanding operations before releasing resources. This lifecycle may enable the accelerator to manage switch-side resources for collective operations in a controlled manner, similar to how software manages submission queues in storage controllers or network interface cards.

In various implementations, a method for managing collective operation resources at a switch in an Ultra Accelerator Link (UALink)-based network, comprising: receiving, at the switch via a UALink-based port, an allocation request from an accelerator, the allocation request carrying a queue partition identifier and a number of entries, the queue partition identifier and the number of entries encoded in an address field of the allocation request; allocating the entries in a queue at the switch for the queue partition; receiving invocation requests for collective operations targeting the queue partition; processing the collective operations from the queue partition; receiving a deallocation request for the queue partition; and completing all outstanding collective operations associated with the queue partition before releasing the allocated entries. The method may be performed independently on each port of the switch, with each port maintaining its own queue and allocation state. The allocation step may involve the circuit reserving a contiguous or non-contiguous set of entries in the queue for the specified partition. The processing step may involve the circuit dequeuing control blocks from the partition and executing the corresponding collective operations, including autonomously generating memory access requests. The deallocation step may involve a drain sequence where the circuit stops accepting new invocations, waits for all in-progress operations to complete their reads, writes, and status buffer updates, and then marks the entries as available. The method may be repeated for multiple allocation-deallocation cycles over the lifetime of the switch.

In some implementations, the method further comprises writing, by the switch, an intermediate progress indicator to the accelerator during processing of a collective operation, the intermediate progress indicator indicating a number of completed memory access requests relative to a total number of memory access requests for the collective operation. The intermediate progress indicator may enable the accelerator's software to monitor the progress of long-running collective operations, such as large all-reduce operations spanning many memory blocks. The progress indicator may be written to a designated location in the status buffer or to a separate progress register in accelerator memory.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an apparatus configured to operate as a switch, wherein the apparatus comprises switching circuitry and is configured to perform the method.

In some examples, a switch for a UALink-based network may perform arithmetic reduction operations on data received from multiple accelerators as part of a collective read operation. The switch may receive a collective read request that specifies the reduction operation to perform and the datatype of the data, with both the reduction operation and the datatype encoded in a source identifier field of the request. This encoding may leverage an existing signal field that carries a different meaning for non-collective requests, delivering the arithmetic instruction to the switch without requiring additional signal fields or expanding the packet format. The circuit performing the reduction may support multiple reduction operations including minimum, maximum, addition, and bitwise logical operations across a range of integer and floating-point datatypes. The circuit may also support configurable rounding modes, including stochastic rounding with seed-based reproducibility for AI training workloads. This approach may enable the switch to perform data reduction within the network fabric, reducing the number of data traversals and the compute burden on the accelerators.

In various implementations, a switch for an Ultra Accelerator Link (UALink)-based network, comprising: a plurality of UALink-based ports; and a circuit configured to: receive a collective read request from a requesting accelerator via one of the plurality of UALink-based ports, the collective read request specifying a reduction operation and a datatype, the reduction operation and the datatype encoded in a source identifier field of the collective read request; receive data from a plurality of accelerators in response to replicated read requests; perform the reduction operation on the received data according to the datatype; and return a reduced result to the requesting accelerator. The circuit may decode the source identifier field to extract the reduction operation and the datatype, and may select the appropriate arithmetic logic and data path width based on the decoded values. The replicated read requests may be issued by the switch to each accelerator identified in a group of destination accelerators, and the circuit may accumulate or buffer the data payloads as they arrive. The reduction operation may be performed incrementally as each response arrives or after all responses have been collected, depending on the associativity of the operation. The reduced result may be returned to the requesting accelerator as a single response containing the computed result. The circuit may be implemented as a dedicated arithmetic logic unit within the switch, or as a configurable data path that shares resources with other switch functions. The source identifier field may include a multi-bit field on the request channel, and the encoding may define a mapping between bit patterns and combinations of reduction operations and datatypes.

In some implementations of the switch, the source identifier field carries a physical accelerator identifier for non-collective requests, and for the collective read request, the source identifier field is overloaded to carry the reduction operation and the datatype encoding. The overloading may allow the switch to deliver the arithmetic instruction without additional signal fields or packet format changes. The switch may determine whether to interpret the source identifier field as a physical accelerator identifier or as a reduction operation encoding based on the command type of the request.

In some implementations of the switch, the collective read request further specifies a rounding mode encoded in upper bits of the source identifier field, and the circuit performs the reduction operation using the specified rounding mode. The rounding mode may occupy the upper bits of the source identifier field, with the reduction operation and datatype occupying the lower bits. The rounding mode may specify how the circuit rounds intermediate or final results when the exact result cannot be represented in the target datatype, such as round to nearest even, round toward zero, or stochastic rounding.

In some implementations of the switch, the reduction operation comprises at least one of: minimum, maximum, addition, bitwise AND, bitwise OR, or bitwise XOR. The minimum and maximum operations may compare values from the participating accelerators and return the smallest or largest value, respectively. The addition operation may compute the element-wise sum of data from all participants. The bitwise operations may perform element-wise logical operations on the data regardless of the numerical format.

In some implementations of the switch, the datatype comprises at least one of: unsigned integer or signed integer in 8-bit, 16-bit, 32-bit, or 64-bit widths. The integer datatypes may cover the range of integer precisions commonly used in AI workloads, from 8-bit quantized activations and weights to 64-bit accumulators. The circuit may select the appropriate comparison, addition, or bitwise logic based on the integer width and signedness.

In some implementations of the switch, the datatype comprises at least one of: FP64, FP32, FP16, BF16, E5M2, or E4M3. The E5M2 and E4M3 formats may be 8-bit floating-point representations with 5-bit and 4-bit exponents respectively, providing reduced precision and bandwidth compared to FP16 or BF16. These compressed formats may be used in AI training and inference to reduce interconnect bandwidth consumption.

In some implementations of the switch, the rounding mode comprises stochastic rounding, and the switch comprises a hardware linear feedback shift register to generate pseudo-random values; and wherein the requesting accelerator provides a stochastic seed via a request attribute field of the collective read request, the request attribute field carrying byte enables for non-collective read requests. The hardware linear feedback shift register may produce a sequence of pseudo-random values that, when combined with the stochastic seed provided by the accelerator, determine the rounding direction for each element. The request attribute field may be overloaded to carry the stochastic seed instead of byte enables when the request is a collective read request, leveraging the existing field without additional signal overhead.

In some implementations of the switch, for minimum and maximum operations on floating-point data, the reduction operation encoding further specifies one of: a first NaN handling semantic in which a number is returned when one operand is NaN, or a second NaN handling semantic in which NaN is propagated. The first NaN handling semantic may correspond to IEEE 754-2008 MaxNum and MinNum behavior, where NaN operands are suppressed in favor of numeric operands. The second NaN handling semantic may correspond to IEEE 754-2019 maximum and minimum behavior, where NaN is propagated. An AI framework may select the appropriate semantic based on the model's numerical stability requirements.

In some implementations of the switch, the circuit performs addition of gradient values in FP16 or BF16 from the plurality of accelerators during a data-parallel training step of an AI model, and returns the reduced gradient to the requesting accelerator. During data-parallel training, each accelerator may compute local gradients for its partition of the training data. The collective read-reduce operation with addition may aggregate these gradients across all participating accelerators, producing a sum that may then be averaged and applied to update model parameters on each accelerator.

In some implementations of the switch, the reduction operation and the datatype are also specified in a reduction operation field within a control block carried with a block collective invocation request, using a same encoding as the source identifier field encoding. The shared encoding may allow the same arithmetic unit to process both collective primitive operations and block collective operations without requiring separate decoding logic. The control block may carry the encoding in a dedicated field alongside other collective parameters such as collective type, buffer offsets, and strided access parameters.

In some implementations of the switch, the reduction operation and datatype encoding specifies a vendor-defined reduction operation, and the circuit processes the vendor-defined reduction operation according to vendor-specific logic. The vendor-defined reduction operations may enable switch vendors to implement proprietary arithmetic functions beyond the standard operations, such as specialized activation functions, quantization-aware operations, or domain-specific reductions.

In some implementations, the switch further comprises hardware performance counters configured to track at least one of: a count of reduction operations performed, a latency of reduction operations, or a throughput of the circuit. The hardware performance counters may enable monitoring of the arithmetic unit's utilization and performance characteristics. The counters may be readable via the management interface and may be used by the centralized controller or by training framework software to optimize collective operation scheduling and datatype selection.

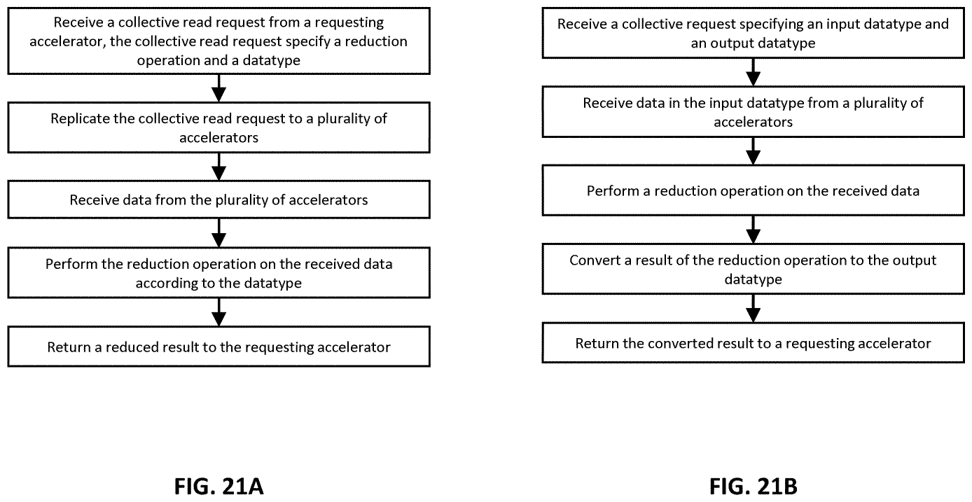

FIG. 21A illustrates a method for performing in-network data reduction in a UALink-based network, comprising receiving a collective read request at a switch, where the request specifies a reduction operation and a datatype encoded in a signal field that serves a different purpose for non-collective requests. The switch may replicate the collective read request to a plurality of accelerators, receive the data payloads, perform the specified reduction operation according to the specified datatype, and return a single reduced result. The method may support configurable rounding modes, including stochastic rounding with deterministic reproducibility when the same seed is used across repeated executions.

In various implementations, a method for performing in-network data reduction in an Ultra Accelerator Link (UALink)-based network, comprising: receiving, at a switch via a UALink-based port, a collective read request from a requesting accelerator, the collective read request specifying a reduction operation and a datatype, the reduction operation and the datatype encoded in a signal field that carries a source identifier for non-collective requests; replicating the collective read request to a plurality of accelerators; receiving data from the plurality of accelerators; performing the reduction operation on the received data according to the datatype; and returning a reduced result to the requesting accelerator. The method may be performed each time a collective read request arrives at the switch. The signal field may be decoded by the switch to extract both the reduction operation and the datatype, which together specify how the data payloads from the plurality of accelerators are to be combined. The replication may involve the switch issuing individual read requests to each accelerator in the collective group. The reduction may be performed element-wise across the data payloads, with the element size and arithmetic rules determined by the decoded datatype. The method may be applicable to collective groups ranging from two accelerators to the full radix of the switch.

In some implementations of the method, the signal field further encodes a rounding mode in upper bits, and performing the reduction operation comprises applying the rounding mode to the result. The rounding mode may determine how intermediate or final results are rounded when the exact result cannot be represented in the target precision. The rounding mode may be applied independently to each element of the reduced result.

In some implementations of the method, the rounding mode is stochastic rounding, and a stochastic seed provided by the requesting accelerator in a request attribute field is used by the switch to generate pseudo-random values; wherein repeated executions of the collective read request with the same data and the same stochastic seed produce identical reduced results. The deterministic reproducibility may be achieved by using the stochastic seed to initialize a pseudo-random number generator in the switch to the same state for each execution. This may enable AI training frameworks to reproduce training runs for debugging or compliance purposes, even when stochastic rounding is used to reduce quantization bias.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an apparatus configured to operate as a switch, wherein the apparatus comprises switching circuitry and is configured to perform the method.

In some examples, a switch for a UALink-based network may perform data reduction with format conversion, receive data in one floating-point format, and return the reduced result in a different floating-point format. The input datatype and the output datatype may be independently configurable per collective request, enabling the requesting accelerator to select the optimal precision trade-off for each operation. For example, the switch may receive data in a compressed 8-bit floating-point format, perform reduction at a higher intermediate precision to preserve numerical accuracy, and return the result in either the original compressed format or the higher-precision format depending on the downstream requirements. This per-request format conversion may be particularly useful for AI training workloads that use mixed-precision strategies, where different phases of the training step may require different precision configurations. The circuit performing the format conversion and reduction may include precision conversion stages, an arithmetic unit, and rounding logic, all configurable per request.

In various implementations, a switch for an Ultra Accelerator Link (UALink)-based network, comprising: a plurality of UALink-based ports; and a circuit configured to: receive a collective request specifying an input datatype and an output datatype; receive data in the input datatype from a plurality of accelerators; perform a reduction operation on the received data; convert a result of the reduction operation to the output datatype; and return the converted result to a requesting accelerator; wherein the input datatype and the output datatype are independently configurable per collective request. The circuit may support format conversion between any combination of the supported datatypes, including conversions between different floating-point precisions (such as from E4M3 to FP16), between floating-point and integer formats, or between formats of the same precision but different representations (such as from E5M2 to E4M3). The independent configurability may allow the requesting accelerator to select the input datatype based on the format of the data stored in accelerator memory and the output datatype based on the precision requirements of the downstream computation. When the input and output datatypes are the same, the circuit may perform the reduction without format conversion. The per-request configurability may be achieved through encodings carried in the collective request that specify both the input and output datatype as part of a combined reduction operation and datatype field.

In some implementations of the switch, the circuit comprises a pipeline having: a first stage that converts input data from the input datatype to an intermediate precision having higher precision than the input datatype; a second stage that performs the reduction operation at the intermediate precision; and a third stage that converts the result from the intermediate precision to the output datatype. The three-stage pipeline may prevent precision loss that would occur if the reduction were performed directly in the compressed input format. By upconverting to the intermediate precision before accumulation, the circuit may preserve numerical accuracy across many addition operations. The third stage may apply the specified rounding mode when downconverting from the intermediate precision to the output datatype.

In some implementations of the switch, the input datatype, the intermediate precision, and the output datatype comprise at least one of: E4M3 input with FP16 intermediate and E4M3 output, E5M2 input with FP32 intermediate and E5M2 output, E4M3 input with BF16 intermediate and BF16 output, or FP16 input with FP32 intermediate and FP32 output. Each combination may be selected based on the precision requirements and bandwidth constraints of the AI workload. The E4M3 with FP16 intermediate combination may offer a balance between bandwidth reduction and precision for inference workloads, while the E5M2 with FP32 intermediate combination may provide higher precision for training workloads.

In some implementations of the switch, the input datatype, the output datatype, and the reduction operation are encoded in a combined encoding field, the encoding field carried in a source identifier field of the collective request for collective primitive operations and in a reduction operation field within a control block for block collective operations. The combined encoding may define a mapping where each encoding value specifies the full combination of reduction operation, input datatype, optional intermediate precision, and output datatype. This compact encoding may allow the switch to decode all arithmetic parameters from a single field without requiring multiple separate configuration fields.

In some implementations of the switch, during inference of a quantized AI model, the circuit receives data in the E4M3 or E5M2 input datatype from accelerators executing quantized model layers, performs the reduction operation at the intermediate precision, and returns the result in the output datatype. Quantized AI models may use FP8 representations for weights and activations to reduce memory footprint and bandwidth. The intermediate-precision reduction may allow the switch to combine quantized values with higher arithmetic accuracy than would be possible with direct FP8 arithmetic.

In some implementations of the switch, different collective requests within a same training step of an AI model specify different combinations of input and output datatypes, the combinations selected based on numerical requirements of different phases of the training step. A training step may include multiple phases with different precision requirements. For example, gradient accumulation may use FP16 input with FP32 intermediate computation, while model parameter updates may use BF16. The per-request configurability may allow the training framework to select the optimal precision for each phase without reconfiguring the switch between phases.

In some implementations of the switch, the circuit further comprises built-in self-test logic configured to verify correctness of the reduction operation across a range of datatypes and operations. The built-in self-test logic may execute a predefined set of test vectors covering representative datatypes and operations, and may compare the results against expected values to detect hardware faults in the arithmetic unit. The self-test may be triggered during switch initialization, periodically during operation, or on demand via the management interface.

FIG. 21B illustrates a method for performing data reduction with format conversion in a UALink-based network, comprising the switch receiving data in one datatype and returning the reduced result in a different datatype, with both datatypes specified per collective request. The method may include an optional intermediate precision conversion step where the received data is upconverted to a higher precision before reduction to preserve numerical accuracy. This method may be used in AI training and inference workloads where the data stored in accelerator memory is in a compressed format but the arithmetic computation benefits from higher-precision intermediate representation.

In various implementations, a method for performing data reduction with format conversion in an Ultra Accelerator Link (UALink)-based network, comprising: receiving, at a switch via a UALink-based port, a collective request specifying an input datatype and an output datatype; receiving data in the input datatype from a plurality of accelerators; performing a reduction operation on the received data; converting a result of the reduction operation to the output datatype; and returning the converted result to a requesting accelerator. The method may be performed by the switch each time a collective request specifying different input and output datatypes arrives. The format conversion may involve rounding, truncation, or precision extension depending on the relationship between the input and output datatypes. When the input and output datatypes are the same, the conversion step may be a pass-through operation. The method may be applicable to both collective primitive operations, where the datatype encoding is carried in a signal field of the request, and block collective operations, where the datatype encoding is carried in a control block.

In some implementations, the method further comprises converting the received data from the input datatype to an intermediate precision having higher precision than the input datatype before performing the reduction operation; and performing the reduction operation at the intermediate precision. The intermediate precision conversion may prevent the accumulation of rounding errors that would occur if the reduction were performed directly in the compressed input datatype. The reduction at the intermediate precision may maintain higher numerical accuracy across many accumulation steps, with the final conversion to the output datatype applying the specified rounding mode.

In some implementations of the method, an accelerator coupled to a host via Compute Express Link (CXL) maps tensor data in a first precision format from the host to the collective request specifying a different input datatype, performing implicit precision conversion at a protocol boundary. The protocol boundary between CXL and UALink may serve as a natural point for precision conversion, where tensor data stored in the host's memory in one precision format may be mapped to a different precision for the collective operation. This may enable the host and the accelerators to use different precision strategies without requiring explicit data conversion steps in software.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

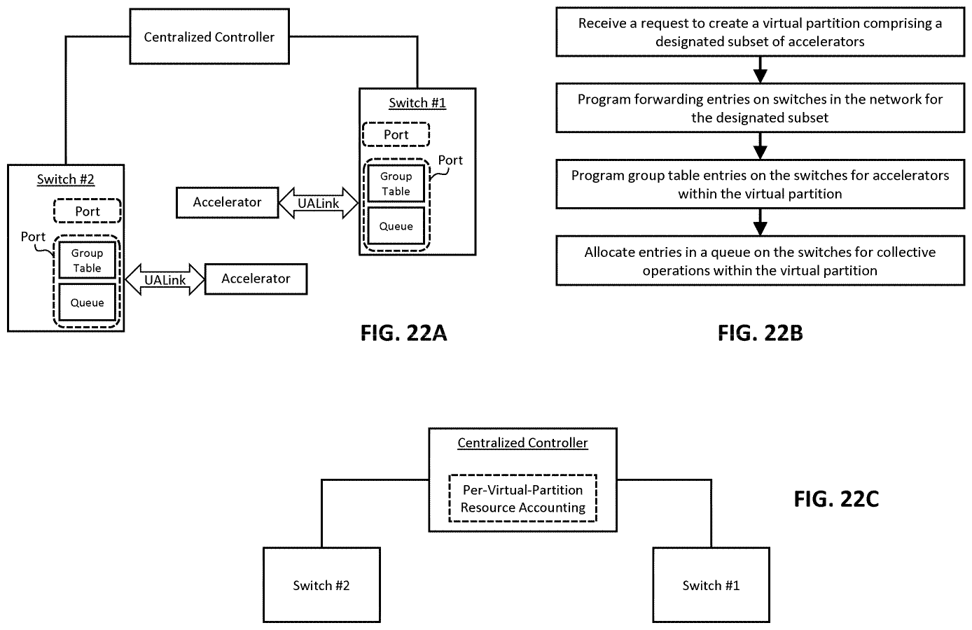

FIG. 22A illustrates a system for a UALink-based network that includes a centralized controller that integrates collective operation resource allocation into the virtual partition lifecycle. When the centralized controller creates a virtual partition for a tenant, it may program forwarding entries on the switches to establish routing paths for the designated accelerators, and then program group table entries and allocate queue entries for collective operations within the virtual partition. The ordering may be significant: group table entries may be programmed after forwarding entries because replicated collective requests generated by the switches need established routes to reach destination accelerators. The virtual partition may be a virtual pod comprising a non-overlapping subset of accelerators within a pod that may communicate amongst themselves but not with accelerators outside the subset. The virtual partition may be assigned to a single tenant, and the switches may enforce traffic isolation between virtual partitions by partitioning switch ports into non-overlapping subsets. The centralized controller may create and tear down virtual partitions independently without affecting other active virtual partitions.

In various implementations, a system for an Ultra Accelerator Link (UALink)-based network, comprising: switches, each switch comprising UALink-based ports, each port comprising a group table and a queue for collective operations; and a centralized controller coupled to the switches via an out-of-band management interface; wherein the centralized controller is configured to, upon creating a virtual partition comprising a designated subset of accelerators: program forwarding entries on the switches for the designated subset; after the forwarding entries are installed, program group table entries on the switches for accelerators within the virtual partition; and allocate entries in the queue on the switches for collective operations within the virtual partition. The centralized controller may receive the virtual partition creation request from a workload orchestrator, an administrator, or an automated provisioning system. The forwarding entries may restrict traffic within the switches to the designated subset of accelerators, establishing routing paths that enable the accelerators to communicate. The group table entries may map group identifiers to bitmasks identifying groups of accelerators within the designated subset, enabling the switches to perform in-network collective operations for the virtual partition. The queue entries may store parameters for offloaded collective operations, enabling the switches to generate memory access requests for collective data reduction. Programming the group table entries after the forwarding entries may prevent a situation where the switch activates a collective group but lacks the route table entries needed to deliver replicated requests to destination accelerators. The centralized controller may program group table entries and allocate queue entries on each port of each switch that serves the virtual partition.

In some implementations of the system, the centralized controller is further configured to, upon tearing down the virtual partition: deactivate the group table entries and deallocate the entries in the queue for the virtual partition; and after the group table entries are deactivated and the queue entries are deallocated, remove the forwarding entries for the virtual partition from the switches. The reverse ordering on teardown may prevent in-flight collective operations from generating replicated requests that have no routes. Deactivating group table entries first may cause any new collective request for the virtual partition to receive a target abort response, halting new collectives. After deactivation and deallocation, the centralized controller may safely remove the forwarding entries without risking orphaned collective traffic.

In some implementations of the system, deactivating the group table entries comprises clearing a valid indicator of each group table entry for the virtual partition on each switch, and the centralized controller waits for outstanding collective operations associated with the virtual partition to complete before removing the forwarding entries. Waiting for outstanding collective operations to complete may prevent loss of in-flight collective data. The centralized controller may poll for completion or may receive completion notifications from the switches before proceeding with forwarding entry removal.

In some implementations of the system, the centralized controller further enables switch ports associated with the designated subset of accelerators to carry transactions after the forwarding entries are installed and the group table entries are programmed and the queue entries are allocated. Enabling the switch ports after all resources are in place may prevent transactions from flowing before the collective operation infrastructure is ready, avoiding failures when an accelerator issues a collective request before the group table entries are active.

In some implementations of the system, the group table entries each comprise a valid indicator and a bitmask identifying a group of accelerators within the designated subset, and the centralized controller programs the group table entries on each port of each switch that serves the virtual partition. The bitmask may have a width equal to the radix of the switch, with each bit position corresponding to a physical accelerator identifier. Programming group table entries on each port may enable collective operations regardless of which port the collective request arrives on.

In some implementations of the system, allocating entries in the queue comprises the centralized controller reserving queue partitions on ports of the switches for the virtual partition, each queue partition identified by a queue partition identifier. The queue partition may be a submission queue within a per-port control block queue on the switch. Each queue partition may be dynamically allocated a number of entries for storing collective operation parameters, and the queue partition identifier may be encoded in an address field of an allocation request.

In some implementations of the system, the centralized controller receives a request from a workload orchestrator to create the virtual partition, the request specifying a number of accelerators and collective operation resource requirements comprising a number of collective groups and a queue capacity, and the centralized controller allocates group table entries and queue entries according to the collective operation resource requirements. The workload orchestrator may specify collective operation resource requirements based on the AI training framework's communication patterns. A data-parallel training workload may require group table entries for gradient all-reduce groups and queue entries for pipelined block collective operations.

In some implementations of the system, upon adding an accelerator to the virtual partition, the centralized controller updates group table bitmasks on the switches to include the added accelerator; and upon removing an accelerator from the virtual partition, the centralized controller updates group table bitmasks to exclude the removed accelerator and verifies that no outstanding collective operations reference the removed accelerator. Updating group table bitmasks when accelerators are added or removed may maintain consistency between the virtual partition membership and the collective group membership, preventing collective operations from targeting accelerators that are no longer part of the virtual partition.

In some implementations of the system, programming group table entries on the switches comprises: programming the group table entries with a valid indicator cleared on each switch; verifying consistency of the programmed entries across the switches; and upon successful verification, setting the valid indicator on each switch to activate the group table entries. Programming with the valid indicator cleared may prevent accelerators from issuing collective requests before all switches have consistent entries. Verifying consistency may detect programming errors or communication failures. Setting the valid indicator after verification may provide a coordinated activation point across all switches.

FIG. 22B illustrates a method for creating a virtual partition with collective operation resources comprising a centralized controller programming forwarding entries, then programming group table entries, and then allocating queue entries for a virtual partition. This sequenced approach may provide that routing paths are established before collective operation resources are activated, and that collective operation resources are deactivated before routing paths are removed during teardown.

In various implementations, a method for creating a virtual partition with collective operation resources in an Ultra Accelerator Link (UALink)-based network, comprising: receiving, at a centralized controller, a request to create a virtual partition comprising a designated subset of accelerators; programming, by the centralized controller, forwarding entries on switches in the network for the designated subset; after the forwarding entries are installed, programming, by the centralized controller, group table entries on the switches for accelerators within the virtual partition; and allocating, by the centralized controller, entries in a queue on the switches for collective operations within the virtual partition. The method may be performed as part of an automated provisioning workflow triggered by a workload orchestrator or administrator. The forwarding entries may establish routing paths between accelerators in the designated subset. The group table entries may enable in-network collective operations for the virtual partition. The queue entries may enable offloaded collective operations where the switch, possibly autonomously, generates memory access requests.

In some implementations, the method further comprises tearing down the virtual partition by: deactivating the group table entries and deallocating the entries in the queue for the virtual partition; and after the group table entries are deactivated and the queue entries are deallocated, removing the forwarding entries for the virtual partition from the switches. The reverse ordering on teardown may mirror the creation ordering: collective operation resources are released before routing paths are removed, preventing orphaned collective traffic from traversing routes that are about to be deleted.

In some implementations of the method, the centralized controller performs concurrent virtual partition operations comprising creating a first virtual partition and tearing down a second virtual partition, and the group table entries and queue entries for the first virtual partition are isolated from the group table entries and queue entries for the second virtual partition. Isolating INC resources between concurrent virtual partition operations may prevent teardown of one virtual partition from affecting collective operations in another virtual partition, even when both virtual partitions share ports on the same switches.

In some implementations of the method, after creating the virtual partition, the centralized controller pre-allocates group table entries for anticipated collective communication patterns comprising at least one of all-reduce, broadcast, or reduce, based on a workload type associated with the virtual partition. Pre-allocating group table entries for anticipated patterns may reduce the latency of the first collective operation issued by the tenant's training framework, because the group table entries are already programmed and activated when the framework issues its first collective request.

In some implementations, the method further comprises periodically auditing, by the centralized controller, group table entries and queue entries on the switches to detect entries not associated with any active virtual partition, and reclaiming the detected entries. Orphaned INC resources may result from incomplete teardown sequences, management communication failures, or software bugs. Periodic auditing may detect and reclaim these resources, preventing gradual resource exhaustion over time.

In some implementations of the method, a non-transitory computer-readable medium comprising instructions which, when executed by a processor, cause the processor to perform the method.

FIG. 22C illustrates a system for a UALink-based network that includes a centralized controller that maintains per-virtual-partition resource accounting for in-network collective operation resources and enforces per-virtual-partition quotas. Each switch port may have a finite number of group table entries and queue entries available for collective operations. In a multi-tenant deployment where multiple virtual partitions share the same physical switches, the centralized controller may track how many of these resources each virtual partition consumes and may enforce quotas to prevent one virtual partition from exhausting shared resources. The quotas may be configured based on workload type, tenant priority, or service-level agreements, and may be dynamically adjusted based on observed utilization.

In various implementations, a system for an Ultra Accelerator Link (UALink)-based network, comprising: switches, each switch comprising UALink-based ports, each port comprising a group table and a queue for collective operations; and a centralized controller coupled to the switches via an out-of-band management interface; wherein the centralized controller is configured to: maintain per-virtual-partition resource accounting comprising, for each virtual partition: a count of group table entries allocated to the virtual partition, and a count of queue entries allocated to the virtual partition; and enforce per-virtual-partition quotas by rejecting a request to allocate group table entries or queue entries for a virtual partition when the allocation would cause the count to exceed a configured quota for the virtual partition. The centralized controller may maintain the resource accounting in a database or data structure that tracks the allocation state of each group table entry and queue entry on each port of each switch, associating each allocated entry with the virtual partition that owns it. The quota enforcement may prevent a single tenant from consuming all available INC resources on shared switch ports, which would prevent other tenants from creating collective groups or submitting block collective operations. The rejection may return an error indication to the requesting entity, enabling the tenant's software to adjust its collective operation strategy.

In some implementations of the system, the configured quota is determined based on a workload type associated with the virtual partition, wherein a training workload type receives a higher quota for group table entries and queue entries than an inference workload type. Training workloads may require many concurrent collective groups for gradient synchronization across large numbers of accelerators, while inference workloads may require fewer collective groups. Allocating higher quotas to training workloads may reflect the higher INC resource consumption of training relative to inference.

In some implementations of the system, when the count of group table entries or queue entries for a virtual partition exceeds a configurable threshold below the configured quota, the centralized controller generates a notification to a workload management system indicating approaching resource exhaustion. The notification may enable the workload management system to take proactive action, such as consolidating collective groups, deallocating unused groups, or requesting additional resources, before the quota is reached and further allocations are rejected.

In some implementations of the system, the centralized controller exposes the per-virtual-partition resource accounting and the configured quotas as management data model attributes queryable via the out-of-band management interface. Exposing INC resource accounting and quotas as management data model attributes may enable operators, workload orchestrators, and monitoring systems to query the current allocation state and quota utilization for each virtual partition, supporting capacity planning and troubleshooting.

In some implementations of the system, upon creation of a new virtual partition, the centralized controller rebalances the configured quotas across all active virtual partitions to provide fair access to group table entries and queue entries across the switches. Rebalancing quotas upon new virtual partition creation may prevent a situation where early tenants receive large quotas and later tenants receive minimal allocations because the capacity was already committed. The rebalancing may be weighted by tenant priority or workload type.

### IC Pair 1—System: Multi-switch Group Table Consistency Programming

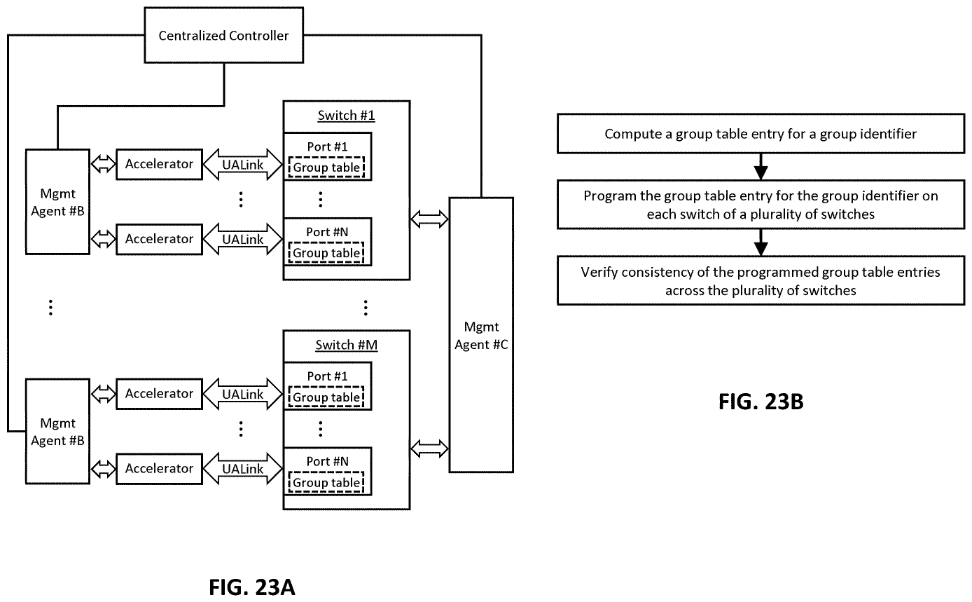

{SPEC: Intro} FIG. 23A illustrates a system for a UALink-based network comprising a centralized controller that programs group table entries across a plurality of switches to enable in-network collective operations spanning accelerators coupled to different switches. The centralized controller may compute the group table entry for a collective group, determining which accelerators are members of the group and encoding the membership in a bitmask. The centralized controller may then program the entry on each switch via an out-of-band management interface and verify that all switches have consistent entries before accelerators are permitted to issue collective requests using the group identifier. This multi-switch consistency programming may involve a management agent on each switch that receives the group table entry from the centralized controller and installs it on the switch hardware. The verification may detect programming errors, communication failures, or hardware faults that could result in inconsistent group membership across switches. The consistency programming protocol may be performed as part of the initial network configuration, during workload deployment, or dynamically during operation as collective groups are created, modified, or deleted.

In various implementations, a system for an Ultra Accelerator Link (UALink)-based network, comprising: a plurality of switches, each switch comprising a plurality of UALink-based ports, each port comprising a group table comprising entries, each entry comprising a valid indicator and a bitmask identifying a group of accelerators; and a centralized controller coupled to the plurality of switches via an out-of-band management interface; wherein the centralized controller is configured to: for a collective group comprising accelerators coupled to different switches of the plurality of switches, compute a group table entry for a group identifier, the group table entry comprising a bitmask identifying accelerators in the collective group; program the group table entry for the group identifier on each switch of the plurality of switches; and verify consistency of the programmed group table entries across the plurality of switches. The centralized controller may determine the membership of the collective group based on workload requirements, virtual partition allocation, or external input from a workload orchestrator. The bitmask may have a width equal to the radix of the switch, with each bit position corresponding to a physical accelerator identifier. The centralized controller may program the same bitmask on each switch, since each switch's route table handles the physical routing of replicated requests to destination accelerators regardless of which switch the destination accelerator is coupled to. The verification may include one or more mechanisms, such as read-back comparison, checksum verification, or acknowledgment-based confirmation. The system may support up to 1024 group identifiers per port and up to 1024 accelerators in the collective group. The centralized controller may be implemented as software executing on a dedicated server, a process on a management controller, or firmware on a baseboard management controller.

### Spec-Direct: Valid-Bit Gating. Three-Phase Protocol: Program With Valid=0, Verify, Set Valid=1. Uses the Existing Valid Indicator as a Gating Mechanism. Novelty: the Spec Defines the Valid Indicator but Does Not Define How it is Used During Multi-Switch Programming

In some implementations of the system, the centralized controller is configured to: program the group table entry on each switch with the valid indicator cleared; upon successful verification, set the valid indicator on each switch to activate the group identifier for collective operations. Programming the entry with the valid indicator cleared may prevent accelerators from issuing collective requests with the group identifier before all switches have been consistently programmed. Setting the valid indicator after verification may gate the activation of the group, providing a coordination point between the management plane and the data plane.

### Spec-Direct: Read-Back Verification. Controller Reads Back Entries From Each Switch and Compares. Novelty: No Read-Back Verification Mechanism is Defined for Group Tables

In some implementations of the system, the centralized controller verifies consistency by reading back the programmed group table entry from each switch via the out-of-band management interface and comparing the read-back bitmask against the expected bitmask for the collective group. The read-back verification may detect programming errors caused by communication failures, hardware faults, or firmware bugs on the switch. The centralized controller may maintain a reference copy of each group table entry and compare the read-back values against this reference.

### Inventive Twist: Forwarding Entry Ordering. Route Table Programmed Before Group Table. Novelty: the Spec Defines Forwarding Entry Programming and Group Table Programming Separately Without Specifying Ordering. The Ordering Dependency is a Natural Constraint: Replicated Requests From Group Table Lookups Must be Routable

In some implementations of the system, the centralized controller programs forwarding entries on each switch before programming the group table entries, such that replicated requests generated from the group table entries are routable via the forwarding entries. Programming forwarding entries before group table entries may prevent a situation where the switch activates a group identifier but lacks the route table entries needed to deliver replicated requests to destination accelerators. The centralized controller may perform group table programming as a final step after route table programming and verification.

### Inventive Twist: Error Recovery During Multi-Switch Programming. Reprogram and Re-Verify on Inconsistency; Deactivate on Unresolvable Failure. Novelty: Error Recovery During Group Table Programming is Not Specified

In some implementations of the system, upon detecting an inconsistency during verification, the centralized controller reprograms the affected switch and re-verifies; and upon failure to resolve the inconsistency, the centralized controller clears the valid indicator on all switches for the group identifier. Clearing the valid indicator on all switches upon unresolvable failure may prevent accelerators from issuing collective requests that would produce incorrect results due to inconsistent group membership across switches. The centralized controller may log the failure for diagnostic purposes and notify an operator.

### Inventive Twist: Virtual Partition Scoping. Group Table Entries Constrained Per Virtual Partition. Novelty: Virtual Partition Constraints on Group Table Programming are Not Specified

In some implementations of the system, the centralized controller programs the group table entries per virtual partition, verifying that the bitmask for the collective group references accelerators allocated to the virtual partition associated with the collective group. The virtual partition scoping may prevent the centralized controller from inadvertently programming a group table entry that references accelerators belonging to a different tenant, which could cause data leakage or interference between tenants' collective operations. In some examples, a virtual partition refers to a virtual pod.

### Inventive Twist: Management Agent Intermediary. The Controller Programs via SMA, Which Installs Via UALink-SAI. Captures the Actual Management Hierarchy. Novelty: the Management Path for Group Table Programming is Not Specified

In some implementations of the system, the centralized controller programs the group table entry on each switch via a management agent associated with the switch, the management agent installing the group table entry on the switch via a hardware abstraction interface. The management agent may receive the group table entry from the centralized controller via a management protocol and translate it into hardware-specific commands for the switch via a hardware abstraction interface. This may enable the centralized controller to program group tables on switches from different vendors using a uniform interface.

### Inventive Twist: Batch Programming. Multiple Group Identifiers Programmed in a Single Transaction. Novelty: Batch Group Table Programming is Not Specified

In some implementations of the system, the centralized controller programs group table entries for a plurality of group identifiers on each switch in a single programming transaction. Batch programming may reduce the number of management protocol transactions between the centralized controller and each switch, lowering the overall latency for configuring multiple collective groups. The centralized controller may verify consistency for all group identifiers in the batch before activating any of them.

### Inventive Twist: AI-Specific Gradient All-Reduce Group Programming. Novelty: the Spec Does Not Connect Group Table Programming to AI Training Workloads

In some implementations of the system, the collective group comprises accelerators executing a data-parallel training workload of an AI model, and the centralized controller programs group table entries for a gradient all-reduce collective operation across the plurality of switches. In data-parallel training, all participating accelerators may need to synchronize gradients via an all-reduce collective operation. The centralized controller may program group table entries that include all accelerators in the data-parallel training group, enabling the switches to perform in-network gradient reduction.

### Out-Of-Scope: Periodic Consistency Audit. Controller Periodically Reads and Verifies All Active Entries. Novelty: Periodic Auditing of Group Table Consistency is Not Specified

In some implementations of the system, the centralized controller periodically reads group table entries from each switch and verifies consistency against a reference copy maintained by the centralized controller, and upon detecting a discrepancy, reprograms the affected switch. Periodic auditing may detect silent corruption of group table entries caused by hardware faults such as memory bit flips, or configuration drift caused by firmware bugs. The audit interval may be configurable by an operator.

### IC Pair 1—Method: Parallel to System IC

{SPEC: Intro} FIG. 23B illustrates a method for programming consistent group table entries across switches in a UALink-based network, comprising the centralized controller computing the correct bitmask for each collective group, programming the entry on each switch, and verifying that all switches have consistent entries. The method may include a three-phase activation protocol that uses the valid indicator as a gating mechanism, group modification with deactivation and reactivation, group deletion, and pre-provisioning of backup entries for fast failover. The method may be performed as part of the initial network bring-up, during workload deployment, or dynamically during operation.

In various implementations, a method for programming consistent group table entries across switches in an Ultra Accelerator Link (UALink)-based network, comprising: for a collective group comprising accelerators coupled to different switches of a plurality of switches, computing, by a centralized controller, a group table entry for a group identifier, the group table entry comprising a bitmask identifying accelerators in the collective group; programming, by the centralized controller via an out-of-band management interface, the group table entry for the group identifier on each switch of the plurality of switches; and verifying, by the centralized controller, consistency of the programmed group table entries across the plurality of switches. The method may be triggered by a workload orchestrator requesting the creation of a collective group, by a training framework initiating a new collective communication pattern, or by the centralized controller as part of an automated network configuration process. The computing step may involve determining group membership from virtual partition assignments, workload requirements, or explicit group definitions. The programming step may involve transmitting the group table entry to each switch's management agent and waiting for acknowledgment. The verification step may involve reading back entries, comparing checksums, or other consistency checks.

### Inventive Twist: Three-Phase Activation Protocol as a Method Step

In some implementations of the method, programming comprises programming the group table entry on each switch with a valid indicator of the group table entry cleared; and further comprising, upon successful verification, setting the valid indicator on each switch to activate the group identifier for collective operations. The three-phase activation protocol may coordinate the transition from an inactive group (valid indicator cleared) to an active group (valid indicator set) across all switches, providing a consistent activation point that prevents accelerators from using the group identifier before all switches are ready.

### Inventive Twist: Group Modification Protocol. Deactivate, Reprogram, Re-Verify, Reactivate. In-Flight Collectives for Other Groups Unaffected. Novelty: Group Modification Protocol is not Specified

In some implementations, the method further comprises modifying the collective group by: clearing the valid indicator for the group identifier on each switch; reprogramming the bitmask on each switch to reflect modified group membership; verifying the reprogrammed bitmask on each switch; and setting the valid indicator on each switch to reactivate the group identifier. The modification protocol may be used to add or remove accelerators from an active collective group, such as when scaling an AI training workload up or down. Clearing the valid indicator before reprogramming may cause any in-flight collective request for that group identifier to receive a target abort response, while collective operations for other group identifiers remain unaffected.

### Out-Of-Scope: Hot-Standby Entries with Pre-Provisioned Failover Bitmasks. Novelty: Hot-Standby Group Table Entries are Not Specified

In some implementations, the method further comprises pre-provisioning, by the centralized controller, a backup group table entry for the group identifier on each switch, the backup entry comprising a bitmask with a replacement accelerator substituted for an accelerator in the collective group; and upon detecting failure of the accelerator, activating the backup entry on each switch. Pre-provisioning backup entries may enable fast failover when an accelerator fails, avoiding the latency of computing a new bitmask, programming all switches, and verifying consistency. The centralized controller may maintain backup entries for accelerators identified as high-risk based on health telemetry.

### Inventive Twist: Group Deletion Protocol. Deactivate All Entries, Clear Bitmasks, Release Group Identifier for Reuse. Novelty: Group Deletion is Not Specified

In some implementations, the method further comprises deleting the collective group by: clearing the valid indicator for the group identifier on each switch; clearing the bitmask on each switch; and releasing the group identifier for reuse. The deletion protocol may free group table entries for reuse by new collective groups. Clearing the bitmask after deactivation may prevent stale group membership from being inadvertently reactivated if the group identifier is later reassigned to a different collective group.

### Non-Transitory Medium Trailing Claim

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

### IC Pair 2—System: Topology-Aware Group Table Maintenance

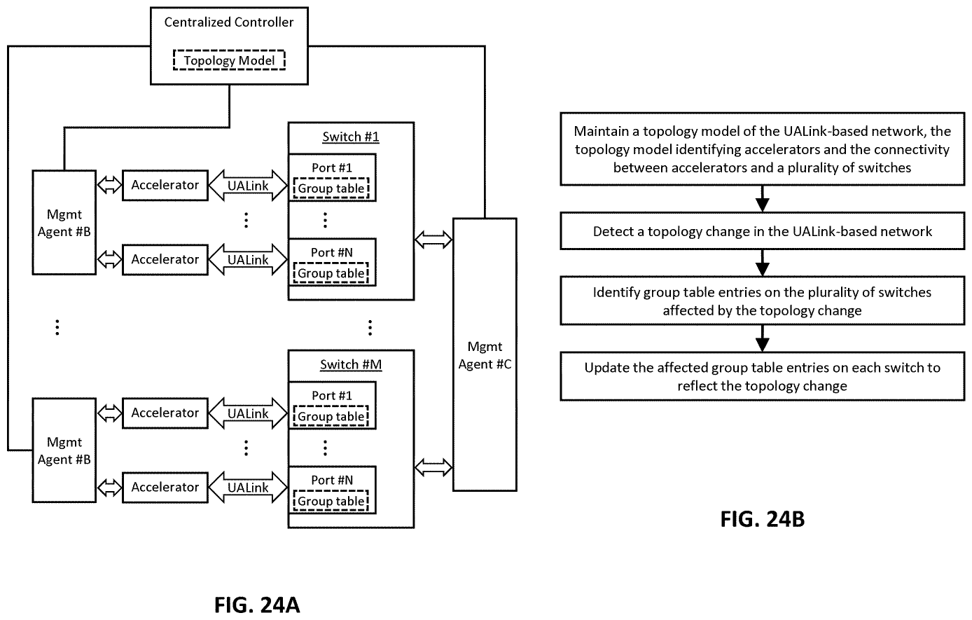

{SPEC: Intro} FIG. 24A illustrates a system for a UALink-based network comprising a centralized controller that automatically maintains group table entries in response to topology changes in the network. The centralized controller may maintain a topology model representing the current connectivity between accelerators and switches, and may update this model when events such as link failures, accelerator failures, or administrative port state changes occur. When the topology model changes, the centralized controller may identify which group table entries are affected by the change and update those entries on each switch to reflect the new topology. This automatic maintenance may prevent collective operations from failing due to stale group table entries that reference accelerators that are no longer reachable, and may enable the network to adapt to failures without manual intervention.

In various implementations, a system for an Ultra Accelerator Link (UALink)-based network, comprising: a plurality of switches, each switch comprising a plurality of UALink-based ports, each port comprising a group table comprising entries, each entry comprising a valid indicator and a bitmask; and a centralized controller coupled to the plurality of switches via an out-of-band management interface; wherein the centralized controller is configured to: maintain a topology model of the UALink-based network, the topology model identifying accelerators and the connectivity between accelerators and the plurality of switches; upon detecting a topology change in the UALink-based network, identify group table entries affected by the topology change; and update the affected group table entries on each switch of the plurality of switches to reflect the topology change. The topology model may represent the physical connectivity between accelerators and switch ports, the link state of each connection, and the reachability of each accelerator from each switch. The centralized controller may build the topology model during initial network bring-up and maintain it by processing state change notifications from management agents. The identification of affected group table entries may involve searching all active group table entries for those whose bitmask includes an accelerator affected by the topology change. The update may involve modifying the bitmask, clearing the valid indicator, or deleting the entry depending on the nature and severity of the topology change.

### Spec-Direct: Topology Change Types. Link Failure, Accelerator Failure, Administrative Port State Changes. These Events are Defined in the Manageability Spec but Not Connected to Group Table Maintenance. Novelty: This Connection is Not Specified

In some implementations of the system, the topology change comprises at least one of: a link failure between an accelerator and a switch, an accelerator failure, or an administrative change to a port state on one of the plurality of switches. A link failure may render an accelerator unreachable from one or more switches. An accelerator failure may remove an accelerator from all collective groups. An administrative port state change may intentionally take a port offline for maintenance, requiring affected group table entries to be updated.

### Inventive Twist: Deactivate-Update-Reactivate for Topology Changes. Clear Valid, Update Bitmask, Verify, Set Valid. Novelty: This Coordination Between Topology Events and Group Table State is Not Specified

In some implementations of the system, the centralized controller is configured to: upon detecting the topology change, clear the valid indicator of the affected group table entries on each switch; update the bitmask of the affected entries to remove an accelerator that is no longer reachable; verify the updated entries; and set the valid indicator on each switch to reactivate the affected group identifiers. Clearing the valid indicator before updating the bitmask may cause any in-flight collective request for the affected group to receive a target abort response, which the requesting accelerator's software may handle as a retriable error. Reactivating after verification may allow collective operations to resume with the corrected group membership.

### Inventive Twist: Cascading Removal From All Groups. When an Accelerator Fails, the Controller Identifies ALL Group Table Entries Across ALL Switches that Include the Failed Accelerator and Removes it From All Of Them. Novelty: Cascading Updates Triggered by a Single Failure are Not Specified

In some implementations of the system, upon detecting failure of an accelerator, the centralized controller identifies all group table entries across the plurality of switches that include the failed accelerator in their bitmask, and removes the failed accelerator from all identified entries. An accelerator may be a member of multiple collective groups simultaneously, such as a gradient all-reduce group and a model broadcast group. Removing the failed accelerator from all groups may prevent multiple concurrent collective operations from timing out on the failed accelerator.

### Inventive Twist: Forwarding Entry and Group Table Coordinated Update. When Topology Changes Cause Route Table Updates, the Controller Also Checks Group Table Routability. Novelty: Coordinated Route/Group Table Updates Not Specified

In some implementations of the system, upon detecting the topology change, the centralized controller updates forwarding entries on the plurality of switches to reflect the changed topology, and further verifies that replicated requests generated from the affected group table entries remain routable via the updated forwarding entries. The coordinated update may prevent a situation where the forwarding entries are updated to remove a path but the group table still directs replicated requests along that path. The centralized controller may perform route table updates first and group table updates second, consistent with the ordering dependency for initial programming.

### Inventive Twist: AI Dynamic Training Reconfiguration. Topology Change Triggers Notification to Workload Management for AI Training Adjustment. Novelty: the Spec Does Not Connect Topology Changes to AI Workload Management

In some implementations of the system, upon detecting the topology change, the centralized controller further notifies a workload management system that a collective group has been modified, enabling the workload management system to reconfigure an AI training workload to operate with the modified group membership. The workload management system may reconfigure a data-parallel training workload to redistribute data partitions across the remaining accelerators, or may pause training and checkpoint the model state before reconfiguration.

### Spec-Direct: Asynchronous Notifications from Management Agents. The Management Agent on Each Switch Notifies the Controller of Port State Changes. Novelty: the Manageability Spec Defines Async Notifications but Does Not Connect Them to Group Table Maintenance

In some implementations of the system, a management agent on each switch transmits asynchronous notifications to the centralized controller upon detecting a port state change, and the centralized controller processes the notifications to update the topology model and trigger group table updates. The asynchronous notifications may enable the centralized controller to respond to topology changes in near real-time without polling. The management agent may generate notifications for link-up, link-down, and administrative state change events.

### Inventive Twist: Cross-Virtual-Partition Topology Impact. A Topology Change Affecting a Shared Link or Switch May Impact Group Tables in Multiple Virtual Partitions. The Controller Updates All Affected Virtual Partitions While Maintaining Isolation. Novelty: Cross-Virtual-Partition Group Table Maintenance is Not Specified

In some implementations of the system, the topology change affects accelerators in a plurality of virtual partitions, and the centralized controller updates group table entries in each affected virtual partition independently while maintaining isolation between virtual partitions. A single link failure may affect accelerators assigned to different tenants. The centralized controller may update group table entries for each affected virtual partition without exposing group membership information across virtual partition boundaries.

### IC Pair 2—Method: Parallel to System IC

{SPEC: Intro} FIG. 24B illustrates a method for maintaining group table consistency in response to topology changes in a UALink-based network, comprising a centralized controller detecting topology events, identifying affected group table entries, and updating the entries to maintain consistency between group membership and network reachability. The method may include pre-activation topology validation to prevent activation of groups with unreachable members, and event logging for diagnostic and compliance purposes.

In various implementations, a method for maintaining group table consistency in response to topology changes in an Ultra Accelerator Link (UALink)-based network, comprising: maintaining, by a centralized controller, a topology model of the UALink-based network, the topology model identifying accelerators and the connectivity between accelerators and a plurality of switches; detecting a topology change in the UALink-based network; identifying group table entries on the plurality of switches affected by the topology change; and updating the affected group table entries on each switch to reflect the topology change. The method may be event-driven, triggered by notifications from management agents on the switches, or may be discovery-driven, triggered by the centralized controller detecting connectivity changes during periodic polling. The identification step may involve scanning a database of active group table entries maintained by the centralized controller, comparing each entry's bitmask against the affected accelerators or links. The updating step may involve modifying bitmasks, deactivating and reactivating entries, or deleting entries that no longer have viable membership.

### Inventive Twist: Pre-Activation Topology Validation. Before Activating Any Group, the Controller Validates That All Members are Reachable From All Switches. Novelty: Pre-Activation Topology Validation is Not Specified

In some implementations, the method further comprises before activating a group identifier for collective operations, validating that all accelerators identified in the bitmask of the group table entry are reachable from each switch based on the topology model. The pre-activation validation may detect situations where an accelerator is included in a collective group but is not reachable from one or more switches due to a topology condition that occurred between group programming and activation. This may prevent collective operations from failing immediately upon activation.

### Out-Of-Scope: Group Table Event Logging for Audit Trail. Novelty: Group Table Audit Logging is Not Specified

In some implementations, the method further comprises logging, by the centralized controller, each update to the group table entries with a timestamp, the group identifier, the topology change that triggered the update, and the updated bitmask. The event log may provide an audit trail for diagnostic purposes, enabling operators to trace the history of group table changes and correlate them with topology events. The log may also serve compliance requirements for systems that maintain records of configuration changes.

### Non-Transitory Medium Trailing Claim

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

### Selective Crypto Bypass at the Switch—System IC1

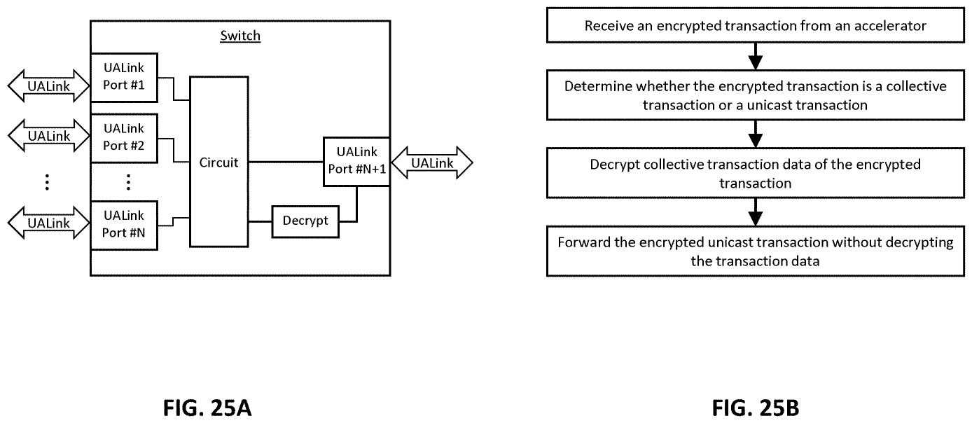

{SPEC: Intro} FIG. 25A illustrates a switch supporting both collective operations and unicast operations. Collective operations, such as reduction, multicast, and broadcast, involve data from multiple accelerators and may require the switch to inspect, process, or combine the data payloads. Unicast operations involve communication between a pair of accelerators and do not require the switch to access the data payload. When encryption is enabled on the links between accelerators and the switch, the switch may need to selectively decrypt collective transaction data to perform operations such as arithmetic reduction, while bypassing decryption for unicast transactions so that the data remains encrypted end-to-end between the source and destination accelerators. A circuit at the switch may determine whether each incoming encrypted transaction is a collective transaction or a unicast transaction by inspecting a command type field for incoming requests or a response type information field for incoming responses. The command type field may identify specific collective commands, such as ReadReduce, WriteMulticast, WriteFullMulticast, AtomicNRMulticast, BlockCollectiveInvoke, BlockCollectiveAllocate, or BlockCollectiveDeallocate. The response type information field may indicate whether the response corresponds to a collective primitive, a block collective, or a unicast transaction. When the transaction is identified as collective, the circuit may decrypt the data for processing. When the transaction is identified as unicast, the circuit may bypass the decryption path and forward the encrypted transaction to the destination port, preserving end-to-end encryption between accelerators. This selective approach enables the switch to participate in collective computations while maintaining data confidentiality for unicast traffic, supporting confidential computing in multi-tenant accelerator deployments.

In various implementations, a switch for an Ultra Accelerator Link (UALink)-based network, comprising: a plurality of ports, each port coupled to an accelerator via a UALink-based link; and a circuit configured to: determine, for an encrypted transaction received on a port of the plurality of ports, whether the encrypted transaction is a collective transaction or a unicast transaction, based on at least one of: a command type field of the encrypted transaction, or a response type information field of the encrypted transaction; decrypt transaction data of the encrypted transaction when the encrypted transaction is the collective transaction; and bypass decryption of the transaction data when the encrypted transaction is the unicast transaction, wherein the transaction data remains encrypted as the encrypted transaction is forwarded through the switch to a destination port of the plurality of ports. The circuit may operate on each incoming transaction independently, evaluating the command type field or the response type information field to make a per-transaction decision on whether to decrypt or bypass. For incoming requests from an accelerator, the circuit may inspect the command type field to identify collective commands that carry data requiring in-network processing. For incoming responses from an accelerator, the circuit may inspect the response type information field to identify responses to collective operations that carry data requiring reduction or aggregation at the switch. When decryption is bypassed, the encrypted transaction may traverse the switch core through the forwarding path without the circuit performing any cryptographic operations on the transaction data, and the transaction may be forwarded to the destination port determined by a destination accelerator identifier carried in the transaction. The circuit may utilize AES-GCM with 256-bit encryption keys and may support authentication tag verification when authentication is enabled. The circuit may be implemented in hardware as dedicated cryptographic logic, a programmable state machine, or a combination thereof. The method may be implemented in hardware, firmware, software, or combinations thereof, and may be performed by various types of devices including a switch, a processor, or a semiconductor device.

{Unpublished spec: Request detection via ReqCmd for collective primitives and block collectives} {Reason: Locks down the specific UPLI command types that trigger decryption at the Switch ingress for incoming requests from accelerators. These are the only commands that carry collective data requiring reduction or multicast processing.}

In some implementations of the switch, for incoming requests from an accelerator, the circuit is configured to determine that the encrypted transaction is the collective transaction based on the command type field indicating at least one of: a ReadReduce command, a WriteMulticast command, a WriteFullMulticast command, an AtomicNRMulticast command, a BlockCollectiveInvoke command, a BlockCollectiveAllocate command, or a BlockCollectiveDeallocate command. The ReadReduce command may perform a reduction operation across multiple accelerators, the WriteMulticast and WriteFullMulticast commands may distribute data to multiple accelerators, the AtomicNRMulticast command may perform atomic operations across multiple accelerators, and the BlockCollectiveInvoke, BlockCollectiveAllocate, and BlockCollectiveDeallocate commands may manage block collective operations at the switch. {Unpublished spec: Response detection via RdRspTypeInfo/WrRspTypeInfo} {NOVELTY: The Switch receives responses from Accelerators (e.g., after replicating a ReadReduce to multiple ranks) and determines from the RESPONSE alone whether to decrypt for reduction-without maintaining request tracking state. The destination Accelerator (Completer) retains whether the original request was collective or unicast, and sets the response type information field accordingly. This enables stateless response-path classification at the Switch.} {Reason: Covers the response-path detection, which is distinct from request-path detection in claim 2.}

In some implementations of the switch, for incoming responses from an accelerator, the circuit is configured to determine that the encrypted transaction is the collective transaction based on the response type information field of the incoming response indicating a collective primitive type or a block collective type. The response type information field may be a multi-bit field carried in the response header. The destination accelerator that generated the response may retain the type of the original request and set the response type information field accordingly, enabling the switch to classify the response without maintaining state tracking the original request.

{Unpublished spec: Specific response type information field values} {Reason: Narrows claim 3 to the specific TypeInfo value-to-command mappings from the unpublished spec.}

In some implementations of the switch, the response type information field indicates the collective primitive type when the incoming response corresponds to a ReadReduce command, a WriteMulticast command, a WriteFullMulticast command, or an AtomicNRMulticast command, and indicates the block collective type when the incoming response corresponds to a BlockRead command or a BlockWriteFull command. The collective primitive type may correspond to responses generated by destination accelerators in reply to collective primitive commands that the switch replicated to each participating accelerator. The block collective type may correspond to responses generated in reply to commands issued by the switch on behalf of a block collective operation.

{Inventive twist: Decrypt-reduce-re-encrypt pipeline at the Switch} {NOVELTY: After the Switch decrypts collective response data, it performs a reduction operation, then RE-ENCRYPTS the reduced result before sending to the requesting Accelerator. The re-encryption uses switch-to-accelerator encryption keys (not accelerator-to-accelerator keys). This three-stage pipeline (decrypt with Acc-to-Switch key, reduce, re-encrypt with Switch-to-Acc key) is novel.} {Reason: Covers the complete data flow through the Switch for collective operations. Any INC Switch with encryption must implement this pipeline.}

In some implementations, the switch further comprises a second circuit configured to perform a reduction operation on decrypted transaction data from the collective transaction; wherein after the reduction operation, the circuit is configured to re-encrypt reduced data using encryption keys for a switch-to-accelerator direction before sending the reduced data to a requesting accelerator. The second circuit may perform arithmetic or logical reduction operations, such as summation, maximum, minimum, or bitwise operations, on data received from multiple accelerators. The encryption keys for the switch-to-accelerator direction may be derived from master keys programmed by trusted software and may be different from the encryption keys for the accelerator-to-switch direction on the same link. The requesting accelerator may identify the response as switch-originated based on a command type field or a response type information field, and may select the appropriate switch-to-accelerator decryption keys.

{Inventive twist: Concurrent trusted and untrusted virtual partitions on the same switch} {NOVELTY: The same physical Switch simultaneously serves multiple virtual partitions. In a first virtual partition with collective security enabled, the Switch is within the trusted computing base and decrypts collective traffic. In a second virtual partition without collective security, the Switch remains outside the trusted computing base. Cryptographic isolation between virtual partitions prevents cross-tenant key leakage. This dual-security-domain architecture within a single physical Switch is unprecedented.} {Reason: Multi-tenant deployment of INC-capable switches. Any cloud provider with multi-tenant AI clusters will implement this.}

In some implementations of the switch, the switch simultaneously serves a plurality of virtual partitions, a first virtual partition of the plurality of virtual partitions having collective security enabled wherein the switch is within a trusted computing base of the first virtual partition, and a second virtual partition of the plurality of virtual partitions not having collective security enabled wherein the switch is outside a trusted computing base of the second virtual partition, with cryptographic isolation between the first virtual partition and the second virtual partition. The cryptographic isolation may be provided by separate sets of encryption keys for each virtual partition, derived from different master keys programmed by different tenants. Traffic belonging to one virtual partition may not be decryptable using the keys of another virtual partition. The switch may maintain per-virtual-partition configuration indicating whether collective security is enabled, and may apply the appropriate cryptographic processing policy for each incoming transaction based on the virtual partition membership of the source accelerator. In some examples, a virtual partition refers to a virtual pod.

{Spec-direct: Port encryption engine narrowing with key association} {Reason: Narrows the general “circuit” to the spec term “port encryption engine.” Does NOT specify per-port association-the circuit may include one or more port encryption engines that serve one or more ports.}

In some implementations of the switch, the circuit comprises at least one port encryption engine, each port encryption engine comprising at least one key association and encryption and decryption capability. The port encryption engine may maintain key associations that bind an encryption key, an initialization vector or counter, and other cryptographic parameters to a specific link direction and stream. The encryption and decryption capability may support AES-GCM at line rate.

{Inventive twist: Data integrity recalculation after reduction} {NOVELTY: After decrypting collective data, performing reduction, and before re-encrypting, the Switch recalculates a data integrity check on the reduced data. This is necessary because the original integrity check covered the pre-reduction data from each individual Accelerator, and the reduced data is a new value that needs its own integrity protection. This covers end-to-end data integrity across the decrypt-reduce-re-encrypt pipeline.} {Reason: Reasonable implementation for any INC Switch with security. If the Switch performs reduction and re-encryption, it must also generate integrity protection for the new data.}

In some implementations of the switch, after decrypting the collective transaction data and performing the reduction operation, the second circuit is configured to recalculate a data integrity check on the reduced data before the circuit re-encrypts the reduced data. The data integrity check may include a cyclic redundancy check or other error detection code computed over the reduced data payload. Recalculating the data integrity check may provide end-to-end data integrity protection across the decrypt-reduce-re-encrypt pipeline, allowing the requesting accelerator to verify that the reduced data was not corrupted during processing at the switch.

{Spec-direct: Authentication tag verification at the Switch} {Reason: Covers the AES-GCM authentication tag verification step. When the Switch decrypts a collective transaction, it verifies the authentication tag to confirm data integrity and authenticity. Verification failure triggers dropping the transaction and signaling an integrity failure.}

In some implementations of the switch, the circuit is configured to, for the collective transaction, verify an authentication tag accompanying the encrypted transaction, and to drop the encrypted transaction and signal an integrity failure when verification of the authentication tag fails. The authentication tag may be carried in a dedicated portion of a transaction layer flit accompanying the encrypted transaction data. Verification of the authentication tag may confirm both the integrity and authenticity of the encrypted transaction data using the same AES-GCM computation that produces the decrypted output. Signaling the integrity failure may include notifying a security manager on the switch, which may take corrective action such as transitioning the affected virtual partition to a stop state.

{Inventive twist: Alternative virtual channel-based detection mechanism} {NOVELTY: Instead of (or in addition to) inspecting the command type or response type information field, the Switch can determine whether to decrypt or bypass based on the virtual channel identifier of the transaction. If collective traffic is assigned to a first virtual channel and unicast traffic to a second virtual channel, the circuit can use the virtual channel assignment as the classification signal. This provides a faster hardware classification path (simple VC comparison vs. command field decode).} {Reason: Covers an alternative implementation that is likely in practice when VC-based traffic classification is deployed. If collective and unicast traffic are already separated by VC, using the VC for crypto bypass classification is the obvious optimization.}

In some implementations of the switch, the circuit is further configured to determine whether the encrypted transaction is the collective transaction or the unicast transaction based on a virtual channel identifier of the encrypted transaction, wherein collective transactions are assigned to a first virtual channel and unicast transactions are assigned to a second virtual channel. When virtual channel-based traffic classification is deployed at the switch, the virtual channel identifier may provide a rapid classification signal for the circuit to determine the cryptographic processing mode. The virtual channel identifier may be inspected without decoding the full command type field, potentially reducing the classification latency. The virtual channel assignment may be determined by the source accelerator or by a traffic classification function at the switch ingress.

### Set 2: Method IC1—Selective Crypto Bypass

{SPEC: Intro} FIG. 25B illustrates a method for selectively processing encrypted transactions at a switch in an accelerator network, comprising classifying each incoming encrypted transaction as a collective transaction or a unicast transaction, and applying different cryptographic processing accordingly. The method may decrypt collective transaction data to enable in-network processing such as arithmetic reduction, while forwarding unicast transactions through the switch without decryption to maintain end-to-end encryption between the source and destination accelerators. By performing this per-transaction classification and selective decryption at the switch ingress, the method may enable the switch to participate in collective computations while preserving data confidentiality for unicast traffic.

In various implementations, a method comprising: receiving, at a switch in an Ultra Accelerator Link (UALink)-based network, an encrypted transaction from an accelerator via a UALink-based link; determining whether the encrypted transaction is a collective transaction or a unicast transaction, based on at least one of: a command type field of the encrypted transaction, or a response type information field of the encrypted transaction; when the encrypted transaction is the collective transaction, decrypting transaction data of the encrypted transaction; and when the encrypted transaction is the unicast transaction, forwarding the encrypted transaction through the switch without decrypting the transaction data. The determining may be performed at an ingress port of the switch upon receiving the encrypted transaction. For incoming requests from an accelerator, the command type field may identify collective commands such as ReadReduce, WriteMulticast, or BlockCollectiveInvoke, which carry data payloads that the switch may need to inspect or process. For incoming responses from an accelerator, the response type information field may indicate whether the response corresponds to a collective primitive or a block collective operation. When the encrypted transaction is the unicast transaction, the encrypted transaction may be forwarded based on a destination accelerator identifier carried in the transaction, and the transaction data may remain encrypted with accelerator-to-accelerator encryption keys that the switch does not possess. The method may be performed by a circuit at the switch that handles both the classification and the cryptographic operations.

### Method Parallel of System Claim 5: Decrypt-Reduce-Re-Encrypt Pipeline

In some implementations, the method further comprises performing a reduction operation on the decrypted transaction data; and re-encrypting reduced data using encryption keys for a switch-to-accelerator direction before sending the reduced data to a requesting accelerator. The reduction operation may combine data from multiple accelerators using arithmetic or logical operations. The encryption keys for the switch-to-accelerator direction may be different from the keys used for the accelerator-to-switch direction, providing directional key isolation on each link.

### Trailing: Non-Transitory Medium

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an apparatus configured to operate as a switch, wherein the apparatus comprises switching circuitry and is configured to perform the method.

### Set 3: System IC2—TCB Elevation Workflow

### System for Selective TCB Elevation of a Switch-System IC2

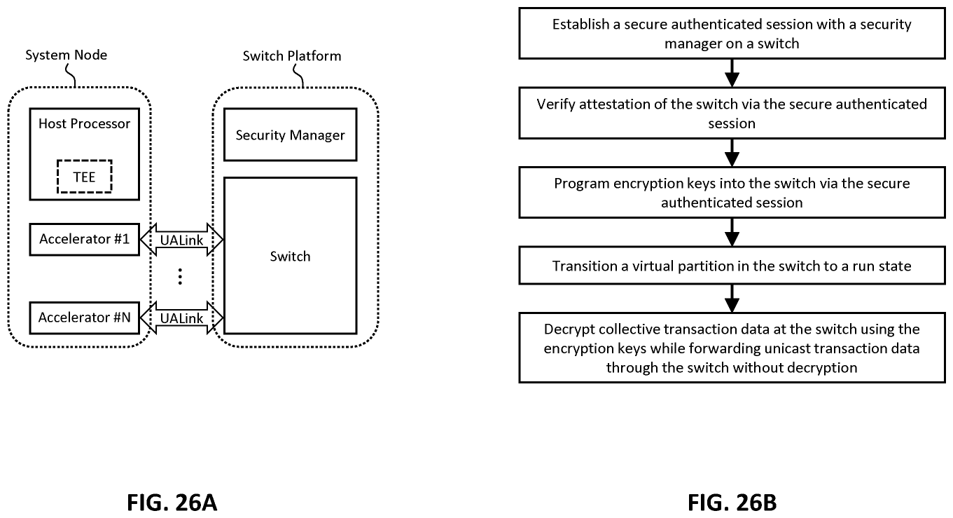

{SPEC: Intro} In accelerator network deployments where accelerators perform distributed workloads using collective operations, a switch may participate in collective computations by processing data as it traverses the switch. When encryption is enabled on the links between accelerators and the switch, the switch may need to decrypt collective data to perform operations such as arithmetic reduction. This requires the switch to be trusted with encryption keys and to be capable of handling unencrypted data, which may conflict with the security architecture if the switch is not within the trusted computing base. FIG. 26A illustrates a system that may provide a mechanism for trusted software on a host processor to selectively elevate the switch into the trusted computing base for collective operations of a specific virtual partition. The trusted software may establish a secure authenticated session with a security manager on the switch, verify the switch's attestation to confirm its identity and integrity, program collective encryption keys into the switch, and transition a virtual partition in the switch to a run state. During the run state, the switch may decrypt collective transaction data using the programmed encryption keys while forwarding unicast transaction data without decryption, maintaining end-to-end encryption for non-collective traffic. The security manager may manage the security lifecycle of the virtual partition through a state machine, and may respond to security events such as integrity failures by transitioning the virtual partition to a stop state. This approach may enable the switch to participate in collective computations for tenants that require in-network collective operations, while remaining outside the trusted computing base for tenants that do not, within the same physical switch hardware.

In various implementations, a system comprising: a plurality of accelerators; a switch for an Ultra Accelerator Link (UALink)-based network, the switch coupled to the plurality of accelerators via UALink-based links, the switch comprising a security manager; a host processor configured to execute trusted software; wherein the trusted software is configured to: establish a secure authenticated session with the security manager of the switch; verify attestation of the switch via the secure authenticated session; program encryption keys into the switch via the secure authenticated session; and transition a virtual partition in the switch to a run state; wherein during the run state, the switch is configured to decrypt collective transaction data using the encryption keys and forward unicast transaction data without decryption. The trusted software may be a trusted virtual machine (TVM) executing within a trusted execution environment (TEE) on the host processor, or may be other software executing in a secure context with access to cryptographic credentials. The security manager on the switch may be a firmware component that manages security policies for the switch and exposes an interface for trusted software to establish sessions, verify attestation, program keys, and control the security state of virtual partitions. The secure authenticated session may utilize cryptographic protocols to protect the confidentiality and integrity of communications between the trusted software and the security manager, preventing eavesdropping or tampering by the infrastructure provider or other untrusted entities. The secure authenticated session between the trusted software and the security manager may be established over a network connection between the system node hosting the host processor and the switch platform hosting the switch, such as a front end network used by operating system domains to establish tenant trusted computing bases, or a management network interface on the switch platform. The network connection for the secure authenticated session may be separate from the UALink-based links that carry collective and unicast transaction data between the accelerators and the switch. The attestation verification may confirm that the switch hardware and firmware have not been tampered with and are running authorized code, providing assurance that the switch is trustworthy before programming it with encryption keys. The encryption keys programmed into the switch may be collective master keys from which stream keys are derived for encrypting and decrypting collective traffic on each link. During the run state, the switch may utilize a circuit to determine whether each incoming transaction is a collective transaction or a unicast transaction, decrypting collective transaction data for in-network processing such as reduction, and forwarding unicast transaction data in encrypted form to preserve end-to-end confidentiality between accelerators. The system may support multiple virtual partitions simultaneously, with independent security configurations for each virtual partition.

{Unpublished spec: SPDM for secure session establishment and attestation} {Reason: Locks down the specific security protocol used for Switch attestation and session establishment. SPDM is the mechanism defined in the unpublished spec. This is novel over v1.0 which had no Switch attestation mechanism.}

In some implementations of the system, the secure authenticated session utilizes Security Protocol and Data Model (SPDM), and wherein the trusted software is configured to verify an attestation report from the switch via the SPDM session. The SPDM session may provide mutual authentication between the trusted software and the security manager, and may establish a secure channel for subsequent key programming and state transition operations. The attestation report may include measurements of the switch firmware and hardware configuration.

{Unpublished spec: Virtual partition state machine (LOCK/RUN/STOP)} {NOVELTY: The virtual partition in the Switch has a three-state security lifecycle: a locked state (configuration verified, no traffic), the run state (secure workload active), and a stop state (security error detected, traffic halted). The transition from the locked state to the run state is controlled by the trusted software after verifying switch configuration. The stop state is entered upon integrity failure detection. This security state machine did not exist in v1.0.} {Reason: Covers the security lifecycle of the virtual partition. The three-state machine with trusted-software-controlled transitions is the core security architecture.}

In some implementations of the system, the security manager is configured to manage the virtual partition according to a state machine comprising a locked state, the run state, and a stop state; wherein the trusted software is configured to transition the virtual partition from the locked state to the run state after verifying configuration of the switch; and wherein the security manager is configured to transition the virtual partition to the stop state upon detecting an integrity failure. In the locked state, the security manager may prevent traffic processing for the virtual partition while allowing the trusted software to read and verify the switch configuration, including routing table entries, security settings, and port assignments. In the stop state, the security manager may halt all incoming and outgoing traffic for members of the affected virtual partition and may report the security event to a centralized controller via the management network.

{Unpublished spec: Upfront configuration constraint-link protection before workload start} {NOVELTY: Both end-to-end (Acc-Acc) link protection and Acc-Switch link protection must be configured BEFORE accelerators enter a workload execution state. Acc-Switch link protection CANNOT be enabled after accelerators are in the workload execution state. This is a novel security lifecycle constraint that prevents a race condition where workload data flows before Switch links are encrypted.} {Reason: This constraint is a mandatory implementation requirement for any secure INC deployment.}

In some implementations of the system, both end-to-end link protection between accelerators and link protection between each accelerator and the switch are configured before the plurality of accelerators enter a workload execution state, and wherein link protection between an accelerator and the switch is not enabled after the accelerator is in the workload execution state. This ordering constraint may prevent a condition where workload data flows on unprotected accelerator-to-switch links before encryption is established. The trusted software may program both accelerator-to-accelerator and accelerator-to-switch encryption keys and may verify that all links are protected before transitioning the accelerators and the virtual partition to the workload execution state.

{Inventive twist: Topology verification at lock} {NOVELTY: Before transitioning the virtual partition to the run state, the trusted software verifies that (1) switch identifiers and port numbers associated with the virtual partition are unique, (2) forwarding entries in the switch match the expected neighbor topology, and (3) security settings are correctly configured. This prevents a compromised or misconfigured switch from participating in the TCB.} {Reason: Covers the verification step that validates switch configuration before trusting it. This is the step that provides assurance that the switch is correctly configured before being elevated into the TCB.}

In some implementations of the system, before transitioning the virtual partition to the run state, the trusted software is configured to verify that switch identifiers and port numbers associated with the virtual partition are unique, that forwarding entries in the switch match an expected neighbor topology, and that security settings of the switch are correctly configured. The topology verification may detect scenarios where a compromised switch presents incorrect identifiers or routing entries, which could misdirect collective traffic to unauthorized accelerators. The trusted software may compare the switch-reported topology information against an expected topology provided by a centralized controller or by the tenant's workload configuration.

### Out of Scope: Group Table Locking by Security Manager During State Transition

In some implementations of the system, the security manager is further configured to lock a group table of the switch during transition of the virtual partition to the run state, the group table comprising entries that map collective group identifiers to participating accelerators; and wherein the group table is not modifiable during the run state without re-authorization by the trusted software. The group table may associate each collective group identifier with a list of participating accelerator identifiers and routing information used to replicate collective commands to the participating accelerators. Locking the group table may prevent modifications to collective group membership that could compromise the integrity of in-network collective operations during a secure workload.

{Inventive twist: Accelerator key material selection based on command type} {NOVELTY: The requesting Accelerator receives a response from the Switch (collective reduced result) encrypted with switch-to-accelerator keys. The Accelerator must use different key material than for accelerator-to-accelerator responses. The Accelerator determines which key material to use based on the command type field of the incoming request from the Switch (e.g., BlockRead, BlockWriteFull indicate switch-originated collective traffic), selecting switch-to-accelerator decryption keys accordingly.} {Reason: Covers the Accelerator-side key selection mechanism that complements the Switch-side selective bypass.}

In some implementations of the system, a requesting accelerator of the plurality of accelerators that receives a response from the switch is configured to determine, based on a command type field of the response, whether the response was encrypted using switch-to-accelerator encryption keys, and to select corresponding decryption keys for authenticating and decrypting the response. The command type field of the response may indicate switch-originated collective commands, such as block read or block write commands issued by the switch on behalf of a block collective operation. The requesting accelerator may maintain both accelerator-to-accelerator decryption keys and switch-to-accelerator decryption keys, and may select the appropriate key set based on the command type field of each incoming response.

### Narrowing to UALink Switch Security Manager

In some implementations of the system, the security manager is a UALink-based switch security manager. The UALink-based switch security manager may be a firmware component specifically designed for UALink switch platforms, providing security management functions for virtual partitions within the UALink-based network.

{Spec-direct: Per-virtual-partition collective security enablement} {Reason: Collective security (Switch in TCB) is enabled on a per-virtual-partition basis. Not all virtual partitions need collective security. This allows mixed deployments where some tenants use secure INC and others do not.}

In some implementations of the system, collective security is enabled on a per-virtual-partition basis, and wherein a first virtual partition of the switch has collective security enabled and a second virtual partition of the switch does not have collective security enabled. Per-virtual-partition enablement may allow tenants that use collective operations to opt into the elevated trust model for the switch, while tenants that only use unicast operations may operate with the switch outside the trusted computing base. The security configuration for each virtual partition may be independent of other virtual partitions.

In some implementations of the system, upon detection of an integrity failure on a link between an accelerator and the switch, the detecting device is configured to drop a failing transaction, stop processing new transactions from a source of the failing transaction, and stop sending transactions to a neighbor on the link, without affecting other links of the switch. The per-link isolation may contain the impact of a compromised or faulty link to the affected accelerator-switch pair, allowing other links to continue operating normally. The detecting device may notify the security manager, which may in turn notify a centralized controller via the management network for further action.

### Device Security Manager on Accelerators

In some implementations of the system, each accelerator of the plurality of accelerators comprises a device security manager, and wherein the trusted software is further configured to establish a security session with each device security manager to program accelerator-side encryption keys. The device security manager on each accelerator may manage the accelerator's encryption keys, attestation state, and security policies. The trusted software may program both the accelerator-to-accelerator encryption keys and the accelerator-to-switch encryption keys via the device security manager on each accelerator.

In some implementations of the system, the trusted software is further configured to establish a security session with each accelerator of the plurality of accelerators via a device interface security protocol of a second interconnect protocol, wherein the secure authenticated session with the security manager of the switch and the security sessions with the plurality of accelerators collectively establish a trusted computing base for collective operations spanning both the UALink-based network and an interface based on the second interconnect protocol. The second interconnect protocol may be based on Compute Express Link (CXL) or Peripheral Component Interconnect Express (PCIe), and the device interface security protocol may provide session establishment, attestation, and key programming functions for the accelerators on the host-side interface. The trusted software may coordinate the timing of key programming and state transitions across both the UALink-based and the second interconnect protocol interfaces to provide a unified security lifecycle for the workload.

### Method for Selectively Elevating a Switch Into TCB-Parallel to Claim 16

{SPEC: Intro} FIG. 26B illustrates a method for selectively elevating a switch into a trusted computing base that may enable trusted software to establish a secure session with a security manager on the switch, verify the switch's attestation, program encryption keys, and transition a virtual partition to a run state in which the switch decrypts collective transaction data while forwarding unicast transaction data without decryption. This method may enable per-workload, per-tenant trust elevation of specific switches in the accelerator network, without requiring all switches in the network to be trusted for all tenants.

In various implementations, a method comprising: establishing, by trusted software on a host processor, a secure authenticated session with a security manager on a switch in an Ultra Accelerator Link (UALink)-based network, the switch coupled to a plurality of accelerators via UALink-based links; verifying attestation of the switch via the secure authenticated session; programming encryption keys into the switch via the secure authenticated session; transitioning a virtual partition in the switch to a run state; and during the run state, decrypting collective transaction data at the switch using the encryption keys while forwarding unicast transaction data through the switch without decryption. The trusted software may be a lead trusted virtual machine that orchestrates the trust elevation across all switches participating in a virtual partition. In some examples, the virtual partition refers to a virtual pod. The method may be performed sequentially for each switch in the virtual partition, with the trusted software establishing independent SPDM sessions with each switch, distributing identical collective master keys to all switches, and coordinating the transition to the run state. The attestation verification may confirm the identity and integrity of each switch before the trusted software programs encryption keys, assuring that the verified switches receive the collective master keys. The encryption keys may be collective master keys from which stream keys are derived using a key derivation function. The decrypting of collective transaction data may enable the switch to perform in-network processing such as arithmetic reduction on the collective data. The forwarding of unicast transaction data without decryption may preserve end-to-end encryption between accelerators for non-collective traffic.

### Method Parallel of System Claim 18: State Machine STOP on Integrity Failure

In some implementations, the method further comprises upon detecting an integrity failure at a port of the switch, transitioning the virtual partition to a stop state, and stopping processing of incoming and outgoing transactions for members of the virtual partition. The integrity failure may be detected by verifying an authentication tag on an incoming encrypted transaction. Transitioning to the stop state may halt all collective and unicast traffic processing for the affected virtual partition, containing the security event. The security manager may report the integrity failure to the trusted software or to a centralized controller for further action.

### Trailing: Non-Transitory Medium

In some implementations of the method, a non-transitory computer-readable medium comprising instructions which, when executed by a processor, cause the processor to perform the method.

The term “Ultra Accelerator Link” (UALink) refers to currently available and/or future versions, variations and/or equivalents of the UALink Specification as defined by the Ultra Accelerator Link Consortium, Inc. UALink_200 Rev 1.0 Specification and its subsequent revisions are herein incorporated by reference in their entirety.

The term “Universal Chiplet Interconnect Express” (UCIe) refers to currently available and/or future versions, variations and/or equivalents of the standard as defined by the UCIe Consortium. UCIe Specification Revisions 1.0, 1.1, 2.0, and 3.0 are herein incorporated by reference in their entirety.

The term “Compute Express Link” (CXL) refers to currently available and/or future versions, variations and/or equivalents of the standard as defined by the CXL Consortium. CXL Specification Revisions 1.1, 2.0, 3.0, 3.1, 3.2, and 4.0 are herein incorporated by reference in their entirety.

The term “PCI Express” (PCIe) refers to currently available and/or future versions, variations and/or equivalents of the standard as defined by PCI-SIG (Peripheral Component Interconnect Special Interest Group). PCI Express Base Specification Revisions 5.0, 6.0, 6.1, and 6.2 are herein incorporated by reference in their entirety.

Various implementations described herein involve circuits. The term “circuit” refers to a device, an integrated circuit (IC), a die, a chiplet, or a system that includes at least a processing element configured to perform a function. This definition encompasses a wide range of implementations, including but not limited to: combinational logic, sequential logic, discrete logic circuits, programmable logic devices, embedded controllers, computers, accelerators, GPUs, FPGAs, ASICs, DSPs, System-on-Chip (SoC) designs, chiplet dies, accelerator dies, System-in-Package (SiP) devices, switch devices, and ICs incorporating processing capabilities. The processing element may be of any type, including combinational logic gates, a state machine, a lookup table, a microcontroller, a microprocessor, a single-core or multi-core processor, a firmware-controlled engine, or any combination thereof. The circuit may optionally include memory, which may include registers, buffers, volatile or non-volatile storage media, or retention memory that preserves state across reset events. The circuit may optionally include a communication interface allowing the processing element to send and/or receive data, signals, or instructions, which may include die-to-die interfaces, UALink-based ports, data link layers, physical layers, out-of-band management interfaces, or other arrangements facilitating data exchange. References to a “circuit” include any collection of one or more circuits that individually or jointly perform a function, meaning that the singular term “circuit” is intended to imply one or more circuits, which jointly perform the functions attributed to “the circuit.”

The terms “port” and “interface” may be used herein interchangeably unless the context requires distinction between them. Depending on the context, a port may refer to a physical or logical connection point configured to support communication with or within components, devices, or systems. A port may include, be included in, or be coupled to various interface types, may support one or more communication protocols and/or may refer to various specialized port types depending on the context.

Herein, terms such as send/sending, receive/receiving, communicate/communicating, or exchange/ exchanging when used to describe elements (e.g., circuit, processor, computer, host, semiconductor device, switch, port, interface) involved in data, message, packet, or other information exchanges, may refer to direct or indirect operation(s) that facilitate information transfer to/from/between such elements. When a first element is said to send information to a second element, it is not required to directly transmit the information from the first element to the second element; similarly, when a first element is said to receive information from a second element, the first element is not required to directly obtain the information from the second element. Instead, the elements may initiate, cause, make available, control, direct, participate in, or otherwise facilitate such transfer. The information transfer may occur directly or indirectly utilizing one or more intermediary components, such as switches, retimers, redrivers, bridges, and/or protocol translators, and may include routing, forwarding, encryption, buffering, protocol conversion, or other suitable data transfer mechanisms over a suitable communication path and/or connection. Similarly, sentences in the form of “a port/interface configured to communicate with an entity” refer to direct or indirect coupling between the port/interface and the entity.

References to a protocol “based on” a specific standard or an industry standard (such as a protocol based on UALink, a UALink-based protocol, a protocol based on CXL, or a CXL-based protocol) are intended to encompass protocols that conform to the referenced standard, as well as protocols that maintain the fundamental communication logic and essential functional characteristics of the referenced standard while potentially incorporating modifications, extensions, or variations. Non-limiting examples of such variations may include protocols that utilize renamed, reordered, or modified fields while preserving the same or similar message formats; protocols that implement essentially the same logical operations utilizing equivalent command sequences or opcodes; protocols that preserve the essential addressing schemes, routing logic, and coherency models; vendor-specific implementations that add proprietary extensions while maintaining core functionality; protocols that implement subsets of the full standard specification; or protocols that adapt the standard for different physical layers or transport mechanisms while maintaining the essential protocol properties. For example, a UALink-based protocol may encompass implementations that add vendor-defined fields, packets, or commands while preserving the essential accelerator-to-accelerator communication model.

References to a protocol-based port (such as a CXL-based port or a UALink-based port) are intended to encompass ports that communicate according to the referenced protocol or according to a protocol based on the referenced protocol. A protocol-based port may communicate over the protocol's native physical layer, over alternative physical and/or transport layers, or according to the protocol encapsulated within, tunneled over, or transported over other protocols or interconnect technologies. For example, a UALink-based port may communicate over its native physical layer, over UCIe, over ESUN, or over SUE.

The drawings presented herein are schematic representations, meaning that the number, order, timings, dimensions, connections, and other properties of the elements illustrated in the drawings are non-limiting examples. Depending on the context, elements (such as lines, arrows, boxes, blocks, symbols, or labels) illustrated in the drawings may represent one or more actual elements. For example, a single box in a block diagram may represent multiple hardware components or software modules, a single arrow in a flowchart may represent multiple process steps or data transfers, and a single line in a circuit diagram may represent multiple electrical connections. Every modification, variation, or alternative allowed by current or future relevant specifications, standards, or common practices in the field is intended to be included within the scope of said drawings. Furthermore, the scope of the drawings extends to encompass implementations that may deviate from strict specifications due to factors such as hardware bugs, relaxed designs, implementation-specific optimizations, or practical constraints, provided such deviations do not fundamentally alter the underlying principles of the implementation.

A computer program (also referred to as software, firmware, or executable logic) encompasses any set of instructions, logic, or data structures executable or interpretable by a computing device. This includes compiled or interpreted code, scripts, and machine-learning models (e.g., neural network weights, biases, and configurations). The computer program may be deployed as a standalone application, autonomous agent, service, microservice, container, or distributed module, and may be organized within any storage architecture, including file systems, object storage, or memory-mapped configurations. The program may reside locally, in a distributed network, or a cloud environment, and may utilize static or dynamic execution paradigms.

As used herein, “non-transitory computer-readable medium” refers to any tangible medium capable of storing instructions, code, or data for access by a computing device, excluding transitory propagating signals. This encompasses all forms of volatile and non-volatile memory, including semiconductor memory (e.g., RAM, Flash, RRAM, MRAM), magnetic storage, optical storage, and emerging persistent storage technologies. The medium may be integral to a device, removable, or distributed across multiple locations (e.g., a distributed database or cloud storage). The instructions, logic, or data structures may be pre-installed or downloaded to the medium via a communication network, such as the Internet. A computer program product comprises such a non-transitory medium containing content that, when accessed by one or more processors, performs the disclosed methods.

The “computer-implemented methods” described herein refer to method operations executed by processing hardware based on logical instructions, firmware, and/or hardwired logic. The processing hardware may include general-purpose processors, ASICs, FPGAs, or other hardware logic that implements the method operations through software execution, firmware execution, dedicated circuitry, or combinations thereof. The execution environment may be centralized or distributed, encompassing standalone devices, networked systems, cloud-based platforms, edge computing nodes, virtualized or containerized environments, and hybrid combinations thereof. The instructions or logic defining the method may be stored on one or more non-transitory computer-readable media, encoded in hardware description languages, and/or implemented in circuit logic.

Unless specifically requiring a particular implementation form, functionality described as implemented in hardware may alternatively be implemented in software, firmware, or a combination thereof, and vice versa. Similarly, functions described as performed by a single component may be distributed across multiple components, and functions described as distributed may be consolidated into a single component. The allocation of functions between hardware and software, or between centralized and distributed implementations, does not limit the scope of the implementations unless explicitly required.

The methods, algorithms, logics, processes, operations, and system functions described herein are not limited by a particular order, timing, sequence, grouping, or a specific implementation or example described or illustrated unless expressly stated otherwise. Steps, operations, and functions may be performed in any reasonable order, simultaneously or sequentially, in parallel or series, and may be combined, separated, modified, rearranged, omitted, supplemented, or distributed across multiple systems or components based on particular implementation requirements. Any process descriptions, steps, or blocks in flowcharts or other illustrations should be understood as potentially representing modules, segments, portions of code, or operations that may be executed in any reasonable order, combination, or concurrently, and are not necessarily limited to the particular sequence depicted.

Phrases such as “an implementation”, “various implementations”, “some implementations”, “one or more implementations”, “an embodiment”, “some embodiments”, “one embodiment”, “an aspect”, “a configuration”, “an example”, and similar phrases are used herein for convenience and do not imply that a disclosure relating to such phrase(s) is essential to the subject technology or that such disclosure applies to all implementations of the subject technology. Phrases such as “an implementation”, “some implementations”, or “various implementations” may refer to one or more implementations and vice versa, and this applies similarly to other foregoing phrases. Distinct references, including terms such as “one implementation”, “another implementation”, “various implementations”, or “some implementations”, do not necessarily denote separate implementations. Such references may describe the same implementation from different perspectives, highlight various aspects of a single implementation, or pertain to distinct implementations. References to examples or instances are to be understood as non-limiting.

Sentences in the form of “X is indicative of Y” mean that X includes information correlated with Y and/or describing Y, up to the case wherein X equals Y. Sentences in the form of “provide/receive an indication (of whether X happened)” may refer to any indication method. The word “most” of something is defined as above 51% of the something (including 100% of the something). The words “portion”, “subset”, “region”, and “area” of something refer to a value between a non-zero fraction of the something and 100% of the something, inclusive; they indicate an open-ended claim language, thus, for example, sentences in the form of “a portion of the memory” or “a subset of the memory” encompass anything from just a small part of the memory to the entire memory, optionally together with additional memory region(s). Sentences in the form of “access the memory” encompass accessing at least a portion of the memory, where the portion may range from a minimal addressable unit to the entire memory capacity, indicating an open-ended claim language. “Coupled” indicates direct or indirect connection, cooperation, and/or interaction, such as direct or indirect physical contact, electrical connection, and/or software and/or hardware interface; the connection between coupled elements may (or may not) involve one or more of passive components, active components, translations, modulation change, modifications to schemes, message alterations, and/or other conversions to the data or signals being transmitted.

The use of “a” or “an” refers to one or more things. The phrase “based on” indicates an open-ended claim language, and encompasses “based, at least in part, on”. Additionally, stating that a value is calculated “based on X” and following that, in a certain implementation, that the value is calculated “also based on Y”, means that in the certain implementation, the value is calculated based on X and Y. Variations of the terms “utilize” and “use” indicate an open-ended claim language, such that sentences in the form of “detecting X utilizing Y” are intended to mean “detecting X utilizing at least Y”, and sentences in the form of “use X to calculate Y” are intended to mean “calculate Y based on X”. The terms first, second, and so forth serve merely as ordinal designations, and shall not be limited in themselves. The phrases “at least one of A or B” and “at least one of A and B” are intended to be interpreted broadly to encompass A alone, B alone, or a combination of both A and B; this interpretation applies regardless of the number of items in a list, or whether the items are connected by the conjunction ‘and’ or ‘or’. A predetermined, predefined, or preselected value is a fixed value and/or a value determined before performing a calculation that utilizes the predetermined value. When appropriate, the word “value” may indicate a predetermined value. The word “threshold” indicates a threshold whose value, and/or the logic used to determine whether the threshold is reached, is established prior to performing the computation that utilizes the threshold, whether the threshold value is fixed, predefined, or dynamically determined.

The implementations of an invention may include a variety of combinations and/or integrations of the features of the implementations. Although some implementations may describe serial operations, the implementations may perform certain operations in parallel and/or in different orders from those described. Moreover, the use of repeated reference numerals and/or letters in the text and/or drawings is for the purpose of simplicity and clarity and does not in itself dictate a relationship between the various implementations and/or configurations discussed. Components and/or modules referred to by different reference numerals may or may not perform the same (or similar) functionality, and the fact they are referred to by different reference numerals and/or letters does not mean that they may not have same or similar functionalities.

Certain features of the implementations, which may have been, for clarity, described in the context of separate implementations, may also be provided in various combinations in a single implementation. Conversely, various features of the implementations, which may have been, for brevity, described in the context of a single implementation, may also be provided separately or in any suitable sub-combination. Implementations described in conjunction with specific examples are presented by way of example, and not limitation. Moreover, it is evident that many alternatives, modifications, and variations will be apparent to those skilled in the art. It is to be understood that other implementations may be utilized and structural changes may be made without departing from the scope of the implementations.

The drawings depict some of the couplings between elements, but not necessarily all. The depiction of elements as separate entities may be done to emphasize different functionalities of elements that may be implemented by the same software and/or hardware. Programs and/or elements illustrated and/or described as being single may be implemented via multiple programs and/or involve multiple hardware elements possibly in different locations. The implementations are not limited in their applications to the details of order, or sequence of method steps, or to details of implementation of the devices, set in the description, drawings, or examples. Individual blocks illustrated in the drawings may be functional in nature and therefore may not necessarily correspond to discrete hardware elements.

Claims in the form of “A non-transitory computer-readable medium comprising instructions which, when executed by a processor, cause the processor to perform the method of claim X” are intended to encompass physical storage media capable of storing instructions, including but not limited to semiconductor memory, magnetic storage, optical storage, and other persistent storage technologies. The instructions may be in any form capable of directing a processor to perform the method, including but not limited to compiled code, interpreted code, bytecode, firmware, as well as other forms of directives such as natural language directives, declarative specifications, model parameters or configurations, and symbolic representations, among other formats that may be suitable for processing by processors, AI modules, neural processing units, or other current or future processing architectures. The processor may include any processing unit capable of executing or interpreting stored instructions, including but not limited to CPUs, microprocessors, microcontrollers, DSPs, GPUs, neural processing units, AI accelerators, and quantum processing units. The stored instructions may cause a single processor to perform the method, or may cause the processor to coordinate with one or more additional processors to collectively perform the method in a distributed manner.

Claims in the form of “One or more integrated circuits configured to perform the method of claim X, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages” are intended to encompass hardware implementations that execute, implement, realize, or carry out method steps through circuitry, programmable circuitry, stored instructions executed by processing elements, or distributed across multiple chiplets. The first alternative covers implementations based on processing units designed to execute arbitrary software instructions, including but not limited to CPUs, microprocessors, and application processors, that execute software or firmware to perform the method, with communication interfaces enabling data exchange with other system components. The second alternative covers implementations where specialized circuitry provides hardware acceleration or dedicated processing capabilities, including but not limited to ASICs, FPGAs, PLDs, and SoC devices, wherein the functionality is implemented using electronic and/or photonic components, programmable logic, or combinations thereof. The third alternative covers chiplet-based implementations where the method is performed by one or more semiconductor dies designed for integration within multi-chip modules or system-in-package configurations. These chiplets may reside within a single package or across multiple packages, communicating via inter-chiplet protocols such as UCIe, AIB, CHI-C2C, or other die-to-die interfaces when within the same package, or via package-to-package interfaces when distributed across different packages. The packages may utilize various integration technologies, including but not limited to 2.5D silicon interposers, 3D stacking, organic substrates, and embedded bridge technologies. The method may be partitioned across multiple chiplets with different chiplets implementing different portions, or a single chiplet may implement the complete method.

Claims in the form of “An active cable comprising first and second pluggable modules coupled by a physical medium; wherein the active cable further comprises hardware circuitry, integrated into the active cable, configured to perform the method of claim X” are intended to encompass cable assemblies that include active electronic components capable of processing and modifying signals during transmission. Such claims cover cables having connectors at each end designed for insertion into corresponding receptacles, connected by a transmission medium that may include copper conductors, optical fibers, or other signal-carrying media. The electronic components performing the method may be incorporated anywhere within the cable assembly, including within either or both of the pluggable connectors, or positioned along the cable between segments of the physical medium. The implementation may utilize fixed circuit arrangements, programmable logic, firmware, or combinations thereof. The electronic components may perform the entire method within the cable or may work in conjunction with other processing elements to implement the complete functionality.

Claims in the form of “An apparatus configured to operate as a switch, wherein the apparatus comprises switching circuitry and is configured to perform the method of claim X” are intended to encompass apparatus that selectively routes signals, data, or communications between ports while also performing the method. Such claims cover traditional switching devices with dedicated switch ports as well as processor-based switches and other architectures that achieve switching functions through alternative port configurations. The ports through which data enters or exits the switching function may include physical ports, logical ports, virtual ports, or other port types appropriate for the switching architecture. The apparatus may include homogeneous ports supporting a single protocol or heterogeneous ports supporting different protocols, speeds, or functionalities. The method operations are performed as part of the switching functionality through hardware, firmware, and/or logic contained within the apparatus.

Accordingly, this disclosure is intended to embrace all such alternatives, modifications, and variations that fall within the spirit and scope of the appended claims and their equivalents.

1. A device for an Ultra Accelerator Link (UALink)-based network, the device comprising:
a UALink-based port;
a circuit coupled to the UALink-based port, the circuit configured to detect a data error indicator on a data beat of a transaction;
a port encryption engine configured to, upon detection of the data error indicator: exclude the data beat from encryption, exclude the data beat from authentication tag computation, and set bytes and byte enables of the data beat to a predetermined value; and
a transaction layer configured to replace the data beat with one or more error indication messages in an outbound flit stream on the UALink-based port.

2. The device of claim 1, wherein the predetermined value for bytes and byte enables of the data beat is zero.

3. The device of claim 1, wherein each error indication message comprises a 32-byte Poisoned Data TL Message Half-Flit, and each 64-byte data beat with the data error indicator is replaced with two of the Poisoned Data TL Message Half-Flits.

4. The device of claim 1, wherein the data error indicator is evaluated independently for each 64-byte data beat within a multi-beat transaction, wherein one data beat is excluded from encryption and authentication tag computation while other data beats in the same transaction are encrypted and authenticated.

5. The device of claim 1, wherein the data error indicator comprises at least one of: an OrigDataError indicator on an originator data channel for write data, or a RdRspDataError indicator on a read response data channel for read response data.

6. The device of claim 1, wherein the excluding of the data beat from encryption and authentication tag computation prevents the data error from causing an authentication tag mismatch at a receiving device, thereby avoiding teardown of a security session between the device and the receiving device.

7. The device of claim 1, wherein the port encryption engine advances at full throughput without stalling when the data beat with the data error indicator is encountered, maintaining line-rate processing for non-poisoned data beats.

8. The device of claim 1, wherein when plaintext CRC protection is enabled, a CRC calculation over plaintext content also excludes the data beat with the data error indicator, maintaining consistency between the CRC exclusion and the encryption exclusion.

9. The device of claim 1, wherein the device comprises a switch in the UALink-based network, and when the switch performs in-network data reduction on decrypted collective data and the data beat has the data error indicator, the switch excludes the data beat from a reduction operation, marks a corresponding beat in a reduced result with a data error indicator, and a switch port encryption engine excludes the data beat from re-encryption and re-authentication tag computation.

10. The device of claim 1, wherein the device comprises a switch in the UALink-based network, and when the switch replicates a collective write operation to a plurality of destination accelerators and the data beat has the data error indicator, the switch propagates the data error indicator for the data beat in all replicated requests to the plurality of destination accelerators.

11. A method for propagating data errors in an Ultra Accelerator Link (UALink)-based network, comprising:
detecting, at a device comprising a port encryption engine coupled to a UALink-based port, a data error indicator on a data beat of a transaction;
excluding, by the port encryption engine, the data beat from encryption;
excluding, by the port encryption engine, the data beat from authentication tag computation;
replacing bytes and byte enables of the data beat with a predetermined value; and
replacing the data beat in an outbound flit stream with one or more error indication messages.

12. The method of claim 11, wherein the predetermined value is zero, and each error indication message comprises a 32-byte Poisoned Data TL Message Half-Flit, and each 64-byte data beat with the data error indicator is replaced with two of the Poisoned Data TL Message Half-Flits.

13. The method of claim 11, wherein the data error indicator is evaluated independently for each 64-byte data beat within a multi-beat transaction, wherein one data beat is excluded from encryption and authentication tag computation while other data beats in the same transaction are encrypted and authenticated.

14. The method of claim 11, wherein the excluding of the data beat from encryption and authentication tag computation prevents the data error from causing an authentication tag mismatch at a receiving device, thereby avoiding teardown of a security session between the device and the receiving device.

15. The method of claim 11, wherein the device comprises a switch in the UALink-based network, and when the switch performs in-network data reduction on decrypted collective data and the data beat has the data error indicator, the switch excludes the data beat from a reduction operation, marks a corresponding beat in a reduced result with a data error indicator, and excludes the data beat from re-encryption and re-authentication tag computation.

16. A non-transitory computer-readable medium comprising instructions which, when executed by a processor, cause the processor to perform the method of claim 11.

17. One or more integrated circuits configured to perform the method of claim 11, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

18. An interconnect system for an Ultra Accelerator Link (UALink)-based network, comprising:
a transmitting device comprising a first port encryption engine, a first transaction layer, and a first UALink-based port;
a receiving device comprising a second port encryption engine, a second transaction layer, and a second UALink-based port;
the transmitting device coupled to the receiving device via a UALink-based link;
wherein at the transmitting device, when a data error is detected on a data beat of a transaction, the first port encryption engine excludes the data beat from encryption and authentication tag computation, and the first transaction layer replaces the data beat with error indication messages;
and at the receiving device, the second transaction layer detects the error indication messages, asserts a data error indicator for a corresponding data beat, and the second port encryption engine excludes the data beat from decryption and authentication tag verification;
wherein the authentication tag verification succeeds for non-poisoned data beats of the transaction despite the presence of the data beat with the data error in the transaction.

19. The system of claim 18, wherein at the receiving device, the second transaction layer decodes the error indication messages and sets bytes of a reconstructed 64-byte data beat to zero and byte enables to zero on a UPLI interface.

20. The system of claim 18, wherein the transmitting device or the receiving device logs each data error event, recording at least one of: a transaction tag, source and destination accelerator identifiers, or a beat offset, enabling post-mortem analysis of data error patterns.
